(19) United States
(12) Patent Application Publication
(10) Pub. No.: US 2025/0348358 A1
(43) Pub. Date: Nov. 13, 2025

(54) RESERVATION OF MEMORY RESOURCES FOR ISOLATED DATA ACCESSES USING OPTICAL CONNECTIONS

(71) Applicant: Intel Corporation, Santa Clara, CA (US)

(72) Inventors: Akhilesh S. THYAGATURU, Ruskin, FL (US); Khaled AHMED, San Jose, CA (US); Gurpreet Singh KALSI, Portland, OR (US); Jason M. HOWARD, Portland, OR (US); Joshua B. FRYMAN, Corvallis, OR (US)

(21) Appl. No.: 19/269,719

(22) Filed: Jul. 15, 2025

(51) Int. Cl. G06F 9/50

(52) U.S. Cl. CPC G06F 9/5016; G06F 9/5027

(57) ABSTRACT

Examples described herein relate to an interface and circuitry, coupled to the interface. The circuitry is to: based on receipt of a first request to access data received from an optical interface and from a process, apply a configuration to determine whether to permit the access to data from a first memory region of the memory and based on a determination to permit the access to the data, permit access to the data by the first request, wherein the first memory region of the memory is accessible to multiple processes of a tenant via optical interconnects.

### BACKGROUND

A data center may include one or more computing platforms. A computing platform can include a processor, accelerator, and associated memory modules. Computing platforms of the datacenter may facilitate the performance of processes associated with various applications running on and/or hosted by computing platform. These processes may be performed by the processors and other associated logic of the computing platforms. Each computing platform may additionally include input/output (I/O) controllers, such as network interface devices, which may be used to send and receive data on a network for use by the various applications.

Communications among computing platforms can utilize optical signal propagation technologies and can utilize polychromatic image sensors to capture images across multiple wavelengths (e.g., visible, infrared, ultraviolet). Polychromatic image sensors can be used in a wide variety of applications. Defense applications can include target detection and identification, surveillance and reconnaissance, guidance systems, and countermeasures. Polychromatic sensors can distinguish between objects based on their spectral signatures, improving the accuracy of identifying military targets in complex environments, including camouflaged or hidden objects. Sensors enable more detailed surveillance, allowing for the detection of threats in various lighting conditions, including nighttime or through smoke and fog. Polychromatic imaging enhances missile or drone guidance by providing more robust target tracking across different wavelengths, ensuring precision in challenging environments. Sensors can detect and counteract enemy camouflage, deception techniques, or even certain types of decoys by identifying spectral inconsistencies.

Commercial applications can include agriculture, medical imaging, environmental monitoring, and quality control. Polychromatic sensors are used in precision farming for crop health monitoring by analyzing the spectral reflectance of plants to assess hydration, disease, or nutrient levels. In medical diagnostics, these sensors can enhance imaging for tissue analysis, detecting variations in biological tissue properties across different wavelengths. They can assess water quality, detect pollutants, or monitor vegetation health by capturing data across various wavelengths. In industrial settings, polychromatic sensors help inspect materials for defects, contaminants, or surface irregularities that are only visible under specific wavelengths.

### BRIEF DESCRIPTION OF THE DRAWINGS

FIG. 1 depicts an example block diagram of a parallel optical link based on arrays of MicroLEDs or Micro Vertical Cavity Surface Emitting Lasers (VCSELs).

FIG. 2 depicts an example of a single core fiber and multicore fiber.

FIG. 3 depicts a cross-section of a MicroLED.

FIG. 4 depicts a cross-section of a MicroLED.

FIG. 5 depicts a cross-section of a Meta MicroLED.

FIG. 6 depicts optical links using arrays of microscopic light emitters (MLEs) and arrays of microscopic photodetectors (MPDs).

FIG. 7 depicts an example structure.

FIG. 8 depicts an example of micro transfer printing of MicroLEDs.

FIG. 9 is a schematic illustration of the use of NbN layer as a release layer for the MicroLEDs.

FIG. 10 depicts a schematic cross section of the Meta MicroLED structure.

FIG. 11 depicts a calculated spectral emission along with the native stack PL spectrum.

FIG. 12 depicts calculated spectra for Meta MicroLEDs.

FIG. 13 depicts phase and reflection coefficient are cross plotted with the meta-atom radius.

FIG. 14 depicts a schematic illustration of the data communication system.

FIG. 15 depicts an example of combining optical pulses.

FIG. 16 depicts an example system.

FIG. 17 depicts an example energy band diagram of heterojunction phototransistor (HPT).

FIG. 18 depicts an example energy band diagram of heterojunction phototransistor (HPT).

FIG. 19 depicts an example cross section schematic of the voltage-tunable phototransistor

FIGS. 20A-20H depict an example fabrication process.

FIG. 21 depicts an example voltage-tunable photodetector and associated circuit connected to it to illustrate an example operation.

FIG. 22 depicts a photodetector's output.

FIG. 23 depicts an example voltage-tunable photodetector system.

FIG. 24A depicts an example a cross section of a photodetector.

FIG. 24B depicts an example structure after flip-chip bonding the device to the readout IC wafer.

FIG. 25A depicts example energy band diagram (to scale) for GaN/InGaN material system.

FIG. 25B depicts an example energy band diagram for InP/InGaAsP material system.

FIG. 26 depicts an example cross section of a microscopic photodetector (MPD).

FIG. 27 depicts a cross section of the microscopic photodetector (MPD).

FIG. 28 depicts an example energy band diagram.

FIG. 29A depicts an example simulated energy band diagram of a photodetector.

FIG. 29B depicts an example simulated energy band diagram of a photodetector.

FIG. 30 depicts a schematic illustration of envisioned polychromatic image sensor that includes two layers.

FIG. 31 depicts a top view schematic of the sensors layer.

FIG. 32 depicts an example process flow illustrating the transfer to devices to a single target substrate.

FIG. 33 depicts transfer-printing of MPDs from growth wafer to a CMOS wafer.

FIG. 34 depicts a cross section illustration of a process for making a proposed tri-color an energy-efficient Wavelength Division Multiplexing (WDM) photodetector.

FIG. 35 depicts a cross section illustration of the proposed tri-color, energy-efficient multiple wavelength photodetector.

FIG. 36 depicts a vertically disaggregated image sensor architecture.

FIG. 37 depicts an image sensor.

FIG. 38 depicts a cross section of a heterostructure NIPIN photodetector or microscopic photodetector (MPD).

FIG. 39 depicts an energy band diagram of a heterojunction NIPIN photodetector showing a multiple quantum well absorber layer.

FIGS. 40A-40H depict example cross sections of a structure after a fabrication process.

FIG. 41 depicts a cross section of infrared heterostructure MPD (IR-MPD).

FIG. 42A depicts an example cross section of infrared heterostructure MPD (IR-MPD) formation of contacts to cathode and anode layers.

FIG. 42B depicts an example cross section of infrared heterostructure MPD (IR-MPD) after transfer to a CMOS wafer that includes readout circuitry.

FIG. 43 depicts a cross section of a polychromatic image sensor architecture.

FIG. 44 depicts a cross section of the first photodetector bonded to the glass substrate through the unique interconnect structures.

FIG. 45 depicts a top-view layout shows a photodetector arrangement.

FIGS. 46A-46D show a sequence of schematic show an example process flow for manufacturing the polychromatic image sensor.

FIG. 47 depicts a pixel structure consisting of two detectors, each targeting a different wavelength.

FIG. 48 depicts a process flow.

FIG. 49 depicts a process flow for transferring multiple microscopic devices from multiple growth substrates onto a single target substrate.

FIG. 50 depicts prior art CMOS image sensors.

FIG. 51 shows the physics of the APD operation through its I-V characteristics of a photodiode showing avalanche photodiode (APD) operating regime at high operating voltage.

FIG. 52 shows a Prior Art photon to digital conversion using APD.

FIG. 53 depicts a layout of a vertically disaggregated image sensor.

FIG. 54 depicts a photon-to-digital conversion circuit, designed to maximize signal-to-noise ratio with minimal components.

FIG. 55 depicts a negative differential resistance (NDR) device.

FIG. 56 depicts a photon to digital configuration.

FIG. 57 depicts an image-capturing system.

FIG. 58 depicts disaggregated image sensor apparatus.

FIG. 59 depicts an imaging apparatus.

FIG. 60 depicts a block diagram of a parallel optical link based on arrays of MicroLEDs or Micro VCSELs.

FIG. 61 depicts a schematic illustration of single core fiber and multicore fiber.

FIG. 62 depicts a schematic illustration of a device structure.

FIG. 63 depicts an example process.

FIG. 64 depicts a process for transferring multiple microscopic devices from multiple growth substrates onto a single target substrate.

FIG. 65 shows a schematic illustrating to configurations of the proposed pixel element.

FIG. 66 shows example heterojunction phototransistor structure and the corresponding example current-voltage characteristics.

FIG. 67 depicts an illustration of the energy band diagram of an HPT.

FIG. 68 depicts a process flow for making the structure MicroLED/HPT.

FIG. 69 illustrates an example first system.

FIG. 70 illustrates example controlled shared memory (COSM) management circuitry.

FIG. 71 illustrates an example second system.

FIG. 72 illustrates an example isolation scheme.

FIG. 73 illustrates an example first permission matrix scheme.

FIG. 74 illustrates an example second permission matrix scheme.

FIG. 75 illustrates an example data transfer scheme.

FIG. 76 illustrates an example in-memory compute and isolation schemes.

FIG. 77 depicts an example system.

FIG. 78 depicts an example of memory access routing.

FIG. 79 depicts an example system.

FIG. 80 illustrates a COSM-enabled Externally Shared Memory Device (ESMD) architecture.

FIG. 81 depicts an example operation.

FIG. 82 depicts an example fiber bundle cross-section.

FIG. 83 depicts an example of circuitry that can gate access to data.

FIG. 84 depicts an example of configuring optical and electrical signal gating based on a configuration.

FIG. 85 depicts an example switch that can permit or deny optical or electrical communications.

FIG. 86 depicts an example system.

FIG. 87 depicts an example system.

FIG. 88 depicts an example system.

FIG. 89 depicts an example switch.

FIG. 90 depicts an example of routing data through a memory module.

FIG. 91 depicts an example of packet transmission between hosts or processes using COSM.

FIG. 92 depicts an example system.

FIG. 93 depicts an example of gating of communications between first and second circuitries.

FIG. 94 depicts an example system.

FIG. 95 depicts an example of interconnects.

FIG. 96 depicts an example process.

FIG. 97 depicts an example system.

### DETAILED DESCRIPTION

In hyperscaler data centers and top-of-rack (ToR) environments, massive volumes of data must be shared across a multitude of hosts with ultra-low latency, high bandwidth, and strong isolation. Electrical interconnects (e.g., Peripheral Component Interconnect express (PCIe), Ethernet) may face challenges of power inefficiency at hyperscale; latency and signal integrity issues as host count scales; and insecure cross-host memory access, increasing risk of side-channel attacks and data leakage.

Various examples provide an Externally Shared Memory Device (ESMD) architecture integrated with micro-size light-emitting diode (microLED)-based optical interconnects and switching. Various examples of MicroLED transceivers described herein can be utilized to transmit and/or receive optical signals. Multiple hosts can be connected to an externally shared controlled shared (COSM) memory pool by optical interconnects and/or electrical or wireless communication technologies. MicroLED switches provide non-blocking, light-based communication paths between host systems and individual memory blocks. COSM's permission matrices and enforcement circuitry provides multi-tenant memory isolation and hardware-level access control of memory access.

Scalable MG-Passivated Microleds with Microcavities for High-Bandwidth Communication

A network of computer chips in an artificial intelligence (AI) training or inference system can utilize micro-size light-emitting diodes (microLEDs). Visible light MicroLEDs can provide parallel optical links. Optical multiplexing technology (e.g., Space Division Multiplexing) can be used to transmit a plurality of channels' worth of optical pulse signals through multicore, multimode optical fibers. As bandwidth increases, a number of cores in the optical fibers increases.

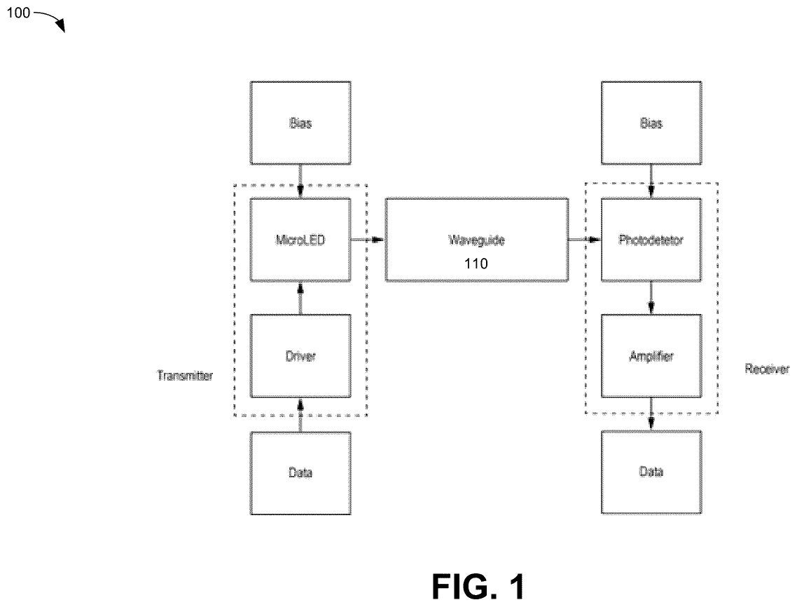

FIG. 1 depicts an example block diagram of a parallel optical link based on arrays of MicroLEDs or Micro Vertical Cavity Surface Emitting Lasers (VCSELs). Waveguide 110 may be a multicore fiber with numerous cores (e.g., 1024 cores), for example. If the modulation speed of an individual MicroLED increases (e.g., from 1 GHz to 4 GHz), the number of cores may be reduced (e.g., from 1024 to 256 cores), making it more commercially feasible to implement this technology in high volume manufacturing.

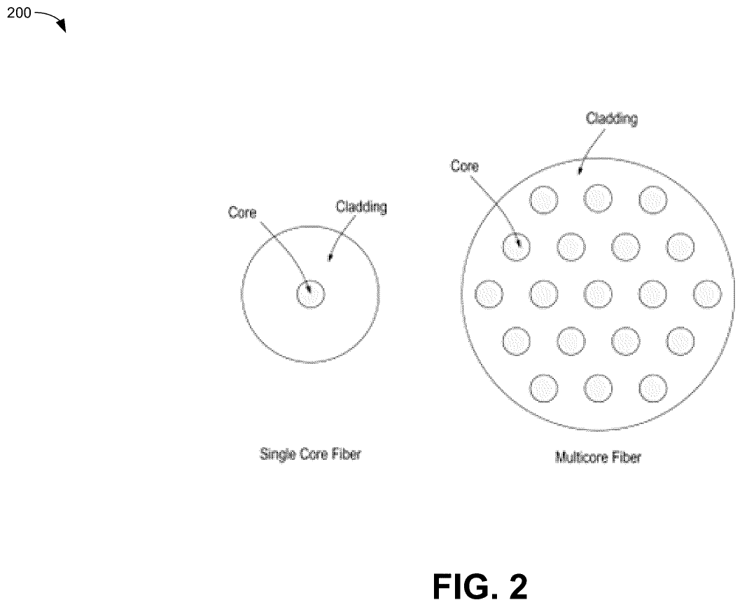

FIG. 2 depicts an example of a single core fiber and multicore fiber. For Space Division Multiplexing (SDM) datacom systems with target transmission data rates of 2 Tb/s/direction, MCFs with about 1024 cores are utilized. However, if the modulation speed of an individual MicroLED increases from 1 GHz to 4 GHz, the number of cores may be reduced to 256 cores.

MicroLEDs are emerging as a technology for building parallel optical interconnects capable of supporting data transfer rates in chip-to-chip communication, such as artificial intelligence (AI) data centers with short-reach links (<10 m). MicroLEDs offer an energy-efficient solution, achieving less than 0.5 pJ/bit at current sizes and potentially scaling down to 0.3 pJ/bit as the MicroLED dimensions are reduced to 5 micrometers or smaller. Such scaling, however, introduces challenges, particularly an increase in the influence of sidewall defects that form during the etching process in manufacturing. These defects can significantly impact the transient response of MicroLEDs, especially when subjected to data-driven current pulses with widths of less than 1 nanosecond.

The presence of these defects leads to increased non-radiative recombination, causing a reduction in light emission efficiency and an increase in energy consumption per bit, ultimately negating the advantages of scaling down the MicroLED size for energy efficiency. To address this, a scalable and cost-effective sidewall passivation technique is essential. Therefore, while MicroLEDs hold immense potential for energy-efficient, high-bandwidth optical interconnects in data centers, the need for a more affordable, high-volume manufacturable solution to manage sidewall defects is critical. Such a solution would ensure that the efficiency gains from reducing MicroLED sizes are realized, maintaining the promise of a <0.5 pJ/bit and <5 cents/Gbps solution for short-reach optical links in AI data centers, enabling scalable, cost-effective, and high-speed data transfer essential for the evolving demands of artificial intelligence workloads.

Various examples utilize magnesium (Mg) implantation on the sidewalls of MicroLEDs to improve device scalability. As MicroLED dimensions shrink, the sidewall-to-volume ratio increases, making surface recombination effects an efficiency bottleneck. The primary physical mechanism through which Mg implantation enhances device performance is through the passivation of surface states that act as non-radiative recombination centers. GaN has a high density of surface states at its etched sidewalls, primarily due to the presence of dangling bonds or unsatisfied bonds left by either gallium (Ga) or nitrogen (N) atoms at the surface. When Mg is implanted into the sidewalls, Mg preferentially bonds with N dangling bonds. This occurs because the electronegativity difference between Mg and N is greater than that between Mg and Ga, making the formation of Mg—N bonds thermodynamically more favorable. These Mg—N bonds are stable and effectively neutralize the electrically active surface states, significantly reducing the density of these recombination centers. This reduction in active surface state density directly translates into a lower rate of Shockley-Read-Hall (SRH) non-radiative recombination at the sidewalls, thus preserving the radiative recombination efficiency of the MicroLED.

Moreover, the implantation of Mg introduces a secondary beneficial effect, namely, the formation of a localized depletion region along the MicroLED sidewalls. As Mg acts as a p-type dopant, its presence in the GaN lattice creates an abundance of acceptor states, leading to the depletion of free electrons in the vicinity of the sidewall surfaces. This depletion region acts as an effective barrier, preventing electrons from reaching the sidewalls where they could otherwise be captured by remaining surface states and undergo non-radiative recombination. By keeping the charge carriers away from these defect-rich areas, the SRH recombination pathway is further suppressed, which is crucial for maintaining high internal quantum efficiency (IQE) in MicroLEDs as their dimensions decrease.

The combined effects of Mg passivation (e.g., the reduction in surface state density and the creation of a depletion region) leads to a significant decrease in surface recombination velocity (SRV). The SRV quantifies how quickly carriers recombine at the surface. By implanting Mg, the SRV is lowered, ensuring that fewer charge carriers are lost to non-radiative processes. This decrease in SRV is particularly important for smaller MicroLEDs, where the efficiency loss due to surface recombination would otherwise be more pronounced due to the larger relative surface area. Consequently, the device maintains a high level of efficiency even as it scales down, enabling the development of highly efficient, high-resolution MicroLED displays.

Mg implantation offers a robust passivation solution by chemically neutralizing surface defects and establishing an electrical barrier that shields carriers from reaching recombination-active regions. This dual mechanism not only reduces the efficiency losses associated with scaling but also enhances the thermal and electrical stability of the MicroLEDs, making it possible to achieve high brightness and efficiency at smaller sizes.

In some examples, formation of an Mg passivation layer on MicroLED sidewalls involves tilted ion implantation, where Mg ions are implanted at an angle to ensure uniform sidewall coverage. For MicroLEDs with heights of 1-2 micrometers, a dose can be around 1×10¹⁴ ions/cm², with an implant energy of 50 keV and a tilt angle of 20°-30°. This angled approach ensures effective penetration and bonding of Mg with nitrogen dangling bonds, creating a robust passivation layer that reduces non-radiative recombination and enhances device performance. The Mg passivation layer formed by ion implantation is not a distinct, continuous film but rather a doped region integrated into the MicroLED sidewalls.

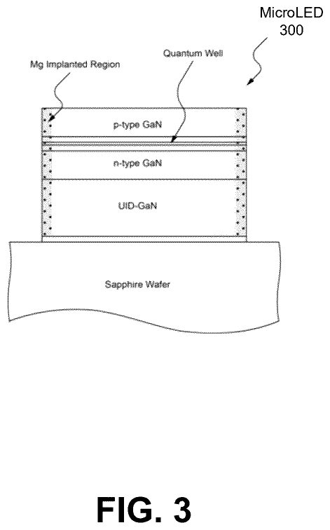

FIG. 3 depicts a cross-section of MicroLED with Mg passivation applied after the mesa has been etched using a dry etch process. The Mg passivation layer is formed through tilted ion implantation, ensuring uniform coverage of the sidewalls. This approach can achieve higher modulation speeds and reduce energy per bit from 1 pJ/bit to 0.3 pJ/bit. By implanting Mg in MicroLED 300, the sidewall defects introduced during manufacturing can be neutralized, significantly reducing non-radiative recombination and enhancing carrier lifetime. This enables MicroLEDs to be scaled down in size while maintaining key performance metrics like speed and efficiency.

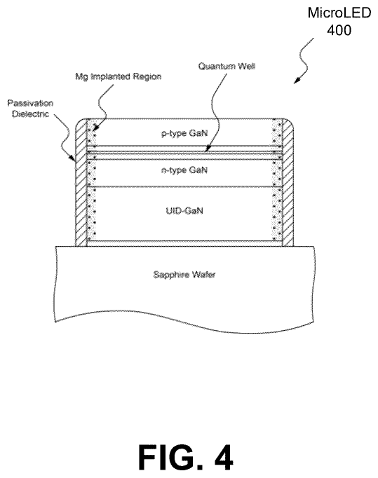

FIG. 4 depicts a cross-section of a MicroLED with Mg passivation and atomic layer deposition (ALD) dielectric (e.g., Al₂O₃) passivation have been applied after the mesa has been etched using a dry etch process. In MicroLED 400, Mg implantation is combined with a single thin ALD dielectric layer, which enhances MicroLED performance and reliability by addressing both surface passivation and environmental protection. The Mg implant reduces surface defects, while the ALD dielectric, such as Al₂O₃, provides a conformal barrier against moisture and contaminants, ensuring long-term stability and efficient light emission.

In some examples, MicroLEDs with diameters of 2-3 micrometers in an optical interconnect system that enable current densities exceeding 1000 A/cm² for a given applied current. This high current density enhances carrier recombination rates, achieving an electro-optical modulation frequency (f3 dB) greater than 1 GHz, making these MicroLEDs ideal for high-speed data communication applications.

In some examples, Mg-passivated MicroLEDs form a microcavity (surrounded by metals) by incorporating a top metasurface mirror and a bottom metasurface mirror, creating a “Meta Mirror.” This design provides a narrow optical emission divergence angle of less than 30 degrees and a small linewidth under 10 nm. A combination of Mg passivation with the meta mirror enhances light confinement, improving emission efficiency and spectral purity. The microcavity structure optimizes light output, making it suitable for applications for precise and efficient light sources, such as high-resolution displays and advanced optical communication systems.

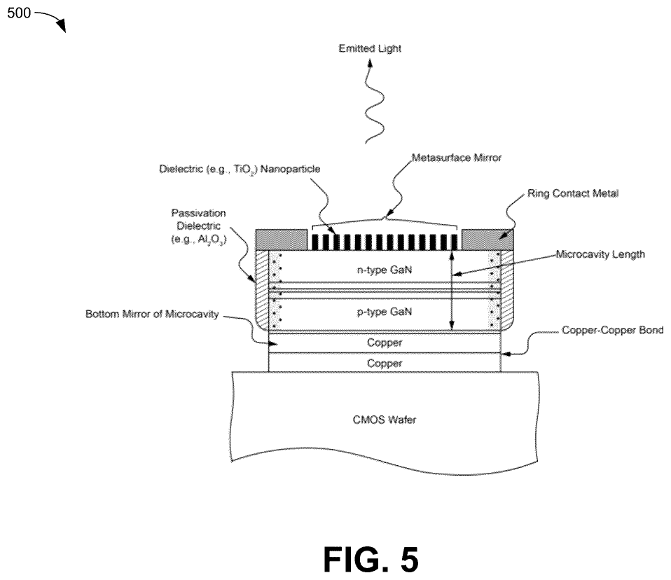

FIG. 5 depicts a cross-section of a Meta MicroLED with both Mg passivation and an ALD dielectric (e.g., Al₂O₃) passivation applied, followed by the flip-chip transfer of the MicroLED onto a Complementary Metal-Oxide-Semiconductor (CMOS) wafer containing driver circuits. Two mirrors form a microcavity within MicroLED 500. The first mirror, acting as the back mirror, is made from the copper back contact, while the second mirror, known as the front mirror, is a metasurface mirror. This metasurface mirror can include an array of dielectric nanoparticles, such as cylinders with a base diameter about one-fifth of the design light wavelength and a height approximately half of the design light wavelength. The spacing between these nanoparticles (edge-to-edge) ranges from half to a full design light wavelength, providing effective light confinement. The material for these nanoparticles is selected to be transparent to the emitted light; for example, titanium oxide is an excellent choice for blue light with a wavelength of 420 nm. This unique microcavity structure, equipped with Mg and dielectric passivation, ensures efficient light emission, narrow linewidth, and enhanced modulation speeds, making the MicroLED ideal for applications requiring precise and high-speed optical data communication, such as chip-to-chip interconnects in AI data centers.

Using Mg implantation to passivate scaled MicroLED sidewalls offers a breakthrough in achieving higher modulation speeds and reducing energy per bit from 1 pJ/bit to 0.3 pJ/bit. By implanting Mg, the sidewall defects created during manufacturing are effectively neutralized, significantly reducing non-radiative recombination and enhancing carrier lifetime. This allows MicroLEDs to be scaled down in size without compromising key performance metrics, such as speed and efficiency. The Mg implant forms a depletion region at the sidewalls, preventing carrier losses, thus enabling ultra-fast modulation and energy-efficient operation. This solution is both manufacturable and effective, making it ideal for high-speed optical applications.

Mg implant passivation improves the peak internal quantum efficiency of MicroLEDs by passivating surface states, reducing surface recombination velocity, and creating a depletion region that prevents carriers from reaching the sidewalls. These effects collectively minimize non-radiative recombination pathways, allowing a larger fraction of carriers to participate in radiative recombination, thereby enhancing the peak IQE. This makes Mg passivation a crucial technique for achieving high-efficiency MicroLEDs, particularly as device dimensions shrink and the influence of surface recombination becomes more significant.

At high current densities such as 1000 A/cm², where MicroLEDs are operated for data communication applications, Mg passivation does not drastically improve the absolute value of IQE because the efficiency losses are mainly governed by bulk effects such as Auger recombination. However, the presence of Mg passivation ensures that the surface remains non-recombining, which indirectly supports maintaining a high level of IQE by preventing any added losses from surface-related recombination.

Applying a current pulse with a high-level of 1000 A/cm² and a low level of zero, Mg passivation significantly enhances the transient behavior of the MicroLED's emitted optical power. Mg passivation reduces non-radiative recombination by neutralizing surface states, preventing carriers from being trapped at the sidewalls. This ensures that more injected carriers participate in radiative recombination, allowing a faster rise in optical power when the current pulse is applied. The Mg-induced passivation creates a depletion region at the sidewalls, which keeps electrons away from defect-rich areas, further reducing non-radiative losses. As a result, the emitted optical power reaches its peak more efficiently and quickly. Additionally, the reduced surface recombination velocity (SRV) due to Mg passivation stabilizes carrier lifetimes, leading to a smoother and more responsive modulation of light output, ensuring a more efficient and rapid optical response to the pulsed current input.

Alternative atoms to magnesium (Mg) that can produce similar benefits for MicroLED sidewall passivation include zinc (Zn) and beryllium (Be). Like Mg, Zn, for example, acts as a p-type dopant in GaN and can effectively bond with nitrogen dangling bonds, reducing non-radiative recombination and enhancing efficiency.

### Process Flow for Constructing Mg-Passivated Meta Microleds

An example process flow for fabricating an Mg-passivated Meta MicroLED begins with the preparation of a sapphire or silicon wafer as the substrate. At (1), a thin buffer layer of AlN is grown using high-temperature metal-organic chemical vapor deposition (MOCVD) epitaxy, serving to match the lattice structure and reduce strain for the subsequent layers. Next, at (2), a layer of unintentionally doped (UID) GaN with a thickness ranging from 1 to 5 micrometers is deposited using MOCVD, providing a high-quality foundation for the MicroLED structure. Following this, at (3), an n-type GaN layer is grown, typically doped with silicon, to achieve the desired conductivity, with a thickness between 300 to 600 nm. The active light-emitting region is then constructed using an MOCVD-grown multiple quantum well (MQW) structure. Each single quantum well (QW) comprises a 10-20 nm UID-GaN barrier, a thin 1-5 nm UID InGaN layer as the well, and another 10-20 nm UID-GaN barrier. This MQW structure plays a crucial role in determining the emission wavelength and efficiency of the MicroLED.

Subsequently, at (4), a p-type GaN layer is grown atop the MQW structure using MOCVD, with Mg serving as the p-type dopant. To activate the Mg and ensure high conductivity, hydrogen-free annealing is performed, which dissociates hydrogen-Mg complexes, leading to the formation of a highly conductive p-GaN layer.

Formation of MicroLED mesas occurs through a carefully optimized dry etching process to minimize damage to the sidewalls, as excessive damage can introduce non-radiative recombination centers that degrade efficiency. To address the sidewall defects, at (5), tilted Mg ion implantation is performed. For MicroLEDs with heights of 1-2 micrometers, an ion dose of approximately 1×10¹⁴ ions/cm² is used, with an implant energy of 50 keV and a tilt angle ranging from 20° to 30°. This tilted implantation allows Mg ions to effectively penetrate and bond with nitrogen dangling bonds at the etched sidewalls, creating a passivation layer that significantly reduces non-radiative recombination, thereby enhancing both efficiency and modulation speed.

Following the Mg passivation operation, at (6), a thin layer (1-2 nm) of Al₂O₃ is deposited using atomic layer deposition (ALD). This ALD process provides a conformal coating that serves as a passivation and protection layer, preventing environmental degradation and further reducing surface recombination effects. At (7), a copper contact is then formed on top of the p-GaN layer, with an appropriate metal barrier included to prevent copper diffusion into the p-GaN, which could otherwise impair device performance.

The device is then subjected to a flip-chip transfer process, where, at (8), the MicroLED is bonded onto another wafer with printed copper pads that align with the copper pads on the MicroLED. The copper pad serves as the first mirror in the microcavity structure. This flip-chip process enables the n-GaN to become the free surface, while the p-GaN remains connected to the copper mirror on the new substrate. At (9), after carefully cleaning the n-GaN surface to remove any contaminants, a metasurface mirror is fabricated on top, completing the microcavity structure in combination with the copper mirror on the p-GaN side.

The resulting structure allows light emission from the n-GaN side through the metasurface mirror, which has a reflectivity ranging from 0.9 to 0.95. This creates a highly efficient and controlled light-emitting Meta MicroLED with reduced divergence angle and spectral linewidth, ensuring that the device achieves both high modulation speeds and high optical efficiency suitable for advanced applications such as data communication and high-resolution displays.

Accordingly, various examples include Mg-passivated MicroLED structure with features such as Mg ion implantation on sidewalls, the use of the metasurface mirror, and the copper mirror forming the microcavity. The device can achieve modulation speed (>1 GHz) and low energy consumption per bit (0.3 pJ/bit) as a result of the Mg passivation and microcavity structure, applicable in optical interconnects. Mg-passivated Meta MicroLEDs in a chip-to-chip optical communication system can provide for high data transfer rates (>2 Tb/s).

Various examples include a method of manufacturing the Mg-passivated MicroLED, including process tilted ion implantation of Mg, Al₂O₃ deposition, and the flip-chip transfer to form the microcavity with copper and metasurface mirrors.

### Microled Structures for Ultra-High-Speed Optical Communication

The modulation bandwidth of c-plane MicroLEDs with Ga-polar GaN is significantly limited, posing a substantial challenge in meeting the high-performance requirements. While the target is to achieve a modulation bandwidth of >1 GHz at a current density of 1000 A/cm², current designs only attain a bandwidth of 0.2 GHz at the same current density. Various examples provide a structure and a manufacturing process for ultra-high-speed MicroLED based on N-polar GaN. N-polar GaN MicroLEDs have much higher modulation speeds than Ga-polar GaN MicroLEDs.

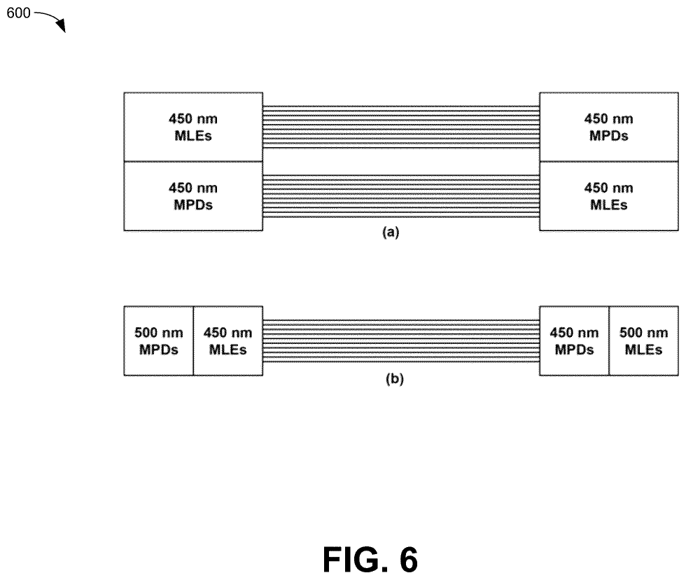

FIG. 6 depicts optical links using arrays of microscopic light emitters (MLEs) and arrays of microscopic photodetectors (MPDs). In (a), transmission in both directions are used using one wavelength and two arrays of multimode, multicore optical fibers. In (b), transmission in one direction is done using one wavelength (450 nm, for example) and transmission in the reverse direction is done using another wavelength (e.g., 500 nm) in order to reduce the number of fibers.

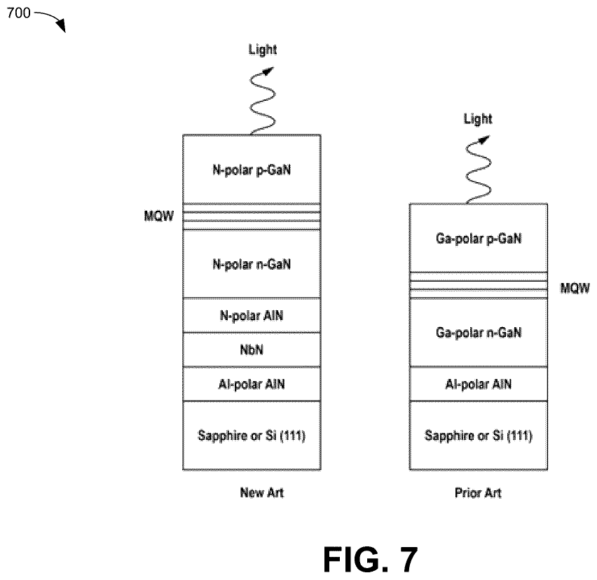

FIG. 7 depicts an example structure. Starting from sapphire or silicon substrate, a thin AlN layer is grown using Metal-Organic Chemical Vapor Deposition (MOCVD) epitaxy or radio frequency (RF) sputtering. This is followed by depositing a niobium nitride (NbN) layer that helps convert the Al-polar AlN to N-polar AlN, on which N-polar GaN is grown using MOCVD. The rest of the MicroLED epi stack including n-GaN, multiple quantum well (InGaN/GaN), and p-GaN are grown using conventional methods based on MOCVD epitaxial growth. The new art involves a NbN to enable polarity inversion from Al-polar AlN to N-polar AlN. Consequently, the GaN layers grown on the N-polar AlN film will also be N-polar.

The use of NbN film can be used as a “release layer” where a laser beam can be used to ablate or vaporize this layer to separate the MicroLED structure from the growth wafer. Modulation frequency is improved significantly without having to use ultrathin quantum wells as in the case of Ga-polar devices.

Conventional techniques for controlling the AlN polarity are based on oxygen-mediated growth mechanisms. By contrast, various examples invert the polarity of wurtzite-type AlN using lattice-matched centrosymmetric NbN. Experimental data on exists in the literature showing that the surface of AlN grown by sputtering on NbN/Al-polar AlN is atomically flat and highly crystalline. Also, structural analysis with scanning transmission electron microscopy data in the literature shows that the AlN grown on NbN/Al-polar AlN was N-polar. All-nitride epitaxial N-polar AlN/NbN/Al-polar AlN heterostructure does not contain oxide materials, which degrade the optical and electrical properties of AlN.

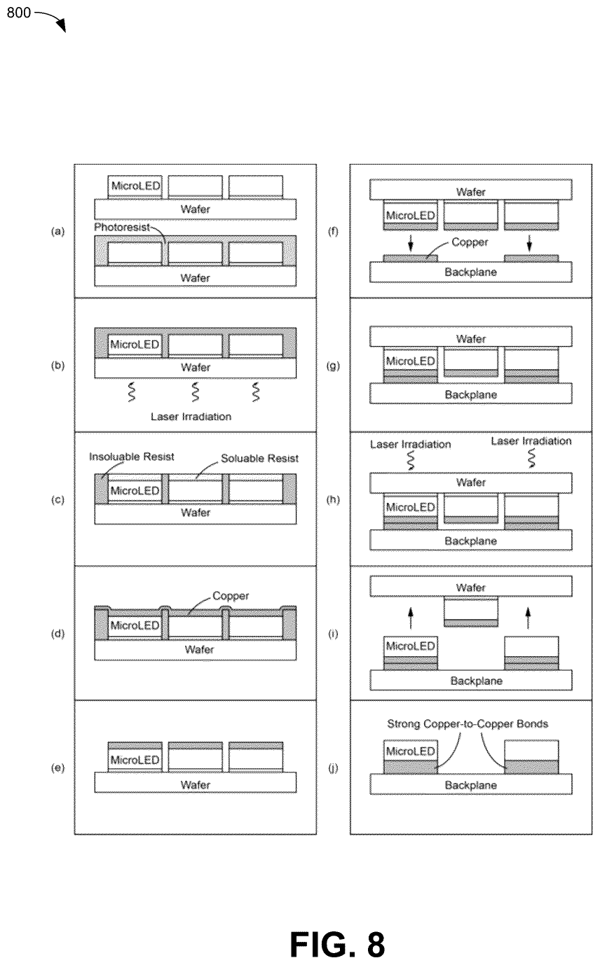

FIG. 8 depicts an example of micro transfer printing of MicroLEDs. A Direct Transfer Method (DTM) can be used where the donor wafer is used instead of a stamp to donate its MicroLEDs directly to the backplane (e.g., CMOS wafer). Operations (a) to (e) form copper contacts on the MicroLEDs, operations (f) and (g) perform selective bonding, operations (h) and (i) perform selective release, and finally annealing bond to form a strong copper bond between the MicroLEDs and the backplane. The laser ablates the NbN layer to separate the MicroLED from growth wafer and donates it to backplane.

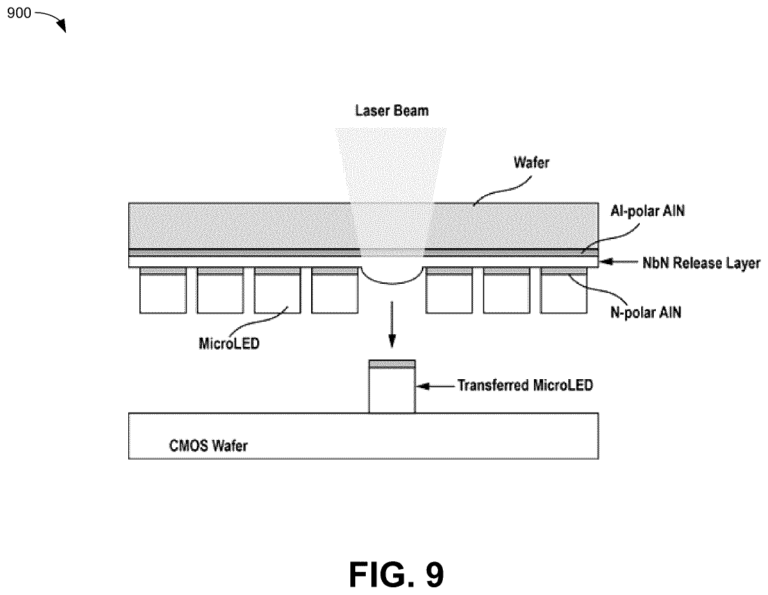

FIG. 9 is a schematic illustration of the use of NbN layer as a release layer for the MicroLEDs. NbN layer performs polarity inversion to enable ultra-high-speed N-polar GaN MicroLEDs for datacom.

### Monolithic Polychromatic Microled Transmitter

In MicroLEDs, some emitted light is trapped as evanescent modes due to total internal reflection. Metasurfaces can couple these trapped waves into free-space modes, improving external quantum efficiency. When the size of nanoparticles in a metasurface is smaller than the wavelength of light, the electromagnetic wave becomes highly confined within these subwavelength structures. According to the Heisenberg uncertainty principle, this spatial confinement (Δx) leads to a large uncertainty in the wave vector (Δk), meaning the wave's momentum is less well-defined. This broadening of the wave vector distribution opens up the energy space for the wave, allowing the metasurface to access and manipulate a wider range of optical modes. As a result, several key phenomena emerge. The ability to control a broader range of momenta enables more precise wavefront shaping, allowing metasurfaces to bend, focus, and redirect light with high efficiency. Additionally, subwavelength confinement enhances interactions with evanescent waves, making these structures powerful tools for enhancing light extraction efficiency. In other words, metasurfaces on top of MicroLEDs not only does not degrade efficiency but actually improves it.

Various examples can tune pitch size, materials of nanoparticles, or polarization of metasurface mirrors to emit a particular color (lithography, deposition, etch). Various examples of MicroLEDs with <5 nm linewidth can emit multiple peak wavelengths on the same wafer. A Meta MicroLED is a classical “planar” or nanowire MicroLED structure (e.g., p-GaN/InGaN quantum well (QW)/n-GaN) that is sandwiched between a front mirror and a back mirror. The InGaN QW is tuned to emit green color with wide emission spectrum (e.g., intentionally large Full Width at Half Maximum (FWHM)).

The front and back mirrors are metasurface structures made with an array of dielectric nanoparticles. These array of nanoparticles are deposited using low-cost liquid atomic layer deposition, for example. The pitch and size of the front and back mirror are tuned such that a phase is imposed on the light wave packet falling on the mirror surface. The peak emission wavelength is determined by the phases imposed by the front and back mirrors according to the relationship:

$$4 π n ( {t}_{b} + {t}_{f} ) / {λ}_{p} + {ϕ}_{f} + {ϕ}_{b} = 2 π k \qquad Eq . ( 1 )$$

where ϕ_{f} and ϕ_{b} are the phase shift due to front and back mirrors, respectively, t_{b} is the distance between the quantum well and the back mirror, t_{f} is the distance between the quantum well and the front mirror, and n is the effective refractive index of the cavity.

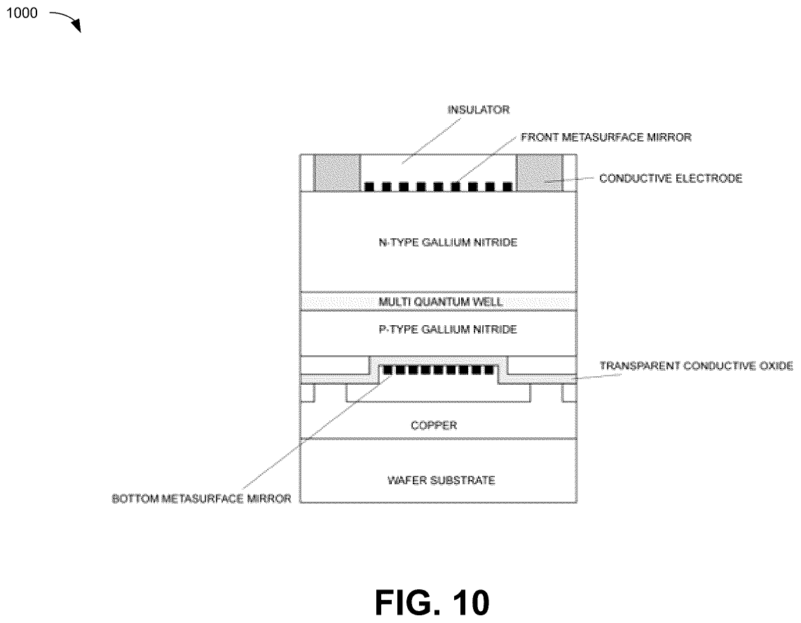

FIG. 10 depicts a schematic cross section of the Meta MicroLED structure. Meta MicroLED 1000 includes metasurface mirrors forming a cavity by: (1) front metasurface mirror and (2) back/bottom metasurface mirror. The phases imposed on the wave packets reflected on both mirrors (ϕ_{f}+ϕ_{b}) determine the resonance peak wavelength as described by Eq. (1). The pitch and size of the nanoparticles making up the metasurface mirrors will determine the emission peak wavelength.

In Meta MicroLED 1000, the active layer is sandwiched between two metasurface mirrors, forming a cavity. The emission spectrum from a cavity, SE (1) is related to the as-grown spontaneous emission PL(λ) by modeling the interference between coherent spontaneous wavepackets emitted in opposite directions from the individual emission events:

$$S E ( λ ) = {T}_{f} \cdot PL ( λ ) \cdot \frac{1 + {ρ}_{b}^{2} + 2 {ρ}_{b} cos ( 4 π {nt}_{b} / λ + {ϕ}_{b} )}{1 + {ρ}_{f}^{2} {ρ}_{b}^{2} + 2 {ρ}_{f} {ρ}_{b} cos ( 4 π n ( {t}_{b} + {t}_{f} ) / λ + {ϕ}_{f} + {ϕ}_{b} )} \qquad Eq . ( 2 )$$

where ρ_{f} and ρ_{b} are the reflectance of front and back mirrors, respectively, ϕ_{f} and ϕ_{b} are the phase shift due to front and back mirrors, respectively, t_{b} is the distance between the quantum well and the bottom mirror, t_{f} is the distance between the quantum well and the front mirror, and n is the effective refractive index of the cavity. For simplicity, ρ_{b} and ρₛ are assumed to have no dependence on λ, which can be realized by properly designing the metasurface mirrors.

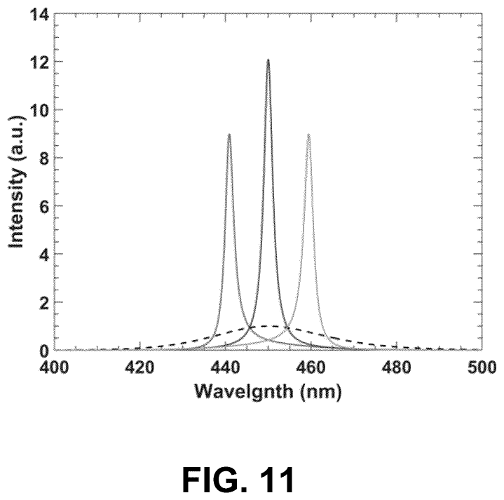

FIG. 11 depicts a calculated spectral emission along with the native stack PL spectrum. Indeed, SE(λ) has a narrower emission than PL(λ). Calculated spectra for Meta MicroLED for three different values for the phase of produced by the front mirror are shown for values of ϕ_{f} was −π/4, 0, and π/4 As can be seen, three different spectra may be produced using well-designed front surface mirror. The native spectrum is shown as dotted line. The amplitude of the dominant wavelength is shown to be enhanced by forming the cavity. It can be seen that if the phase shift at the front and back mirrors are tuned by properly designing the metasurface, one can tune the dominant wavelength λₚ.

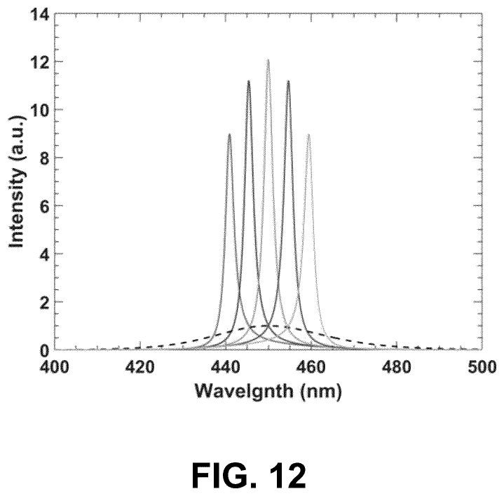

FIG. 12 depicts calculated spectra for Meta MicroLEDs for five different values for the phase of produced by the front mirror for the values of ϕ_{f} was −π/4, −π/8, 0, π/8, and π/4. As can be seen, five different spectra may be produced using well-designed front surface mirror. The native spectrum is shown as dotted line.

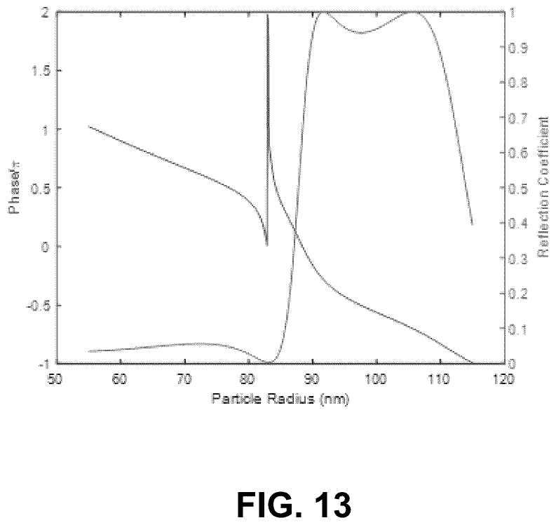

FIG. 13 depicts phase and reflection coefficient are cross plotted with the meta-atom radius for design wavelength of 450 nm. The meta-atom nanoparticle diameter can be tuned from 180 nm to 220 nm and as a result the phase is varied from 0.4π to 0.7π, which results in peak wavelength of 430 nm to 484 nm.

### Optical Code Multiplexing and Devices Enabling Parallel Data Communications Using Microleds or μVCSELS

Optical code division multiplexing (OCDM) is a communication method that extracts a signal by pattern matching by allocating different codes (patterns) to each channel. OCDM is a technology that encodes, on the transmission side, an optical pulse signal by an optical code that is different for each communication channel and which, on the reception side, performs decoding to restore the original optical pulse signal by using an optical code that is the same as that of the transmission side for each communication channel.

Various examples provide an OCDM transceiver. The proposed OCDM transceiver comprises an encoding portion and a decoding portion. The decoding portion comprises a decoder, clock extractor, and time gate. The decoder decodes an encoded optical pulse signal and separates the encoded optical pulse signal into a clock signal extraction signal and an optical pulse signal. The clock extractor extracts a clock signal from the clock signal extraction signal. The time gate removes only the auto-correlation waveform component from the optical pulse signal. The auto-correlation waveform component is converted to an electrical signal by an optical receiver and generated as a reception signal.

The encoder divides the optical pulse signal into chip pulses to form an array. In other words, the encoder divides and arranges optical pulses that constitute the optical pulse signal one by one into chip pulses by generating a time lag difference between wavelengths components on the time axis. When the process in which the optical pulse signal is divided into chip pulses by the encoder is considered, one optical pulse is spread and arranged on the time axis and hopping is performed for each wavelength. As a result, encoding performed by the encoder is called time spreading/wavelength hopping encoding. An encoded optical pulse signal is transmitted to the reception side as a result of propagation through an optical fiber. On the reception side, a playback optical pulse signal that is the same as the original optical pulse signal is played back as a result of decoding by a decoder with a function for decoding a code that is supplied by code that had been applied by the encoder.

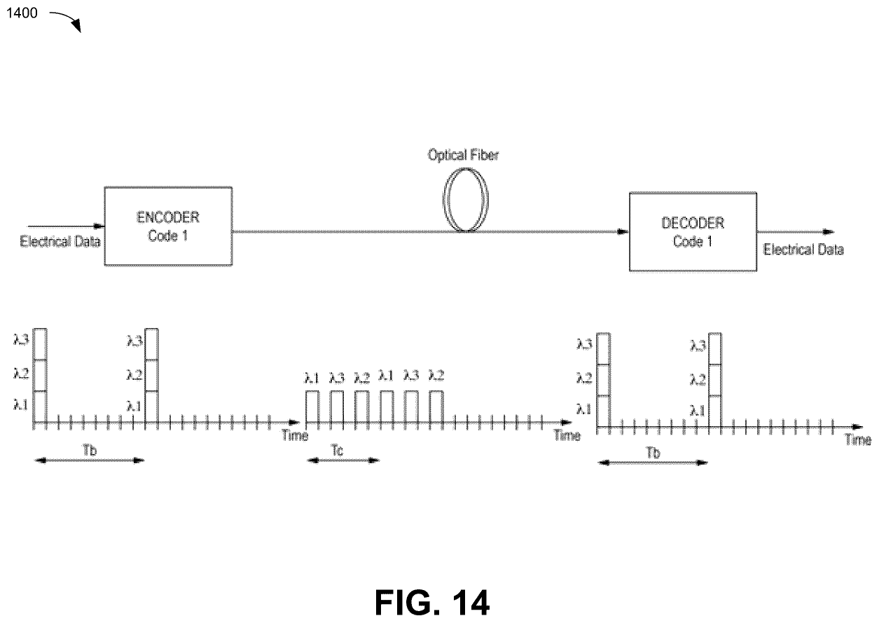

FIG. 14 depicts a schematic illustration of the data communication system. In system 1400, the bit rate, which expresses the communication speed, is the speed indicating whether it is possible to send and receive information on how many bits per unit time and is the reciprocal of the “data cycle” that is represented by the time T_b. Further, the maximum spread time per bit (one optical pulse) is also known as the “code cycle” that is represented by the time T_c. That is, the code cycle is the maximum time width that is allocated to each optical pulse constituting an optical pulse signal on the time axis of an encoded optical pulse signal.

On the transmit (TX) side, each data line coming from the transmitting chip drives three MicroLEDs (or μVCSELs). A first MicroLED emits λ₁. A second MicroLED emits λ₂. A third MicroLED emits λ₃. In order to illustrate the fact that this is light of the wavelengths λ1, λ2, λ3, and λ4, the codes λ1, λ2, λ3, and λ4 are appended in the rectangles representing the rectangular waves. Because a single optical pulse is generated from light rendered by mixing light of the wavelengths λ1, λ2, λ3, and λ4, rectangles to which the codes λ1, λ2, λ3, and λ4 have been appended are shown stacked on the time axis.

The data from two or more data lines (channels) produce coded light signal that are coupled into one core of the MCFs. For example, if 4 data lines are connected to four pixels (each pixel is composed of three MicroLEDs emitting three different wavelengths, for example), 1024/4=256 fiber cores can be used instead of 1024 MCF to achieve 2 Tb/s/direction for the entire link as desired. With OCDM and systems described herein, 256 cores can be used instead of 1024 MCF to achieve 2 Tb/s/direction for the entire link as desired.

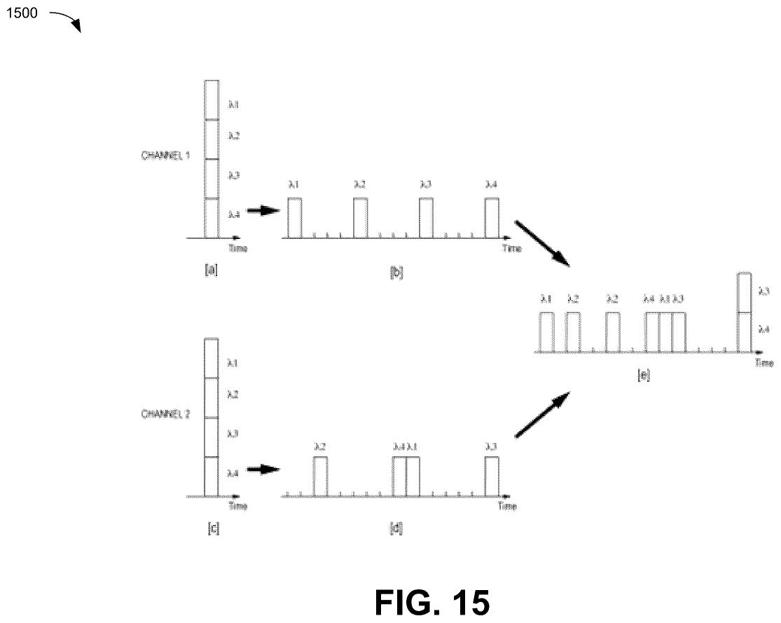

FIG. 15 depicts an example of combining optical pulses. A first optical signal is formed from a first data line controlling a first set of four MicroLEDs (emitting wavelengths λ1, λ2, λ3, and λ4) with timing for each wavelength illustrated. A second optical signal is formed from a second data line (channel) that controls a second set of four MicroLEDs. The two optical signals are then multiplexed to produce one signal that is coupled into one core of a multicore fiber. In other words, two data lines (i.e., two channels) are transmitted over one core of the multicore fiber.

A single optical pulse of a first channel is shown in (a). The optical pulse is generated from light rendered by mixing light of the wavelengths λ1, λ2, λ3, and λ4. The optical pulse shown in (a) is encoded by code supplied by Code 1. As shown in (b), the pulse has a shape rendered through division into “chip pulses” and arrangement by time spreading/wavelength hopping on the time axis. In keeping with the rule that the wavelengths of chip pulses are to be arranged with respect to the positions in which the chip pulses exist and O's are arranged with respect to the positions where chip pulses do not exist, on the time axis, supposing that code is shown in the form of a progression that is lined up on one row on the time axis, the code supplied by Code 1 is written as (λ1, 0,0,0,0, λ2, 0,0,0,0, λ3, 0,0,0,0, and λ4). Thereafter, the fact that code supplied by Code 1 is shown by means of the above progression is abbreviated in the format Code 1=(λ1, 0,0,0,0, λ2, 0,0,0,0, λ3, 0,0,0,0, and λ4).

A single optical pulse of the second channel is shown in (c). As per the first channel, the optical pulse is also generated from light that is rendered by mixing light of the wavelengths λ1, λ2, λ3, and λ4. The optical pulse of the second channel that is shown in (c) is encoded by code that is supplied by Code 2 and has a shape rendered through arrangement by means of time spreading/wavelength hopping on the time axis as shown in (d). Similar to the code used for the first channel and Code 1, the code used for the second channel and Code 2 are expressed in the form of a progression as follows. That is, Code 2=(0,0, λ2, 0,0,0,0,0, λ4, λ1, 0,0,0,0,0, λ3).

The result of multiplexing the first and second channels above is the arrangement shape of the channel pulses shown in (e) (encoded optical pulses). The arrangement of chip pulses shown in (e) combines the encoded optical pulses of the first channel that are encoded by means of Code 1 shown in (b) and the encoded optical pulses of the second channel that are encoded by means of Code 2 shown in (d). The multiplexed signal shown in (e) is then coupled to one single core of the plurality of cores provided by the MCF.

The microscale light emitters (e.g., MicroLEDs or μVCSELs) need to have narrow linewidth in order to use four (for example) colors (wavelengths) for the coding scheme described above.

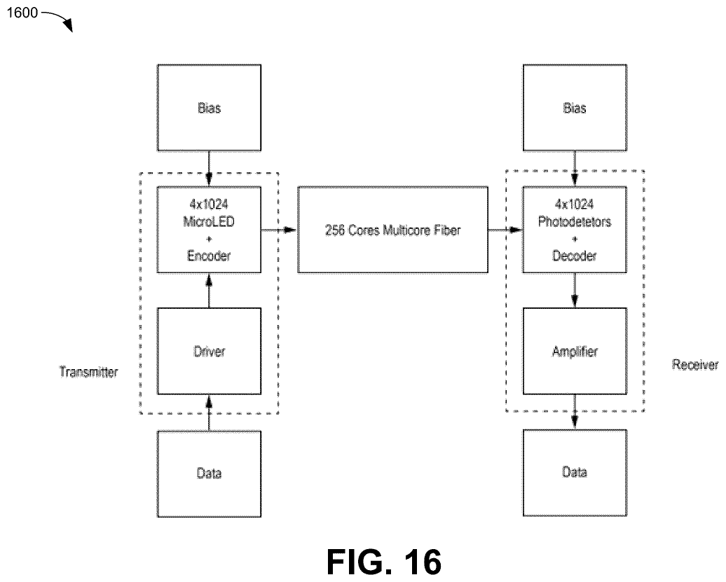

FIG. 16 depicts an example system that uses fibers of 256 cores. Various examples provide a system with an encoder, a channel (MCF), and a decoder. The encoder includes N MicroLEDs per input electrical data line. The MicroLEDs (Meta MicroLEDs) emit lights with different dominant wavelength. For example, N=4 Meta MicroLEDs can be used that emit lights with peak wavelengths of 420 nm, 440 nm, 460 nm, and 480 nm. Each emission spectrum has a full-width-half-maximum of less than 10 nm, for example. The decoder includes N microscale photodetectors for each electrical data line. Each photodetector is tuned to one of the emission spectra used at the encoder side. The waveguide is a multicore (and multimode) plastic optical fiber. The number of cores required to transfer M data lines (channels) is equal to M/N. For example, if M=1024 and N=4, the number of cores in the MCF shown in the system of FIG. 2 is 1024/4=256.

The microscale photodetectors can be made of heterostructure phototransistors based on GaN material system. These phototransistors have high gain which allows for longer reach compared to a case where PIN photodiodes are used instead.

### Voltage-Tunable Microscopic Heterostructure Phototransistor

Photodetectors with voltage-tunable spectral response have long been sought in optoelectronics to overcome fixed-wavelength limitations. Achieving tunability often compromised efficiency, responsivity, and noise levels, highlighting the complexity and motivating ongoing research into advanced materials and device architectures for improved performance.

In a heterojunction phototransistor (HPT) the input light passes through the transparent emitter and is absorbed in the base, the base-collector (b-c) depletion region, and the collector. The photo-generated holes flow into the base layer and accumulate there. Then, the emitter-base potential barrier is decreased and electrons are injected into the base from the emitter. The primary photocurrent is amplified by the normal transistor action. The short wavelength edge of the spectral response is determined by the energy bandgap of the emitter layer, and the long wavelength edge by the bandgap of the base and the collector layers. Thus, the spectral response is fixed for a given HPT.

Various examples provide voltage tunable photodetection for ultra violet (UV), visible, or infrared spectra. Various examples address photodetector designs that required high bias for sensitivity, leading to higher energy consumption. Some photodetectors lack adaptability for high-yield, heterogeneous integration of microscopic, multi-wavelength sensitive detectors, essential for creating high-resolution, low-power polychromatic image sensors. HPT can achieve voltage-tunable spectral response by leveraging a multi-layer collector design that allows selective absorption of light across different wavelengths. The device's collector is split into two layers, I and II, where the bandgap of collector I matches that of the base, and the bandgap of collector II is narrower. The device can absorb shorter wavelengths of light (e.g., 400-450 nm) in the base and collector I, while longer wavelengths (e.g., 450-650 nm) are absorbed in collector II. Tuning the spectral response is based on the distance “h” between the base-collector (b-c) depletion region and collector II. This distance can be modulated by adjusting the bias voltage, which alters the depletion region's width.

When light is absorbed in collector II, photo-generated holes diffuse to the b-c depletion region to contribute to the photocurrent. If the distance “h” is smaller than the diffusion length of the holes in collector I, the holes can reach the base efficiently, resulting in a strong primary photocurrent. However, if “h” becomes much larger than the diffusion length due to a higher bias voltage, many of the holes recombine in collector I, reducing their contribution to the photocurrent. By controlling the bias voltage, the device can dynamically adjust the distance “h,” thus tuning which wavelengths are efficiently detected.

An example structure design based on the Alₓ Ga₁₋ₓAs material system targets cutoff wavelength range 520-880 nm for detection is shown in Table 1.

TABLE 1
Layer specification of HPT based on the AlₓGa₁₋ₓAs
material system targeting cutoff wavelength
range 520-880 nm. Substrate wafer may be GaAs.

| | | | | Doping |
|---|---|---|---|---|
| | | Thickness | Doping | Concentration |
| | Material | (nm) | Type | (×10¹⁷ cm⁻³) |
| Emitter | Al_{0.5}Ga_{0.5}As | 90 | N | 2 |
| Spacer | Al_{0.5}Ga_{0.5}As | 10 | N | 0.05 |
| Base | Al_{0.2}Ga_{0.8}As | 150 | P | 0.5 |
| Collector I | Al_{0.2}Ga_{0.8}As | 200 | N | 0.1 |
| Collector II | GaAs | 50 | N | 1 |

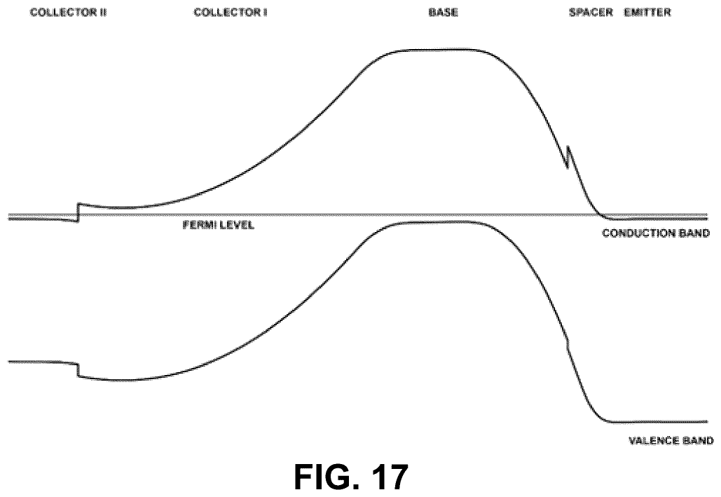

FIG. 17 depicts an example energy band diagram of heterojunction phototransistor (HPT) with two-layered collector based on AlGaAs material system. Emitter is to the far right of the diagram.

An example structure design based on the Inₓ Ga₁₋ₓN material system targets cutoff wavelength range 420-600 nm for detection is shown in Table 2.

TABLE 2
Layer specification of HPT based on the InₓGa₁₋ₓN
material system targeting cutoff wavelength
range 520-880 nm. Substrate wafer may be Sapphire.

| | | | | Doping |
|---|---|---|---|---|
| | | Thickness | Doping | Concentration |
| | Material | (nm) | Type | (×10¹⁸ cm⁻³) |
| Emitter | GaN | 50 | N | 10 |
| Spacer | GaN | 10 | N | 0.05 |
| Base | In_{0.20}Ga_{0.80}N | 70 | P | 1 |
| Collector I | In_{0.20}Ga_{0.80}N | 100 | N | 0.2 |
| Collector II | In_{0.30}Ga_{0.70}N | 50 | N | 0.2 |

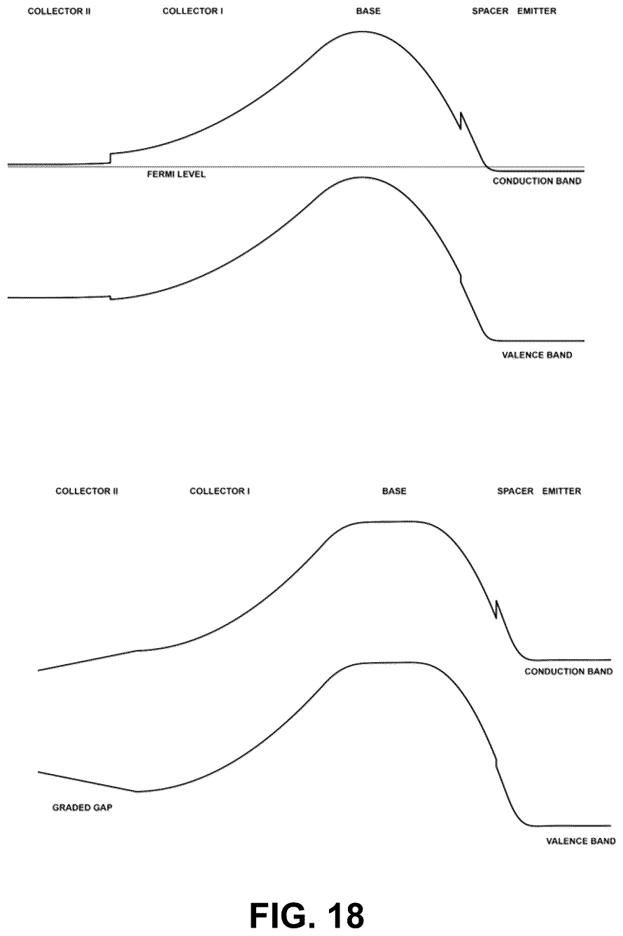

FIG. 18 depicts an example energy band diagram of heterojunction phototransistor (HPT) with two-layered collector based on InGaN material system. Detection of light signal is based on energy gap between conduction band and valence band. An energy band diagram of heterojunction phototransistor (HPT) with graded-gap collector is depicted.

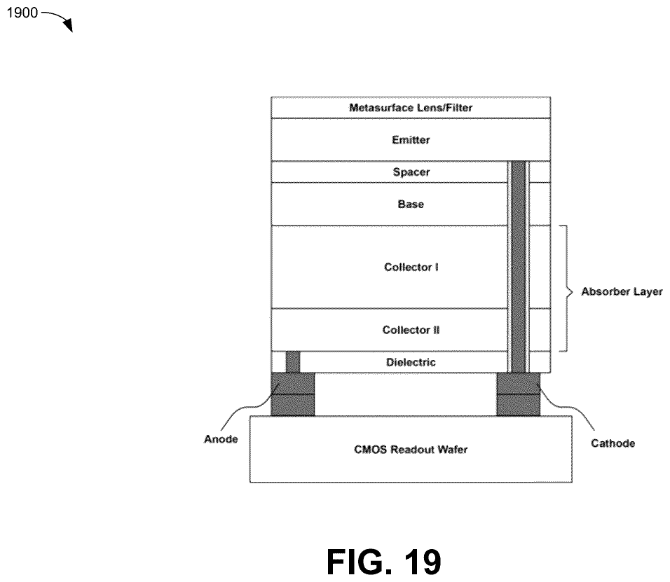

FIG. 19 depicts an example cross section schematic of the voltage-tunable phototransistor after connection to the CMOS readout wafer with detection circuitries have been fabricated. A metasurface lens/filter provides additional selectivity for light detection.

The examples are not limited to a particular wavelength range. The examples can be used to detect UV, visible, infrared, and other spectra with the use of the appropriate material system. Co-planar contact structures for the anode and cathode facilitate transferring the photodetector from growth wafer to CMOS readout circuit to make an image sensor. The proposed detector has a large internal gain (˜100-1000), high bandwidth (GHz range), and low dark current (1 nA/cm² range). The structure is manufacturable using MOCVD epitaxy, which is more manufacturable and more cost-effective compared to MBE.

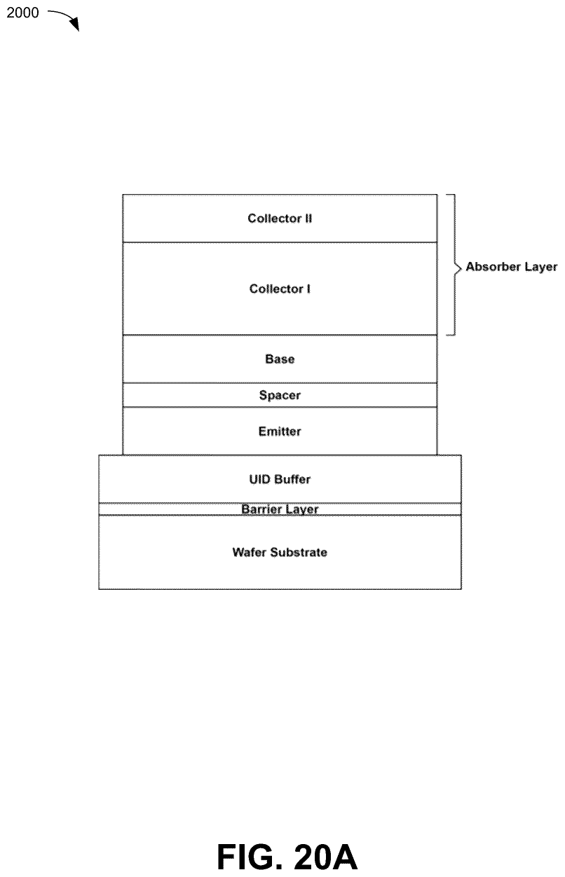

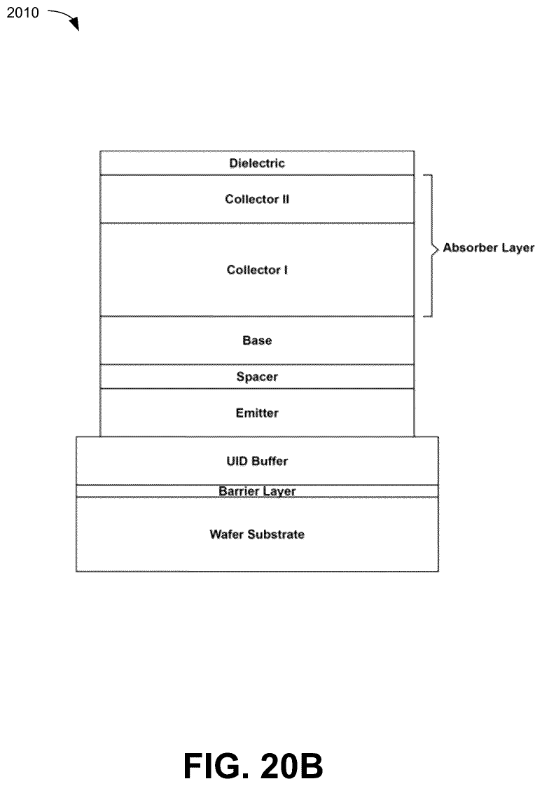

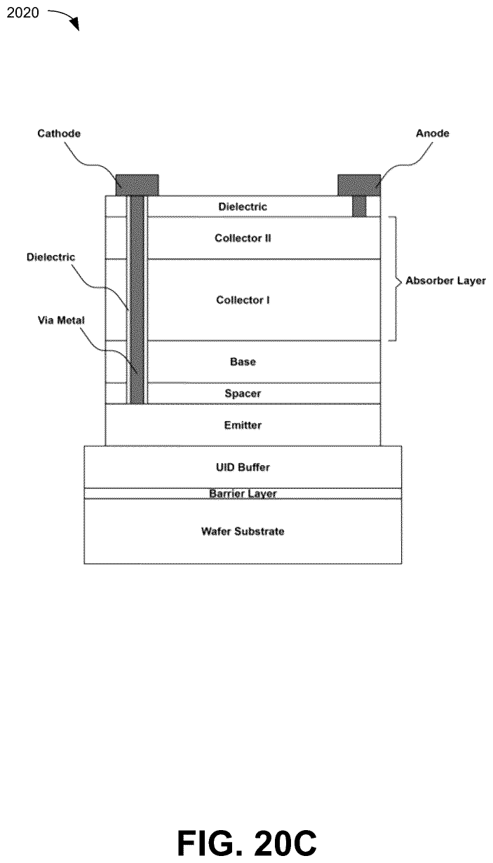

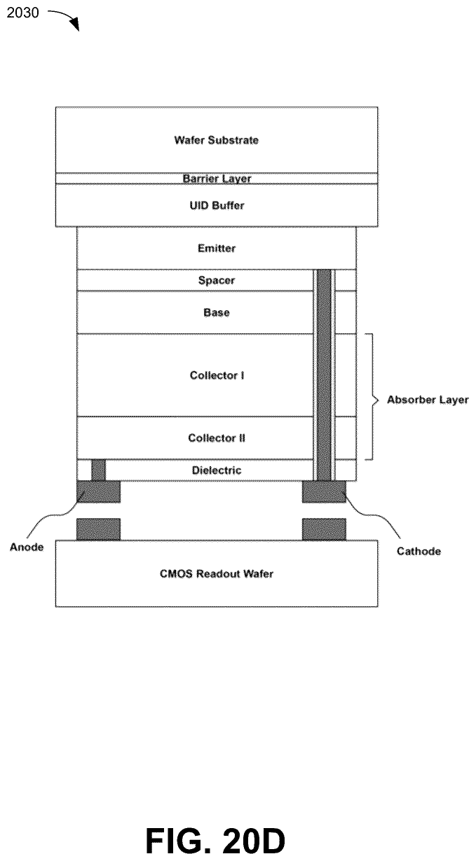

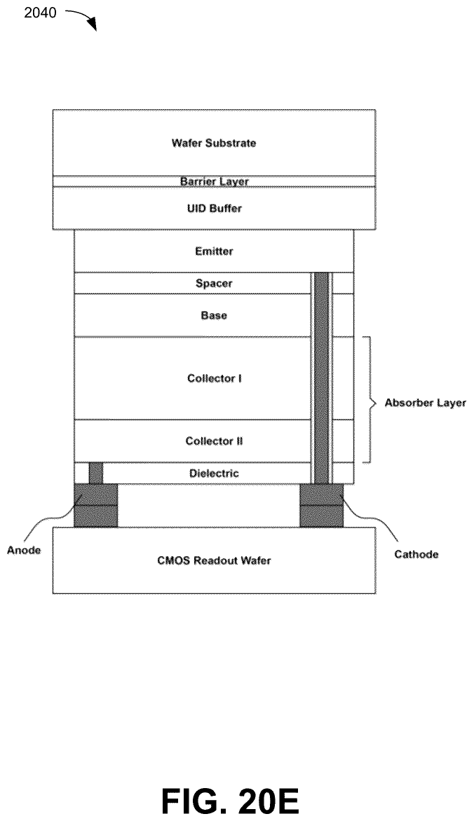

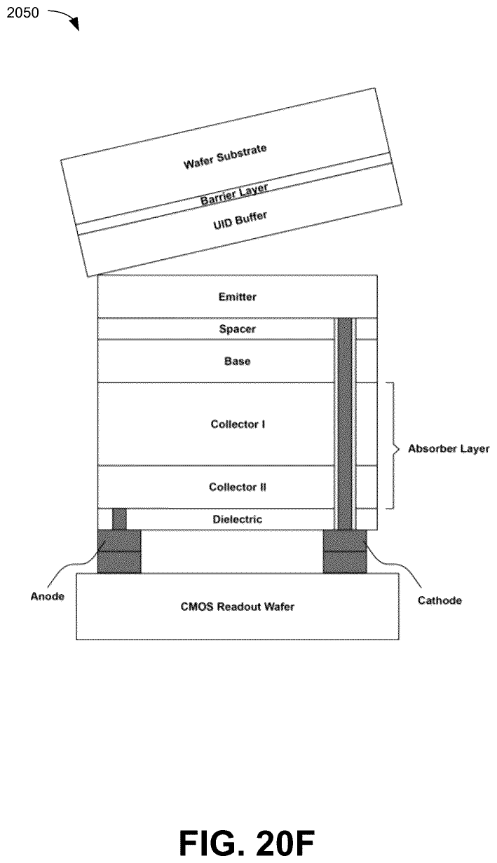

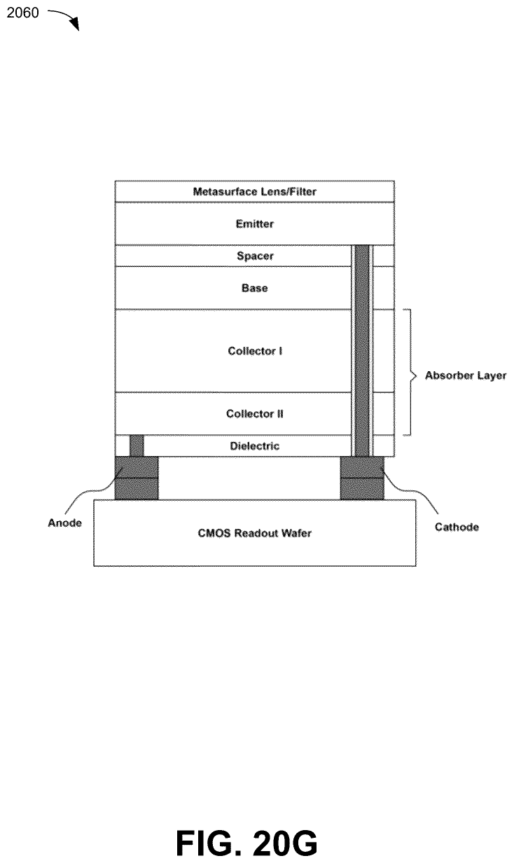

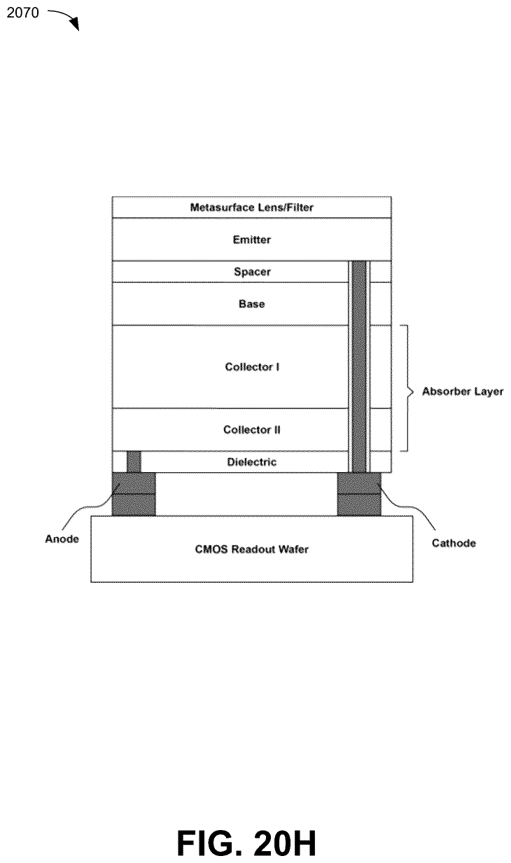

FIGS. 20A-20H depict an example fabrication process. The following is a process flow to grow the voltage-tunable HPT then transfer it to a CMOS readout circuit using the unique co-planar cathode and anode contact structure proposed herein. FIG. 20A depicts a structure after growth of epitaxial stack and mesa etch. Cleaning and surface preparation are performed on a wafer substrate for epitaxial growth. Growing a barrier layer prevents reaction of subsequent layers with the wafer substrate. Growing un-intentionally doped (UID) buffer layer provides a template for growing high quality epi device layers on top. Growing the emitter (n-type doped), spacer (undoped), base (p-type doped), collector I (lightly doped n-type), and collector II (relatively higher doping than collector I layer) can occur. Example materials, thickness, and doping values are given in Table 1 for detecting wavelengths in the range 520 nm-880 nm.

FIG. 20B depicts a structure 2010 after depositing a dielectric layer to facilitate further processing of interconnects as shown in next operations. FIG. 20C depicts a structure 2020 after etching trenches to make contacts to the emitter and the collector II layers using lithography, etch, dielectric deposition on the sidewalls of the trench, and metal fill. Contact pads for the cathode and anode terminals are fabricated. FIG. 20D depicts a structure 2030 after including flip-chip the growth wafer and align with the CMOS readout wafer so that the cathode and anode terminals face the corresponding terminals on the CMOS readout wafer in preparation for bonding. FIG. 20E depicts a structure 2040 after bonding of anode and cathode terminals to the CMOS readout circuit terminals using hybrid bonding, for example. FIG. 20F depicts a structure 2050 after removal of growth substrate. FIG. 20G depicts a cross section of a structure 2060 after removal of growth wafer. FIG. 20H depicts a structure 2070 after deposition and patterning of a metasurface lens/filter on the surface of the emitter layer. FIG. 201 depicts a structure 2080 receiving incident light on the phototransistor through the metasurface lens/filter.

Various examples can include a voltage-tunable heterojunction phototransistor (HPT) comprising: an emitter layer, base layer, and a multi-layer collector structure including collector I and collector II, where: the emitter layer is transparent to incoming light, the base layer is configured to accumulate photo-generated holes, and the collector I has a bandgap similar to the base layer and absorbs shorter wavelengths of light, while collector II has a narrower bandgap and absorbs longer wavelengths of light; a base-collector (b-c) depletion region, wherein the distance between the b-c depletion region and collector II (denoted as “h”) is modifiable by applying a bias voltage, allowing selective tuning of the spectral response of the phototransistor; and a co-planar cathode and anode contact structure, enabling connection to a readout circuit. In some examples, for the heterojunction phototransistor, the emitter, base, and collector layers are made from the AlGaAs material system, with the emitter having an Al mole fraction of 0.7, the base having an Al mole fraction of 0.2, and the collector II being composed of GaAs for a detection range of 520-880 nm. In some examples, the device includes a metasurface lens or filter for enhancing spectral selectivity of incident light. In some examples, the heterojunction phototransistor of claim 1, wherein the co-planar contact structure facilitates hybrid bonding with a complementary metal-oxide-semiconductor (CMOS) readout circuit.

In some examples, a multi-layer voltage-tunable heterostructure phototransistor includes a voltage-controllable depletion region within the multi-layer collector, allowing spectral response tuning across multiple wavelength bands, wherein the material system can be varied to target UV, visible, and infrared ranges.

In some examples, an imaging sensor includes: a plurality of heterojunction phototransistors, each tuned to different spectral bands using voltage-tunable control, forming a polychromatic imaging array capable of capturing multispectral images.

Various examples can include a method for voltage-tuning the spectral response of a heterojunction phototransistor, that includes: modifying the depletion width of the base-collector (b-c) region by applying an external bias voltage; absorbing shorter wavelengths of light in the base layer and collector I and longer wavelengths of light in collector II; and controlling the distance “h” between the b-c depletion region and collector II, affecting the diffusion and recombination of photo-generated holes, thereby tuning the spectral response of the device.

In some examples, the spectral response is dynamically adjusted between the visible and infrared regimes by selecting appropriate material systems for the base, emitter, and collector layers, such as using GaN for ultraviolet detection or InGaAs for infrared sensing.

Some examples include a manufacturing process for a voltage-tunable heterojunction phototransistor, that includes: growing the phototransistor structure on a substrate, including emitter, base, and multi-layer collector regions; implementing a flip-chip bonding process to integrate the phototransistor with a CMOS readout circuit using co-planar cathode and anode terminals.

### Voltage-Tunable Microscopic Photodetector

Photodetection systems use separate photodetectors and external filters to achieve wavelength selectivity. These systems include multiple components, such as optical filters, that are placed in front of the photodetector to isolate the desired wavelength. Such systems allow for some degree of wavelength selectivity and can be adapted for different light detection applications. Additionally, these systems are relatively well-established and can be modified to cover a wide spectral range by swapping out filters. However, their modularity and reliance on external components make them bulky, less efficient, and unable to offer the fine-tuned control or integrated design that modern applications increasingly demand.

Various examples of photodetectors include heterogeneous integration of microscopic, multi-wavelength sensitive detectors, and low-power polychromatic image sensors. Photodetectors can utilize voltage tunable photodetection for UV, visible, or infrared spectra. Various examples include a tunable monolithic integrated photodetector designed to detect light at a target wavelength within a specified range. The photodetector includes a filter, a detector, and a bias, integrated atop a single substrate. Both the filter and detector are constructed from multiple quantum well (MQW) materials, ensuring efficient light interaction. The filter, formed as the first MQW layer, captures incident light, selectively filtering it before passing the refined signal to the second MQW layer, the detector, which identifies the selected wavelength.

To enhance the photodetector's accuracy, a bias is employed, that includes a fixed bias VF and a variable bias VX. The fixed bias, applied between the filter and detector using voltage source VFF, ensures that the filter absorbs light wavelengths surrounding the target wavelength, thereby sharpening the detector's focus on the desired signal. Simultaneously, the variable bias VX, applied through voltage source VXX, adjusts both the filter and detector, allowing precise tuning of the target wavelength within the photodetector's tunable range. For even greater wavelength selectivity, a fixed external filter can be added, enabling the exclusion of wavelengths beyond the photodetector's range, thereby optimizing detection accuracy.

In some examples, multiple photodetectors can be arranged into a two-dimensional array, expanding versatility. Such an array offers broad application potential, particularly in imaging technologies where high-resolution wavelength detection is crucial. Examples provide tunable wavelength selectivity but also demonstrates adaptability across various applications, making it a promising solution for advanced optical sensing and imaging systems, where precise, dynamic control over wavelength detection is essential.

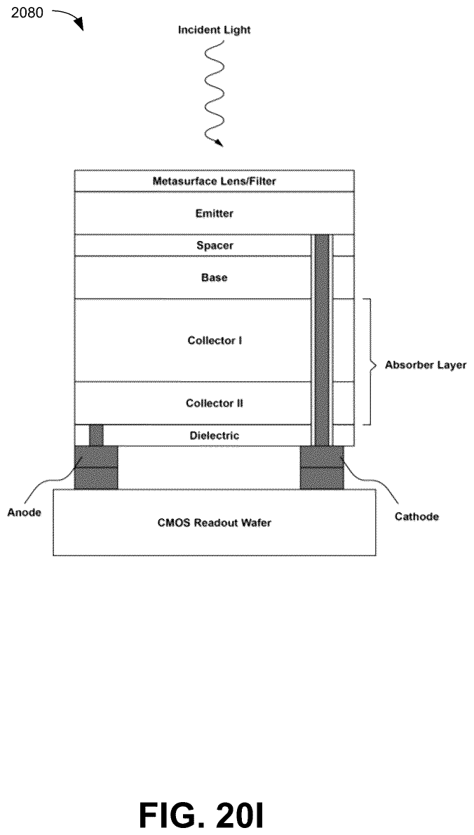

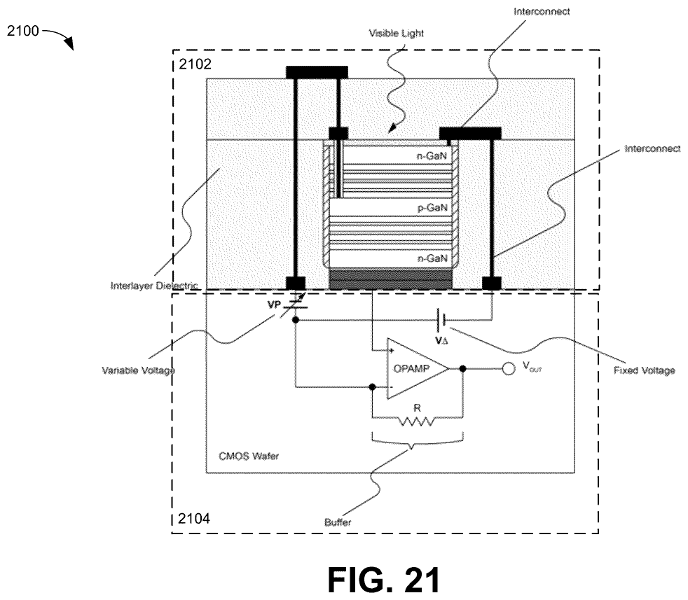

FIG. 21 depicts an example voltage-tunable photodetector and associated circuit connected to it to illustrate an example operation. In structure 2100, the top MQW is an MQW filter 2102 and the bottom MQW is MQW detector 2104. A fixed voltage bias VA is applied between the MQW filter and the MQW detector via a fixed voltage source. The voltage source VS is connected between a contact on the top surface of the n-doped layer and the input of a buffer. The fixed voltage bias VA causes the MQW filter to absorb light wavelengths substantially surrounding the target wavelength to thereby enhance the detectability of the target wavelength. By offsetting the bias VA of the MQW filter with respect to the MQW detector, the photocurrent spectrum of the MQW detector is slightly shifted (along the wavelength axis) compared to that of the MQW filter. This predicament creates a narrow wavelength region where detectability is maximized, thus closely approximating a single wavelength, voltage tunable photodetector.

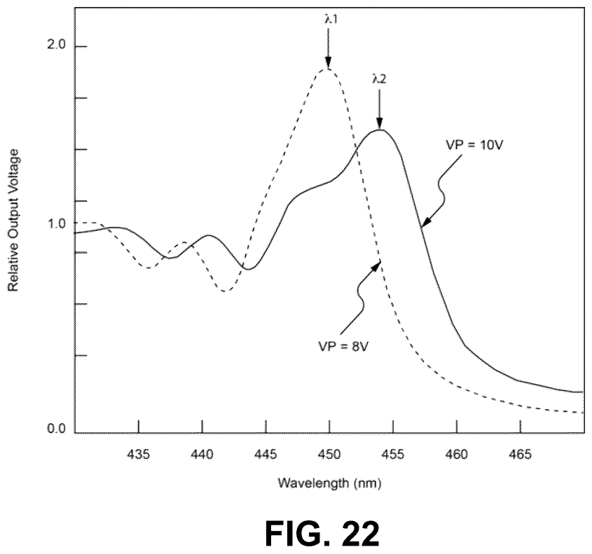

FIG. 22 depicts a photodetector's output, represented as preamp output voltage versus incident light wavelength, reveals distinct spectral features under varying voltage biases. When the fixed voltage bias VA is set at 6V and the variable voltage bias VP is adjusted to 8V and 10V in separate trials, notable changes are observed. The excitons from the multiple quantum well (MQW) detector appear as peaks, while those from the MQW filter manifest as dips in the spectrum. This results in an enhanced peak-to-valley ratio, significantly improving the detector's spectral resolution. As the fixed bias VA increases, the red shift difference between the detector and filter narrows, with shifts ranging from 10 to 20 nm. This tunability underscores the photodetector's ability to precisely discern wavelengths, making it highly adaptable for applications requiring fine spectral detection.

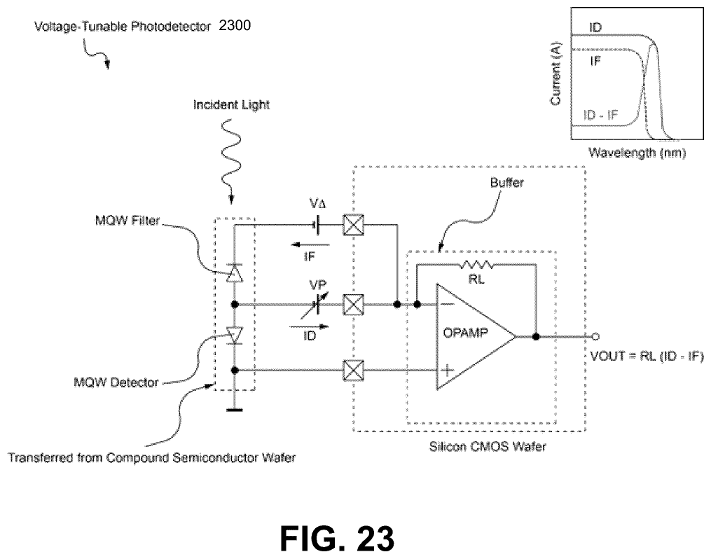

FIG. 23 depicts an example voltage-tunable photodetector system. A tunable photodetector system 2300 includes multiple quantum well (MQW) materials integrated monolithically on a substrate. A first MQW layer acts as a filter and a second MQW layer functions as a detector, allowing for tunable wavelength detection within a defined visible light range.

A dual biasing system, comprising a fixed voltage bias VA and a variable voltage bias VP, enables selective wavelength detection, with the fixed bias enhancing wavelength specificity by absorbing surrounding wavelengths and the variable bias enabling fine-tuning of the target wavelength.

Two-dimensional array formation arranges multiple photodetectors in a two-dimensional array, enabling high-resolution imaging and advanced optical sensing applications.

A tunable integrated photodetector accurately detects specific wavelengths within a defined range. Various examples integrate multiple quantum well (MQW) materials, allowing both filtering and detection within a single, compact structure. A dual biasing system that includes a fixed and a variable bias provides precise control over the wavelength selection, ensuring unparalleled accuracy and adaptability.

The fabrication of the photodetector begins on an n-doped GaN substrate using GaN-source MOCVD epitaxy, which is well-suited for constructing devices that operate within the visible spectral range. The process starts with the formation of a 500 nm n-doped GaN layer on the substrate, serving as the foundation for the device. Next, the multiple quantum well (MQW) detector is created by depositing 10 undoped periods of 5 nm InGaN wells and 10 nm GaN barriers, optimizing it for visible light detection. These MQW detector layers are then clad with 20 nm GaN spacers on both sides to ensure proper confinement. A 800 nm p-doped GaN layer is deposited on top, followed by the formation of the MQW filter, which comprises 7 undoped periods of 5 nm InGaN wells and 10 nm GaN barriers, similarly clad with 20 nm undoped GaN spacers. This configuration can achieve precise red shifts in response to applied voltages. For example, a 600 nm n-doped GaN layer and a 5 nm n+ doped In_{0.05}Ga_{0.95}N cap layer can complete the structure. By using fewer periods in the MQW filter than in the detector, this design ensures efficient tunability within the visible range, allowing controlled wavelength detection by adjusting the variable bias VP.

The fixed voltage source VS, which supplies the fixed voltage bias VA, could be replaced with a variable voltage source, allowing for more flexibility. A consistent fixed bias between the filter and detector can ensure that wavelength tuning is achieved without disrupting this relative balance. This fixed relationship is pivotal for ensuring reliable and precise tuning, highlighting the robustness of the original photodetector design over more complex configurations.

Various examples include a photodetector system comprising multiple quantum well (MQW) materials integrated monolithically on a substrate, wherein a first MQW layer acts as a filter, and a second MQW layer functions as a detector, allowing for tunable wavelength detection within a defined visible light range.

Various examples include a dual biasing system, comprising a fixed voltage bias VA and a variable voltage bias VP, that enables selective wavelength detection, with the fixed bias enhancing wavelength specificity by absorbing surrounding wavelengths and the variable bias enabling fine-tuning of the target wavelength.

Various examples include a multiple photodetectors are arranged in a two-dimensional array, enabling high-resolution imaging and advanced optical sensing applications.

Various examples include a fixed external filter for enhancing selectivity by excluding wavelengths outside the tunable range of the photodetector.

### Wavelength Selective Heterojunction Phototransistor

Various examples include a wavelength-selective heterojunction phototransistor for polychromatic image sensors for detecting a broad range of wavelengths. This photodetector leverages a multi-layered semiconductor structure, including materials like InP and InGaAsP, enabling selective detection in the infrared spectrum (1200-1500 nm). The image sensor includes a window layer, a filter layer, and an emitter, base, and collector configuration, where the energy gaps are precisely engineered to allow wavelength selectivity. Examples include a co-planar cathode-anode contact architecture, facilitating efficient flip-chip bonding to a readout integrated circuit (IC), which integrates the phototransistor into broader imaging systems. The device can be manufactured using metal-organic chemical vapor deposition (MOCVD) epitaxy, for accurate compositional grading and high-quality layer formation. This process allows for fabricating detectors ranging from 5 to 100 micrometers in diameter, enabling scalability across different applications.

The phototransistor is designed for low-voltage operation, utilizing the built-in electric field between the base and emitter layers, which enhances both speed and sensitivity. External metasurface filters may not be used, potentially reducing size and improving energy efficiency. An internal gain mechanism can provide a strong response to weak light signals, making it suitable for applications such as high-speed optical communications, advanced driver assistance systems (ADAS), and multispectral imaging in medical diagnostics.

Traditional photodetectors also lacked adaptability for high-yield, heterogeneous integration of microscopic, multi-wavelength sensitive detectors, for creating high-resolution, low-power polychromatic image sensors. By enabling efficient, low-bias operation and seamless multi-wavelength integration, various examples support advanced imaging requirements.

Various examples include a microscopic photodetector (MPD) structure enabling the creation of polychromatic image sensors. By utilizing different material systems, the MPD can target specific light ranges: GaN—InGaN for visible light (400-700 nm), InP—InGaAs for infrared light (1200-1500 nm), and AlGaN—GaN for ultraviolet light (250-350 nm). The co-planar cathode-anode contact architecture allows these diverse MPDs to be integrated onto a common readout integrated circuit (IC) for simultaneous detection of multiple light spectra, facilitating the manufacture of a single, versatile polychromatic image sensor.

The MPD can include multiple layers: a substrate (such as sapphire or silicon), buffer layers, a window layer (wide bandgap layer that is transparent to the incident light) with energy gap Egw, a filter layer with energy gap Egf, an emitter layer (e.g., heavily doped n-type semiconductor with energy gap Ege>Egf), a p-type base layer with energy gap Egb, and an n-type collector layer with energy gap Egc=Egb. The following condition provides wavelength selectivity: Egw>Ege>Egf>Egb. The selected and detected wavelength peaks can be ˜1240/Egb (nanometers).

Microscopic photodetector (MPD) can be fabricated using metal-organic chemical vapor deposition (MOCVD) epitaxy. This process allows for precise control of the semiconductor's composition, achieved by adjusting the flow of the indium precursor. After the growth process, photolithographic and etching techniques can be used to define the device's structure, which typically ranges from 5 to 100 micrometers in diameter. Contact vias can be made to access the emitter and the collector layers, and metal bumps (pads) can be patterned to facilitate flip chip bonding of the MPD to a readout CMOS integrated circuit to make the polychromatic imager.

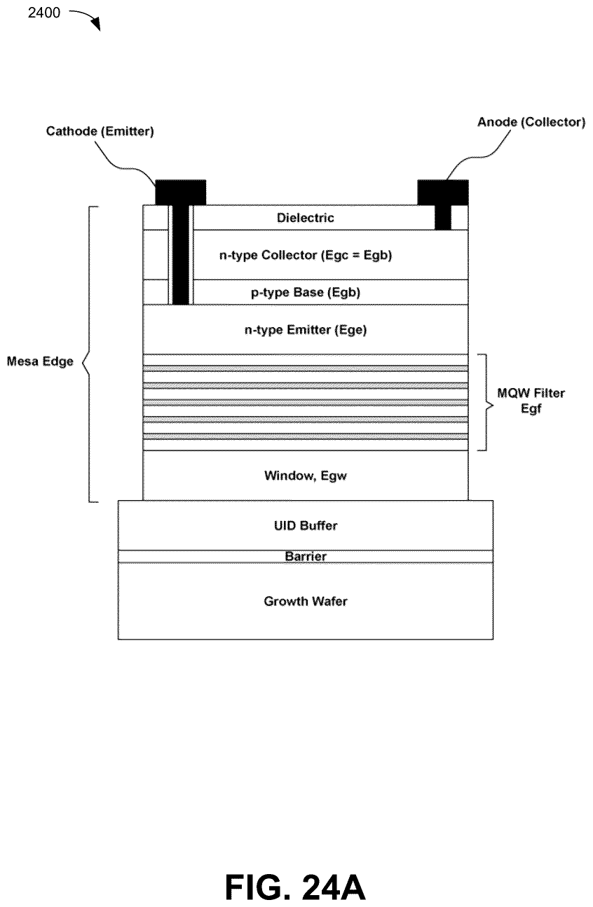

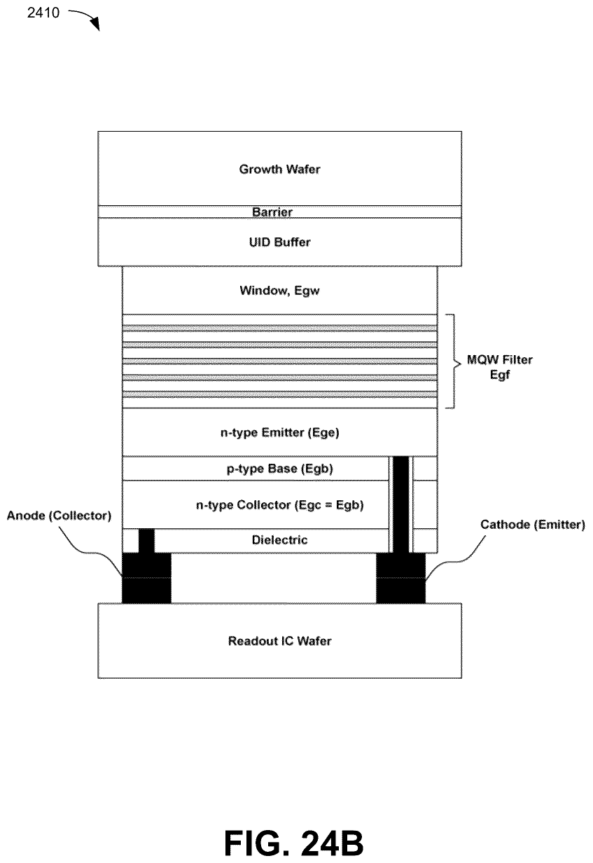

FIG. 24A depicts an example a cross section of a photodetector 2400. Different material systems may be used to target different wavelengths. A co-planar anode and cathode contact structure will facilitate flip-chip bonding to a readout IC wafer to make a polychromatic image sensor.

FIG. 24B depicts an example structure 2410 after flip-chip bonding the device to the readout IC wafer. Lights can be received through window through multi quantum well (MQW) layer. The window and emitter layers are made of InP. All other layers are made of InGaAsP.

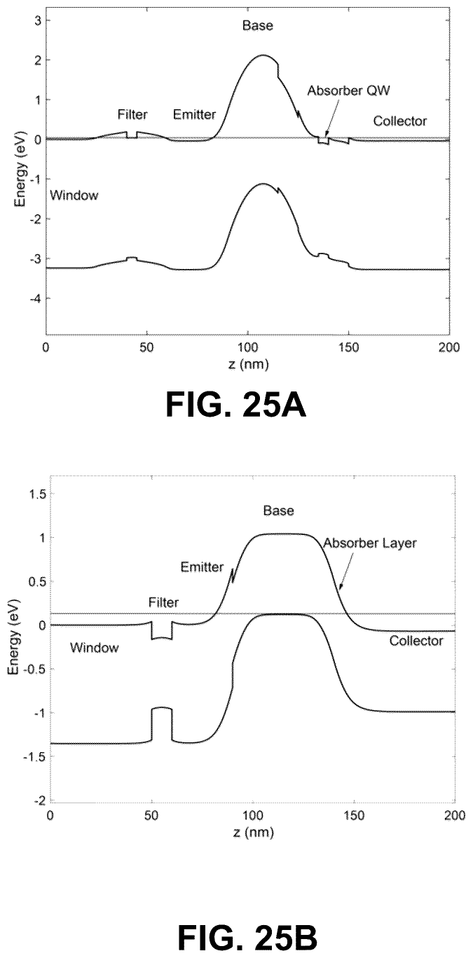

FIG. 25A depicts example energy band diagram (to scale) for GaN/InGaN material system. An incident light through the window (from left-hand side) gets filtered (shorter wavelengths) by the filter quantum well (QW) (e.g., Indium Mole Fraction ˜10%), and goes through the emitter and base, and gets absorbed in the absorber QW (e.g., InGaN with indium mole fraction of 20%). Electron-Hole pairs created in the collector/absorber layer get swept in different directions by the built-in electric field. For example, electrons drift to the collector and holes drift to the base. Because of the barrier to holes between the emitter and base, holes are stored in the base, causing the barrier height to electrons in the emitter to be lowered so that electrons from the emitter are injected towards the collector, causing large current in response to the incident photons.

FIG. 25B depicts an example energy band diagram for InP/InGaAsP material system. An incident light through the window (from left-hand side) gets filtered (shorter wavelengths) by the filter QW, and goes through the emitter and base, and gets absorbed in the absorber layer. Electron-Hole pairs created in the collector/absorber layer get swept in different directions by the built-in electric field whereby electrons drift to the collector and holes drift to the base. Because of the barrier to holes between the emitter and base, holes are stored in the base, causing the barrier height to electrons in the emitter to be lowered so that electrons from the emitter are injected towards the collector, causing large current in response to the incident photons.

Various examples of a photodetector device can provide amenity to integration of heterojunction phototransistors (HPTs) made with different materials to make a polychromatic image sensor, low voltage operation that allows for use of low reverse bias without compromising detectivity or speed, wavelength selectivity without having to use metasurface filters, precise compositional grading for fabrication of high-performance devices with controlled material properties, and device fabrication in a range of sizes, from 5 to 100 micrometers in diameter.

Various examples include a wavelength-selective heterojunction phototransistor comprising: a multi-layered structure including an emitter, base, and collector, wherein the layers are composed of III-N or III-V materials; a window layer with an energy gap greater than that of the emitter layer, configured to transmit incident light to underlying layers; a filter layer having an energy gap lower than the emitter layer, positioned between the window and base layers; a co-planar anode and cathode contact configuration to facilitate flip-chip bonding with a readout integrated circuit (IC). The device can perform selective detection of wavelengths based on the energy gaps of the layers, enabling detection across infrared, visible, or ultraviolet spectra.

In some examples, the filter layer is composed of InGaAsP, with a composition adjusted to filter out shorter wavelengths, allowing the phototransistor to detect infrared light in the 1200-1500 nm range. In some examples, wherein the device is capable of low-voltage operation due to a built-in electric field generated between the base and emitter layers. In some examples, the co-planar anode and cathode contacts are configured to reduce parasitic capacitance, thereby improving the response time of the phototransistor. In some examples, the base layer is p-type and the emitter layer is heavily doped n-type, with a barrier height adjusted to optimize electron injection into the collector.

Some examples include a method for manufacturing a wavelength-selective heterojunction phototransistor comprising: growing a semiconductor structure using metal-organic chemical vapor deposition (MOCVD) epitaxy to form a multi-layered photodetector; forming a window layer and a filter layer with controlled energy gaps to achieve wavelength selectivity; and patterning metal contacts for co-planar anode and cathode access and integrating with a readout IC using flip-chip bonding. In some examples, adjusting the flow of indium precursor during MOCVD growth to achieve a graded composition across the InGaAsP layers for enhanced detection efficiency.

Some examples include a polychromatic image sensor comprising a plurality of wavelength-selective heterojunction phototransistors as described in claim 1, wherein each phototransistor is tuned to detect a different wavelength range, enabling multispectral imaging.

Some examples include a wavelength-selective photodetector assembly comprising: a first phototransistor configured for detection of infrared wavelengths using an InP/InGaAsP material system; a second phototransistor configured for detection of visible wavelengths using a GaN/InGaN material system; a third phototransistor configured for ultraviolet detection using an AlGaN/GaN material system, each being integrated onto a common readout IC via flip-chip bonding. In some examples, the phototransistor is part of an advanced driver-assistance system (ADAS) for vehicles, providing real-time detection and imaging of objects based on their spectral signatures.

Some examples include a method for integrating wavelength-selective photodetectors into a medical diagnostic tool, comprising: incorporating the phototransistor into a sensor array and using the sensor array to capture spectral data from tissue samples across multiple wavelengths for non-invasive diagnostic imaging.

Zero-Voltage Npin Microscopic Photodetector with Graded Indium Mole Fraction

Some photodetectors rely on silicon-based P-N, P-I-N, or avalanche photodiode structures to detect visible light, typically incorporating organic or inorganic filters for specific wavelengths (e.g., red, green, blue). Silicon material properties constrain these detectors to visible wavelengths, restricting broader applications.

Various examples provide low-power consuming polychromatic image sensors with heterogeneous integration of microscopic and multi-wavelength sensitive detectors. By enabling efficient, low-bias operation and seamless multi-wavelength integration, image sensors can provide for high detectivity and energy efficiency.

A photodetector structure utilizes a graded bandgap that achieves detection, even at zero or near-zero bias, for rapid detection applications. Operating at a slight reverse bias, the structure gains enhanced detectivity, allowing high sensitivity with minimal energy consumption. The structure can include an n-type semiconductor cathode, a p-type barrier, an undoped absorber layer, and an n-type anode. In some examples, GaN is used for all layers except the absorber, where InGaN features a variable indium mole fraction, shifting from 0.0 at the barrier interface to 0.4 at the anode. This gradient produces a graded bandgap and an internal electric field, allowing zero-bias operation without sacrificing speed or sensitivity. The InGaN active layer ensures a steady response across a broad wavelength range of 400 nm to 600 nm. Photodetector diameters under 20 μm can prevent barrier layer p-type dopant deactivation during cathode layer growth, preserving functionality. Integrating a metasurface filter atop the anode layer further enables precise wavelength filtering by adjusting meta-atom properties, offering exceptional flexibility for tuning specific detection needs. This design maximizes performance while enabling selective and energy-efficient wavelength detection.

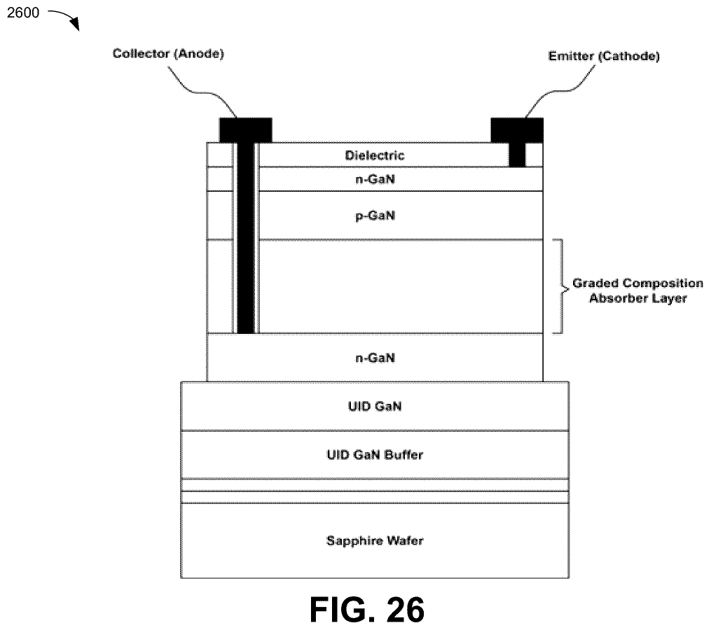

FIG. 26 depicts an example cross section of a microscopic photodetector (MPD) 2600 after growth on the sapphire wafer and after the formation of co-planar contacts for the emitter (cathode) and collector (anode).

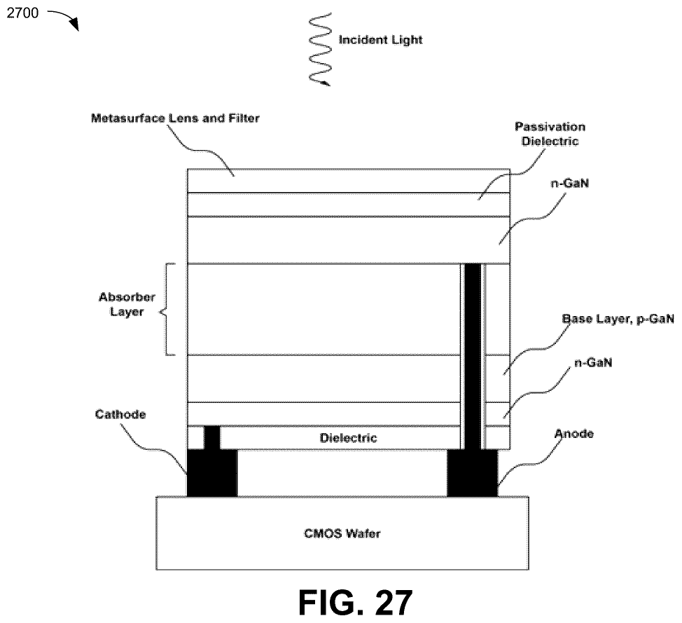

FIG. 27 depicts a cross section of the microscopic photodetector (MPD) 2700 after getting transferred from the growth compound semiconductor wafer to a CMOS readout circuitry wafer. A metasurface filter and lens is added on the light-receiving surface to provide wavelength selectivity. A grade composition absorber layer (no doping) grown on top of n-GaN creates internal field (eV different or slope between P and N type materials) with no bias and photodetection occurs.

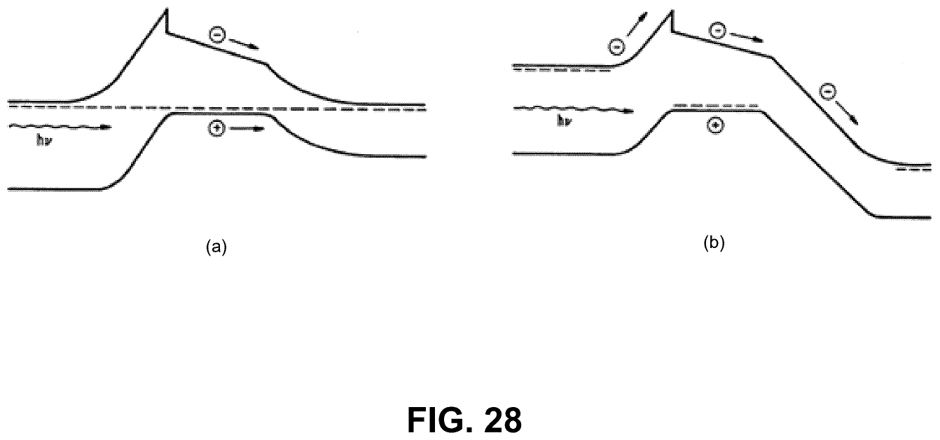

FIG. 28 depicts an example energy band diagram that illustrates how the photodetection process works at zero bias and reverse bias, helping to clarify carrier dynamics in the structure. Diagram (a) is under zero bias, and diagram (b) is under reverse bias. The photodetection process in an n-p-n structure involves a graded composition absorber layer that is doped with p-type dopants, such as Mg for GaN. The emitter layer is made of n-type GaN, while the absorber layer consists of an Inₓ Ga₁₋ₓ N layer where the indium composition increases from x=0 to x=0.3, moving from the emitter to the collector. The collector can be constructed using n-type GaN or n-type Inₓ Ga₁₋ₓ N with an indium mole fraction “x” of around 0.1. The p-type absorber layer may have a doping concentration of 10¹⁸ cm⁻³, while the emitter and collector regions could be doped to 10²⁰ cm⁻³. The absorber layer's thickness can range between 50 nm and 500 nm.

When light, represented by the energy quantum hv, is incident on the wide-bandgap collector of the device, it passes through the collector and enters the composition-graded absorber layer. In this region, the energy from the light is absorbed, generating electron-hole pairs within the photosensitive graded bandgap area. The presence of a quasi-electric field in this region, created by the graded bandgap, propels the electron-hole pairs toward the collector, with an ambipolar drift velocity driving their motion. The time it takes for these carriers to travel toward the absorption/collector junction is determined by both the drift velocity and the thickness of the absorber layer. At the junction, the built-in electric potential barrier ensures that holes are prevented from entering the collector, while electrons are injected into the collector region. As holes accumulate near the absorber/collector junction, a time-dependent photovoltage is generated. This photovoltage is divided between the emitter/absorption junction, the absorption/collector junction, and the external load resistor. As a result of the lowered energy barrier at the emitter/absorber junction, electrons flow from the emitter into the collector, and the device exhibits photo-electronic behavior. The photo-electrons move from the collector through the external circuit until the electron quasi-Fermi levels on either side of the absorption region reach equilibrium. During this process, the capacitances of both the emitter/absorption and absorption/collector junctions charge rapidly, with the charging process occurring within an RC time constant of about 0.5 picoseconds (ps), assuming a resistance of 50 Ohms and a capacitance of 10 femtofarads (fF). The transit time across the base region, measured at approximately 0.25 ps, further contributes to the device's fast response.

When the incident light pulse is switched off, the device returns to its equilibrium state. This is primarily driven by the thermionic emission of holes, which overcome the lowered barriers at the emitter/absorption and absorption/collector junctions, eventually recombining with electrons in the collector and emitter regions. The discharge process is also fast, particularly under high incident power levels, as the large reduction in junction barriers accelerates recombination. However, at lower power levels, the return to equilibrium may take longer due to a smaller reduction in the junction barriers, potentially leading to a longer tail in the device's response.

The ultrahigh-speed operation of the device, on a timescale of picoseconds, is largely attributable to the graded bandgap design. This configuration allows most of the incident light to be absorbed in the heavily doped graded region, where the quasi-electric field enhances carrier drift. Without the graded bandgap, the device could instead rely on slower diffusion processes, which would significantly increase response times. For example, in a base region with a thickness of 500 nanometers (nm) and a diffusion coefficient of 25 cm²/s, the diffusion time would be approximately 100 ps, far slower than the drift process enabled by the graded bandgap.

When the device is reverse-biased, the device operates similarly to a phototransistor, exhibiting increased sensitivity while maintaining fast response times. In this configuration, the absorption regions function as base regions. The effective charging time, calculated as (kT/le) (Cbe+Cbc), becomes negligible at high power levels, allowing the device to maintain its rapid performance. At zero bias, the device's photodetector function is expected to produce symmetric rise and fall times with minimal tailing effects. For larger devices (100 μm×100 μm), the intrinsic response time is estimated to be around 20 ps, whereas for smaller devices (5 μm×5 μm), the response time could reach 0.3 ps due to the reduced capacitance, such as 6 fF. These ultrafast response times are achievable with incident laser powers in the range of 0.1 to 1.0 watts (W) for the larger devices, while smaller devices may require around 250 microwatts (μW) to achieve the 0.3 ps response time. At lower incident powers, like 50 μW, the reduced barrier lowering at the junctions can result in a longer tail in the response.

Under reverse bias conditions, the base-collector junction operates as a phototransistor, significantly enhancing sensitivity. The rise time and the full width at half maximum (FWHM) of the pulse remain consistent across varying power levels, but the tail magnitude decreases as the power level decreases. While the initial response remains fast, the tail can extend over several hundred picoseconds at lower power levels. However, the FWHM remains independent of the incident power, meaning that as long as the tail falls below a detection threshold, it becomes negligible and does not interfere with measurements.

Accordingly, a graded bandgap design enables ultrahigh-speed detection with flat responsivity across a broad wavelength range. The device can achieve increased sensitivity and faster response times through reverse biasing and phototransistor action, making it suitable for applications that demand both speed and high sensitivity.

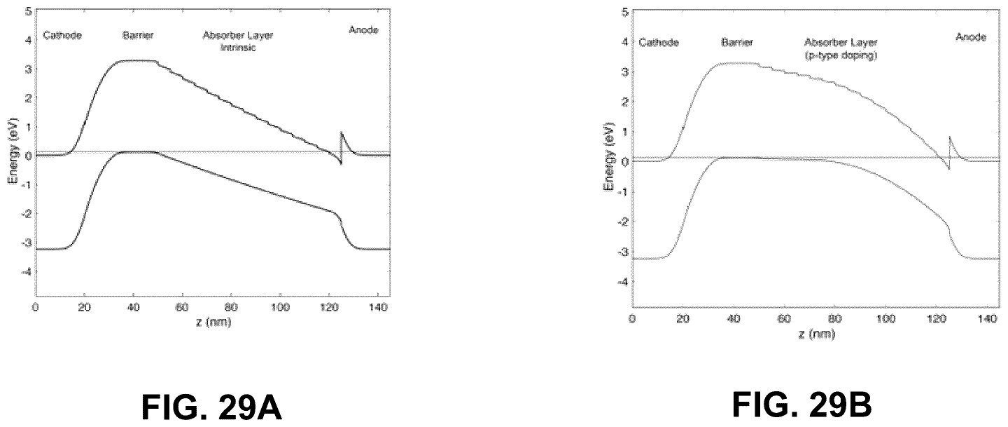

FIG. 29A depicts an example simulated energy band diagram of a photodetector based on GaN/InGaN material system with an applied bias=0, with intrinsic absorber layer with graded indium mole fraction from 0 to 0.4. Emitter, base, and collector can be constructed of GaN. The absorber layer can include graded InGaN. Doping of the p-type barrier region is 10¹⁹ cm⁻³.

FIG. 29B depicts an example simulated energy band diagram of a photodetector based on GaN/InGaN material system with an applied bias=0 and with p-type (10¹⁸ cm⁻³) absorber layer with graded indium mole fraction from 0 to 0.4. Emitter, base, and collector can be constructed of GaN. The absorber layer can include graded InGaN. Doping of the p-type barrier region is 10¹⁹ cm⁻³.

A microscopic photodetector (MPD) can be fabricated using metal-organic chemical vapor deposition (MOCVD) epitaxy. This process allows for precise control of the semiconductor's composition, achieved by adjusting the flow of the indium precursor. After the growth process, photolithographic and etching techniques are used to define the device's structure, which typically ranges from 5 to 20 micrometers in diameter. The structure includes multiple layers: a substrate (such as sapphire or silicon), buffer layers, an anode n-GaN layer, a graded composition absorption region made of un-doped InGaN, a p-type barrier layer, and an n-type anode layer.

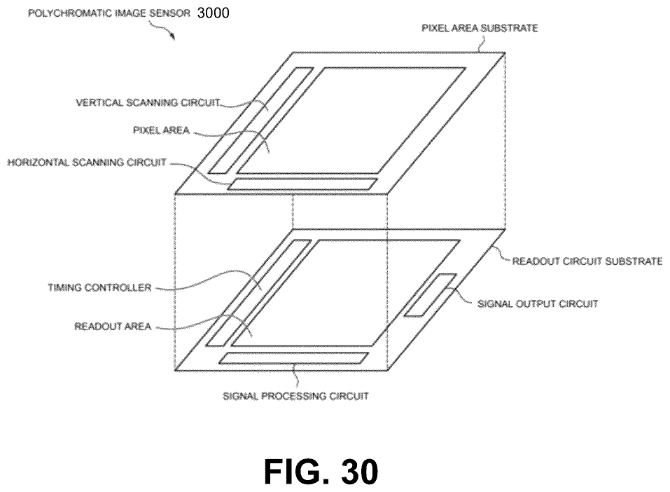

FIG. 30 depicts a schematic illustration of envisioned polychromatic image sensor 3000 that includes two layers: a sensors layer and a readout integrated circuit (ROIC) layer. The sensors layer comprises a 2D array of pixels, each containing multiple subpixels with microscopic photodetectors (MPDs) sensitive to specific wavelengths. The ROIC layer incorporates advanced low-power, high-performance CMOS-based circuitry, manufactured on 300 mm silicon wafers to leverage economies of scale and advanced functionality at low power. This design aims to optimize performance and efficiency, making it suitable for a wide range of applications.

Manufacturing the sensors layer can include transfer-printing MPDs, each tuned to different wavelengths, from their growth wafers of varying materials and sizes onto the ROIC layer. This process utilizes flip-chip and hybrid bonding technologies, similar to those used in MicroLED display production, to achieve precise integration.

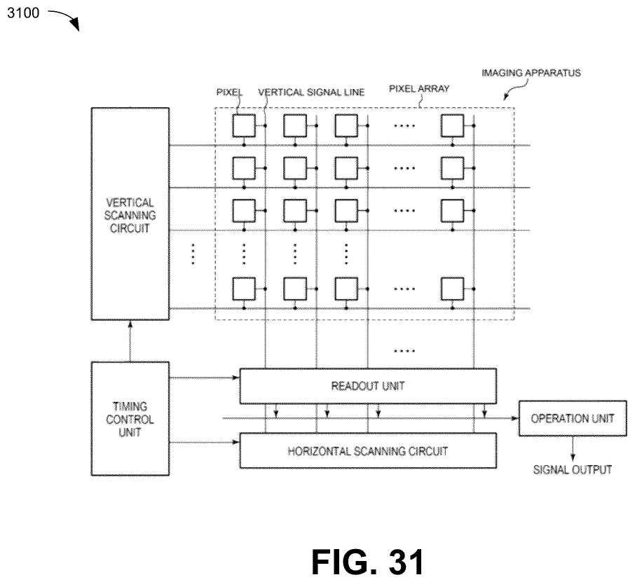

FIG. 31 depicts a top view schematic of the sensors layer. The sensors layer 3100 can include a 2D pixel array interconnected with vertical and horizontal scanning circuits, a readout unit, and a timing control unit, controlled by an operation unit. A pixel includes multiple subpixels, each equipped with microscopic photodetectors (MPDs) that detect specific wavelengths, such as UV, visible, or infrared light. Redundant MPDs ensure fault tolerance for consistent performance. The vertical signal lines are aligned column-wise, connecting directly to each subpixel, allowing precise signal output and data transmission.

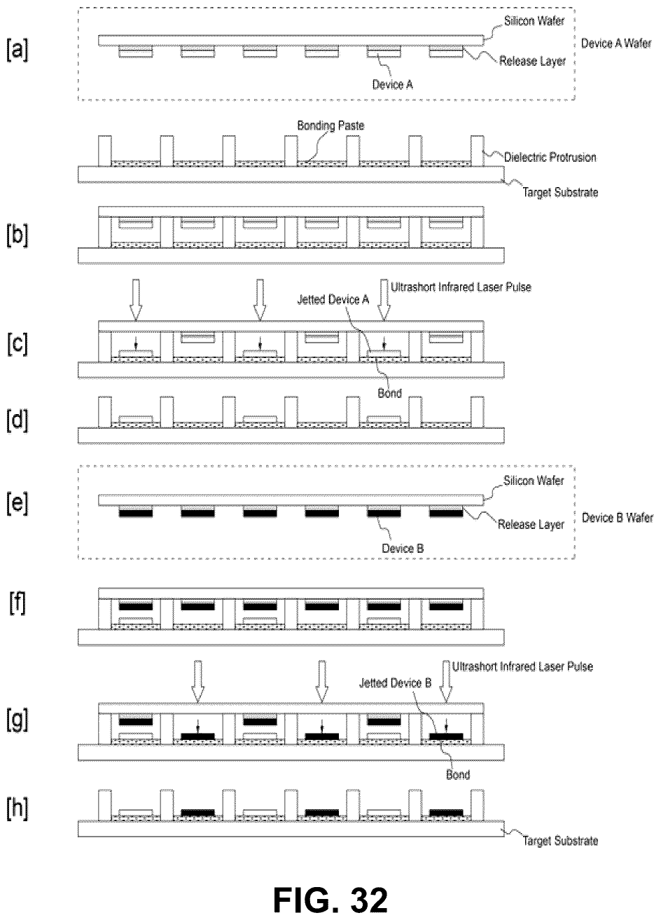

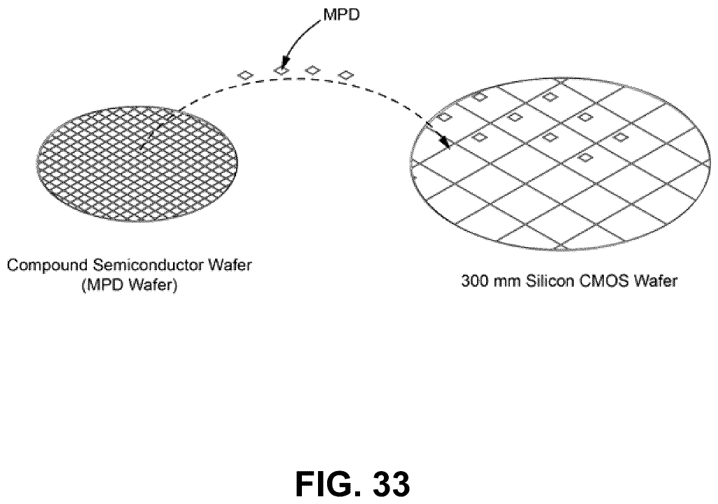

FIG. 32 depicts an example process flow illustrating the transfer to two types of devices (Device A and Device B) from two different growth wafers to a single target substrate. Device A could be an MPD tuned for visible light and Device B could be an MPD tuned for infrared light. FIG. 33 depicts transfer-printing of MPDs from growth wafer to a CMOS wafer.

### Stacked Multiple Wavelength Microscopic Photodetector

Photodetection systems that use separate photodetectors and external filters to achieve wavelength selectivity can involve multiple components, such as optical filters, that are placed in front of the photodetector to isolate the desired wavelength. Modularity and reliance on external components make them bulky and unable to offer the fine-tuned control.

Various examples provide for a photodetector that integrates multiple photodetection layers (PDLs) within a stacked, compact structure, that detects multiple light wavelengths. This detector can be used for a visible spectral range, within infrared spectral range, or within UV spectral range. A PDL can operate as either a photodiode or a heterojunction phototransistor and can absorb light at a specific target wavelength.

Fabrication of a photodetector can include growth of each PDL on a substrate such as sapphire or silicon, utilizing advanced epitaxial techniques like Metal-Organic Chemical Vapor Deposition (MOCVD). For each PDL, coplanar contacts serve as the anode and cathode, ensuring robust electrical connectivity. Sequentially, the PDLs can be transferred one by one onto a CMOS wafer, which has been pre-fabricated with the necessary detection circuitry and amplification systems. The PDL attuned to capture the longest wavelength can be transferred first, while the layer optimized for the shortest wavelength is transferred last, ensuring that each layer performs optimally without interference. A transparent insulating dielectric layer separates each PDL, maintaining optical clarity and providing essential electrical isolation. Contact vias are fabricated, allowing seamless access to the anode and cathode connections, ensuring efficient communication with the circuitries embedded in the CMOS wafer.

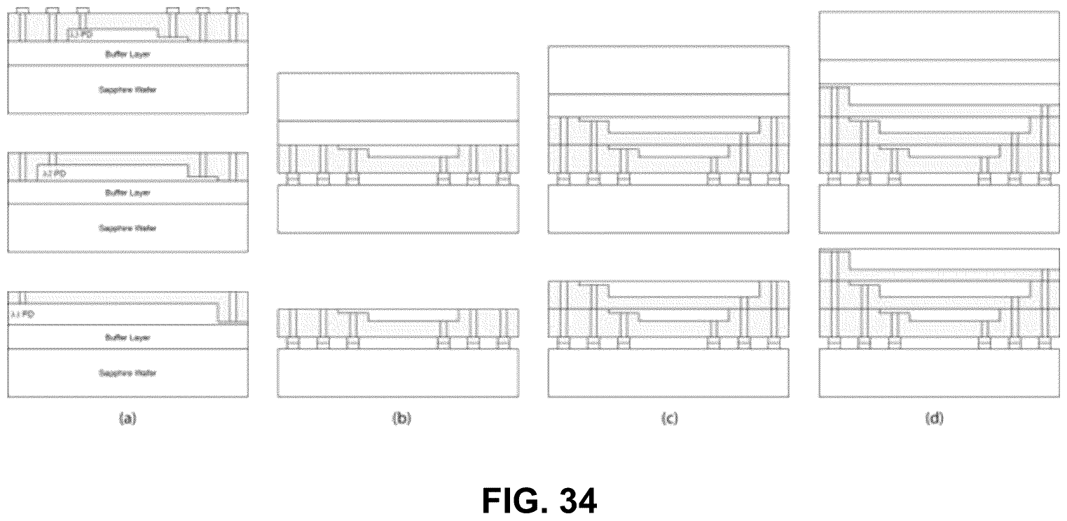

FIG. 34 depicts a cross section illustration of a process for making a proposed tri-color an energy-efficient Wavelength Division Multiplexing (WDM) photodetector for optical interconnects. The photodetector structures for different wavelengths are grown on separate wafers as shown in (a), and interconnect vias are also fabricated. In (b), the photodetector with the longest wavelength is flip-chip hybrid bonded to a CMOS wafer where the circuitries have been fabricated. In (c), the photodetector with the second longest wavelength is flip-chip hybrid bonded to the assembly produced in the bottom picture of (b). In (d), the photodetector with the smallest wavelength is flip-chip hybrid-bonded to the assembly produced in the bottom picture of (c). A passivation dielectric is added to the top of the structure shown in the bottom picture of (d).

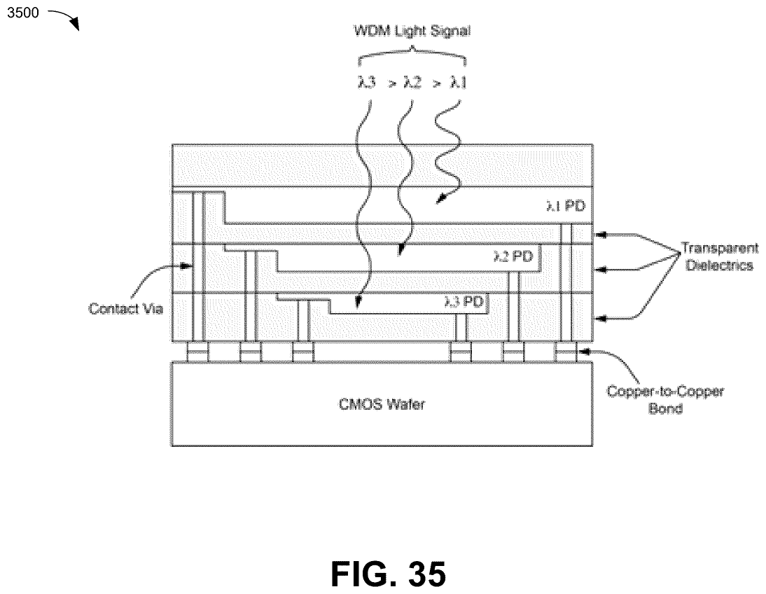

FIG. 35 depicts a cross section illustration of a tri-color, energy-efficient multiple wavelength photodetector 3500. Different photo detectors detect different colors but are not on same plane. Cathode and anode (contacts) can be coplanar.

Various examples include a stacked WDM photodetector arrangement with multiple photodetection layers (PDLs) integrated within a compact, stacked configuration. Each PDL can be designed to absorb a specific wavelength. PDLs can be sequentially stacked using techniques such as flip-chip hybrid bonding, starting with the PDL that captures the longest wavelength and ending with the one tuned for the shortest wavelength.

Various examples can include a stacked, compact multiple wavelength photodetector, comprising: multiple photodetection layers (PDLs), each designed to absorb a specific wavelength of light, stacked in a compact structure; coplanar electrical contacts for each PDL to form an anode and a cathode; and a transparent dielectric layer separating each PDL to provide electrical isolation and maintain optical clarity. The PDLs can be sequentially transferred to a CMOS wafer with integrated detection circuitry, wherein the PDL optimized for the longest wavelength is transferred first, followed by the PDL for the shortest wavelength. In some examples, the photodetection layers are composed of materials selected from InGaN for visible light detection and InGaAs for near-infrared light detection. In some examples, the dielectric layer is composed of silicon dioxide (SiO₂) to provide both electrical isolation and optical clarity.

Various examples include a method of manufacturing a stacked WDM photodetector, comprising: growing photodetection layers on substrates using epitaxial techniques; sequentially transferring the photodetection layers onto a CMOS wafer via flip-chip hybrid bonding; utilizing a transparent dielectric material to separate the photodetection layers; and forming electrical connections between the CMOS wafer and the photodetection layers through contact vias. In some examples, the photodetection layers are sequentially bonded to the CMOS wafer starting with the layer optimized for the longest wavelength and ending with the layer optimized for the shortest wavelength.

Polychromatic Image Sensor with Heterojunction NIPIN Photodetector with High Gain

Various examples include an image sensor that includes a two-dimensional array of heterojunction NIPIN photodetectors with a responsivity of 1-100 A/W, in the visible wavelength range (400 nm-700 nm). A microscopic heterostructure NIPIN photodetector (MPD) utilizes a GaN material system to provide photodetectors that achieve pixel diameters smaller than 10 μm while maintaining high sensitivity, making them particularly effective for low-light applications, offering enhanced performance in compact and precise detection systems. While the material system used here is based on GaN, InGaN, and AlGaN can be used. By replacing GaN with GaAs, InGaN with InGaAs, and AlGaN with AlGaAs, a photodetector can be configured to detect infrared light. Additionally, for ultraviolet light detection, GaN can be replaced by Al_{y}Ga_{1-y}N, InGaN by GaN, and AlGaN by AlₓGa₁₋ₓN (with x>y). This flexibility in material substitution allows the structure to be tailored for various wavelength detection needs across different spectral regions.

Various examples include a method for manufacturing microscopic photodetectors (MPDs) using metal-organic chemical vapor deposition (MOCVD) epitaxy technology. Flip-chip hybrid bonding can be used to transfer the MPDs to a Readout CMOS circuit to maximize quantum efficiency and to improve yield.

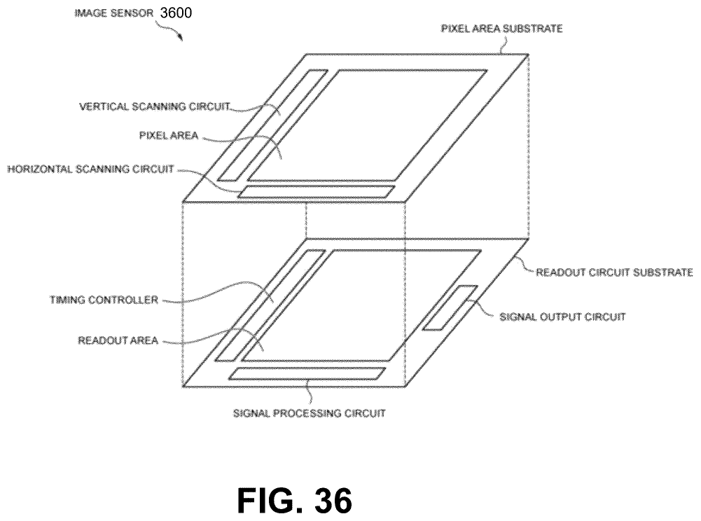

FIG. 36 depicts a vertically disaggregated image sensor architecture 3600 that can utilize optical transmitters or receivers described herein.

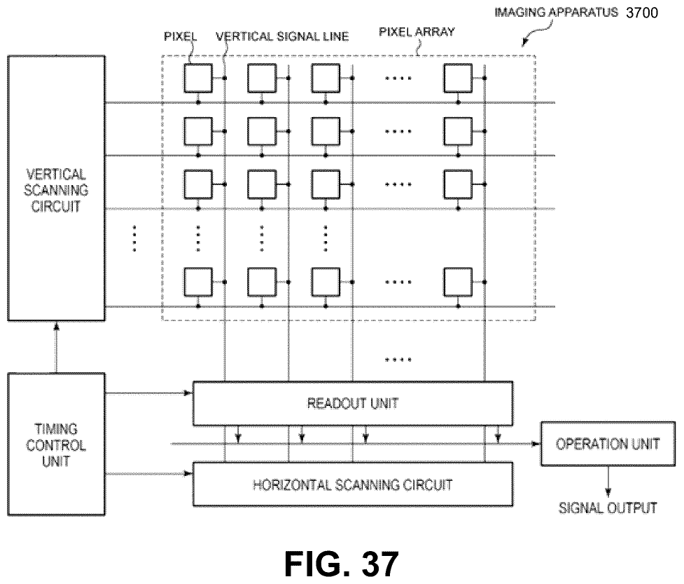

FIG. 37 depicts an image sensor. The image sensor 3700 includes a pixel array, a vertical scanning circuit, a readout unit, a horizontal scanning circuit, a timing control unit, and an operation unit. The pixel array can include a plurality of pixels arranged in a matrix. Each of vertical signal lines provided on a column basis is connected to each of the pixels as a wiring for outputting a signal.

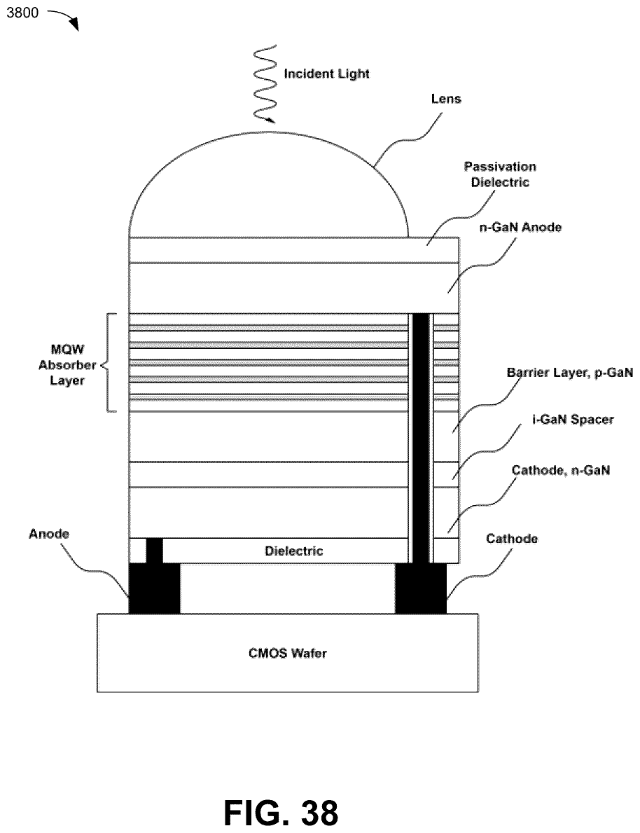

FIG. 38 depicts a cross section of a heterostructure NIPIN photodetector or microscopic photodetector (MPD) 3800 after being transferred from its growth substrate onto the readout CMOS circuit that has been fabricated on a CMOS wafer. A lens may be replaced by a metasurface lens and filter to detect a specific wavelength. The structure utilizes microscopic heterostructure NIPIN based on the GaN material system. The MPD can achieve pixel diameters smaller than 10 μm while maintaining high sensitivity, and utilized for compact, high-density sensor arrays. The MPD structure can achieve responsivity of 1-100 A/W, which is 10 to 100 times higher than traditional silicon-based photodetectors in the visible spectrum. This higher responsivity translates directly into improved signal-to-noise ratios (SNR), especially in low lighting conditions. As a result, the imager can detect finer details and subtle variations between neighboring pixels, enhancing spatial resolution and ensuring the clear capture of object features. This makes it particularly useful for applications like facial recognition in laptops or smartphones, where accuracy and reliability in user identification are paramount.

GaN, InGaN, and AlGaN material system can be adapted for different wavelength detection. By substituting these materials with GaAs, InGaAs, and AlGaAs, the structure can detect infrared light, expanding its use beyond visible light applications. Similarly, for ultraviolet light detection, GaN can be replaced by AlyGa1-yN, InGaN by GaN, and AlGaN by AlxGa1-xN. This adaptability makes the imager a versatile solution for a wide range of applications, from consumer devices to industrial automation and even medical diagnostics.

Moreover, the imager's high bandwidth, reaching GHz levels, offers another benefit, particularly for high-speed imaging and communication. By contrast to conventional silicon-based photodetectors, which typically operate at lower bandwidths of 10-100 MHZ, the MPD supports faster data processing and real-time imaging, a critical feature for applications such as autonomous driving, where rapid response times are essential.

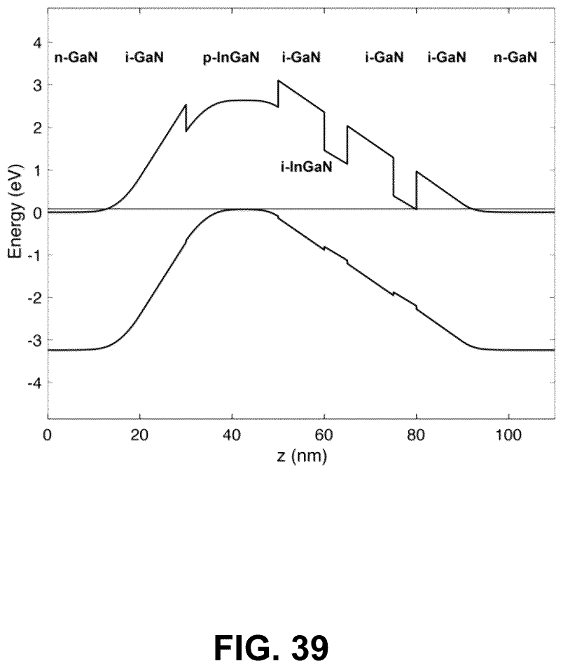

FIG. 39 depicts an energy band diagram of a heterojunction NIPIN photodetector showing a multiple quantum well absorber layer. The doping in the barrier layer is 10¹⁹ cm⁻³. This results in large barrier under dark condition and therefore very small dark current. This is a trade off with the minimal detectable light power. For the detector to be sensitive to lower light powers, the barrier may be reduced by using smaller p-type doping in the barrier layer.

According to FIG. 39, the operation of a heterostructure NIPIN photodetector begins when light is incident on the absorber layer of the device, generating electron-hole pairs. This process initiates a photo response. The generated holes, being positively charged, are driven towards the p-type InGaN barrier layer. However, they encounter an energy barrier at the interface between the GaN cathode and the InGaN barrier, preventing them from easily passing through. As more holes accumulate at this interface, they effectively lower the energy barrier for electrons at the same cathode/barrier junction.

This reduction in the barrier height allows electrons in the cathode to move more freely towards the barrier, increasing the flow of electrons from the cathode to the anode. This flow of electrons results in a significant current increase, even if the incident light intensity is low.

The barrier to electrons can be lowered by using relatively lower doping in the p-type barrier layer to allow for even weaker light signals to induce current from cathode to anode, resulting in high gain even at low optical signal power. This phenomenon of enhanced current flow due to light absorption provides the large internal gain in the photodetector.

Responsivity of the MPD can range from 1 to 100 A/W. Responsivity refers to the ability of the photodetector to convert incident light into electrical current, and this high value that even small amounts of light can generate large electrical signals. The internal gain amplifies the initial photogenerated signal, allowing the device to detect even weak light sources with high accuracy and efficiency. This makes these MPDs particularly well-suited for applications that require high sensitivity, such as low-light imaging, where the ability to capture fine details under minimal illumination is critical.

### Manufacturing and Transfer of Mpds to Fabricate an Image Sensor

The process flow for fabricating microscopic heterojunction NIPIN photodetector begins with a sapphire wafer, commonly used as a substrate due to its stability and compatibility with the subsequent growth layers. To initiate the fabrication, an Aluminum Nitride (AlN) barrier layer is deposited on the sapphire wafer using methods such as hot sputtering or Metal Organic Chemical Vapor Deposition (MOCVD), with a thickness of up to 50 nm. This AlN layer acts as a buffer to reduce strain between the sapphire substrate and the following layers.

Next, an unintentionally doped (UID) GaN buffer layer is grown using MOCVD to a thickness of approximately 400 nm. This layer serves as a foundation for the epitaxial growth of the following layers, providing structural integrity and optimizing the crystalline quality of the GaN material system. After the buffer layer is in place, a heavily doped n+GaN anode layer is grown, also using MOCVD, with a thickness between 300 nm and 500 nm. This layer serves as the anode region in the final device structure.

A thin UID GaN quantum barrier (QB) layer, with a thickness of 10-15 nm, is then grown on top of the n+GaN anode. The next operation involves growing the first InGaN quantum well (QW), with a thickness of 4-6 nm. The indium mole fraction in the InGaN QW determines the cutoff wavelength for the detector, effectively tuning the photodetector's sensitivity to a specific wavelength range. A second UID GaN quantum barrier is grown on top of the QW to encapsulate it. This alternating process of growing quantum wells and quantum barriers is repeated between 2 to 100 times to form a multiple quantum well (MQW) absorption layer. This MQW stack is designed to absorb photons and generate electron-hole pairs (EHPs) upon light exposure, which is critical for the device's photodetection function.

Once the MQW absorption layer is complete, a p-type InGaN barrier layer, with a thickness of 10-50 nm, is grown. The indium content in this barrier layer ranges from 3% to 10%, and it plays a crucial role in modulating the energy barrier between the cathode and barrier layers. Following this, an UID GaN spacer (i-layer) layer, with a thickness of 10-100 nm, is grown. Next, an n+ GaN cathode is grown to complete the main structure of the heterostructure photodetector.

An insulating dielectric layer is then deposited on the surface of the n+GaN cathode. This dielectric layer is patterned to form contacts to both the anode and cathode regions, allowing for electrical interfacing.

The next operation involves etching the structure into mesas with specific dimensions. These mesas can take various shapes, including squares with a shoreline of 10 μm, rectangles with dimensions of 10 μm×8 μm, circles with diameters of 10 μm, or ellipses with axes of 13 μm and 7 μm, for example.

After the mesa etching, metal bumps are fabricated on both the anode and cathode terminals. These bumps facilitate flip-chip hybrid bonding, a technique used to transfer the microscopic MPDs onto corresponding pads on the readout circuitry, which is often based on CMOS technology. Once the transfer is complete, the sapphire wafer is removed using techniques well established in the field. Finally, microscopic lenses or metasurface lenses and filters can be patterned on each MPD to selectively focus and filter incoming light, optimizing the device's sensitivity to specific wavelengths. This sophisticated fabrication process results in high-performance MPDs suitable for various applications requiring precise light detection.

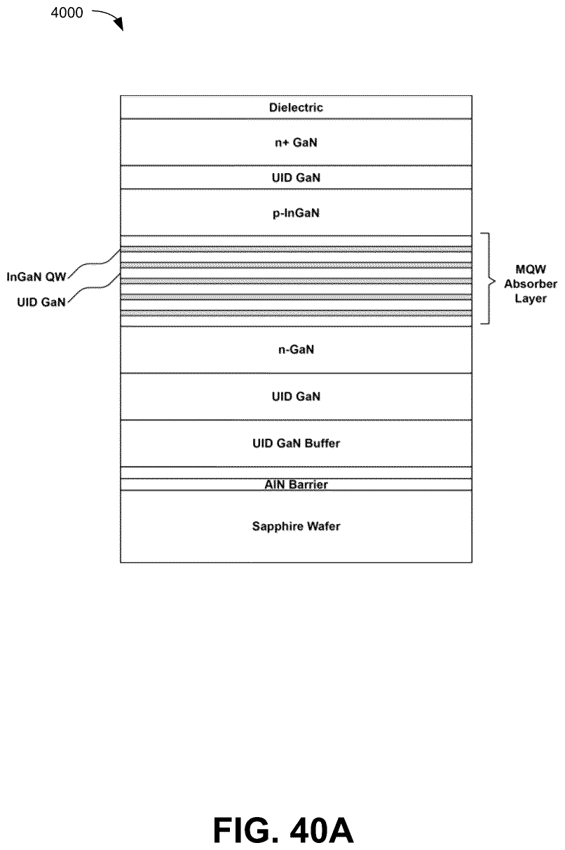

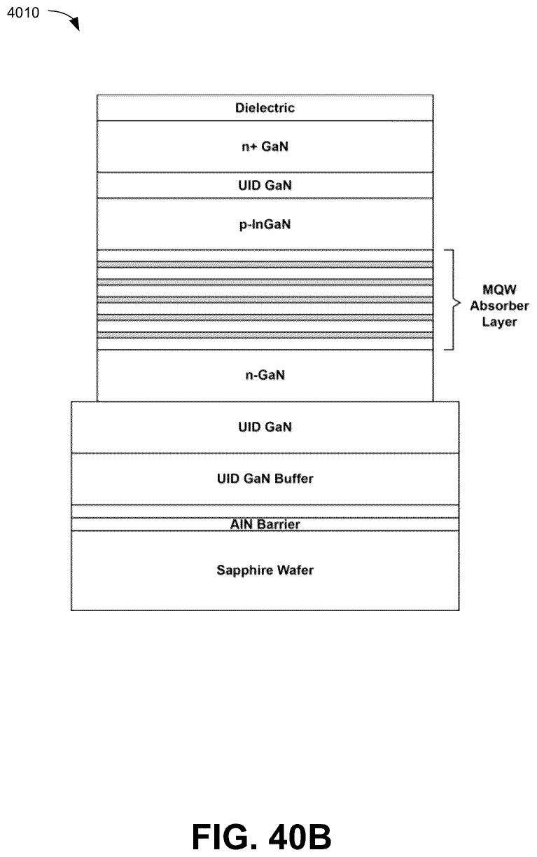

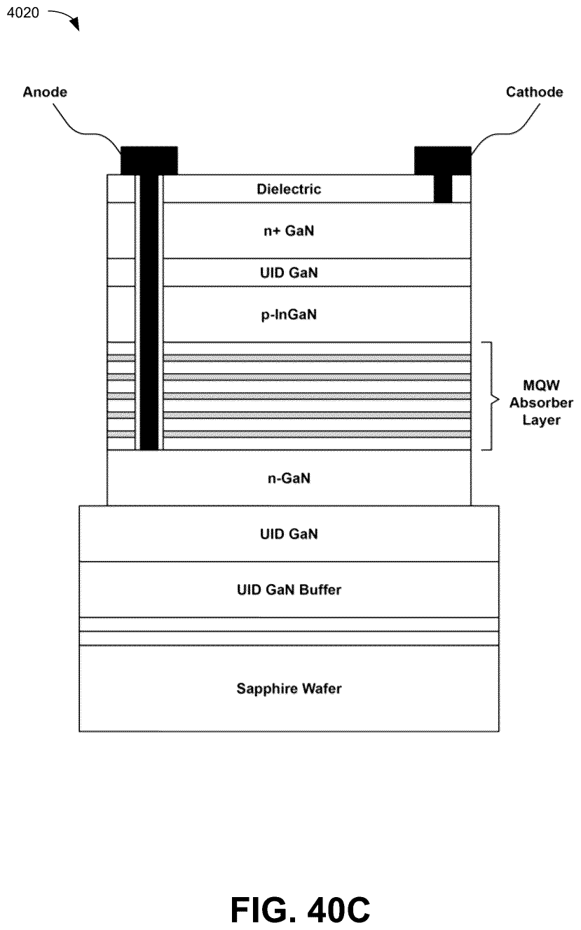

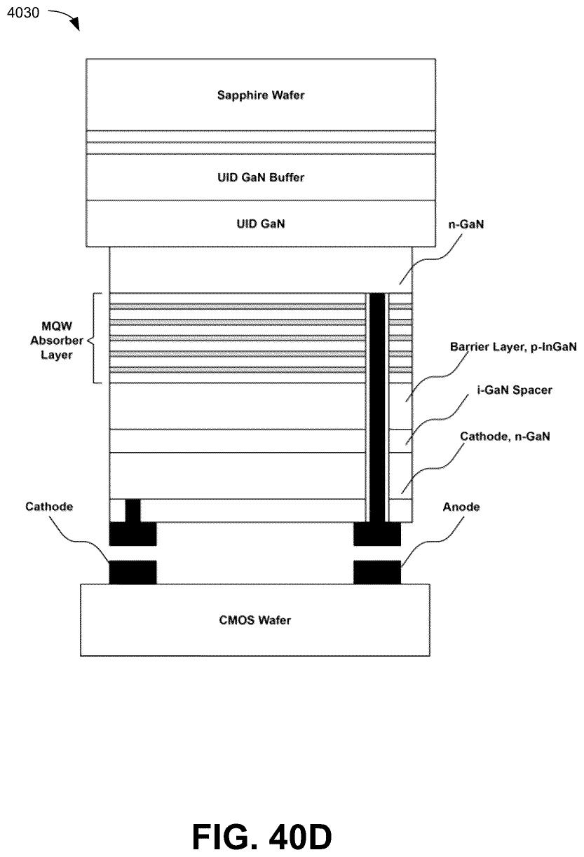

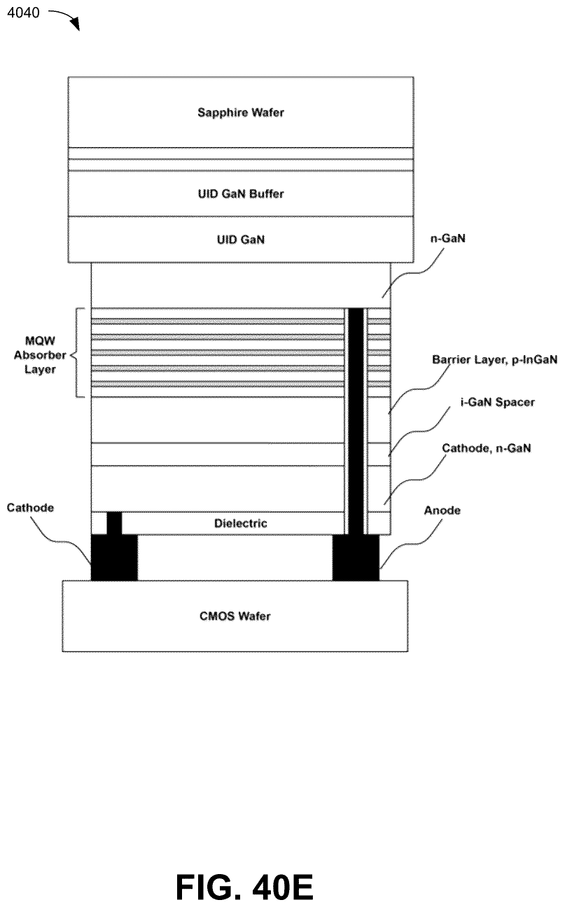

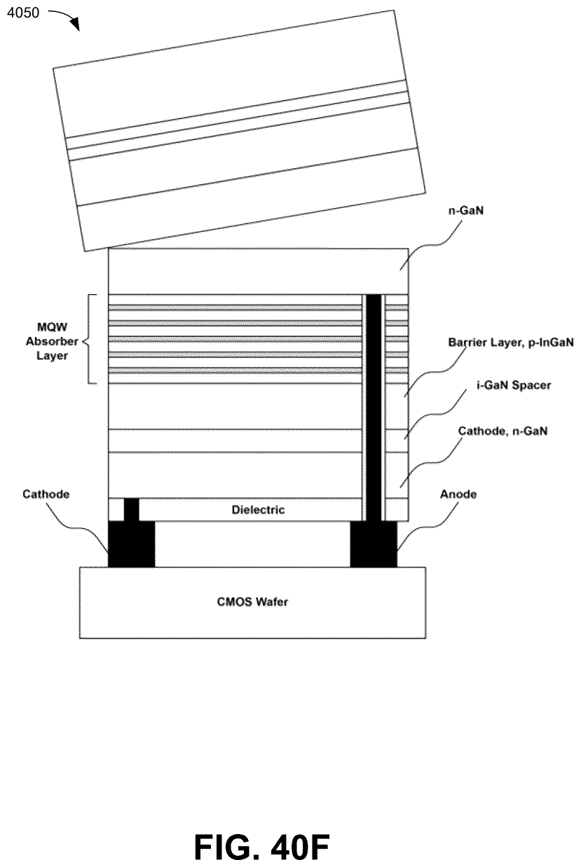

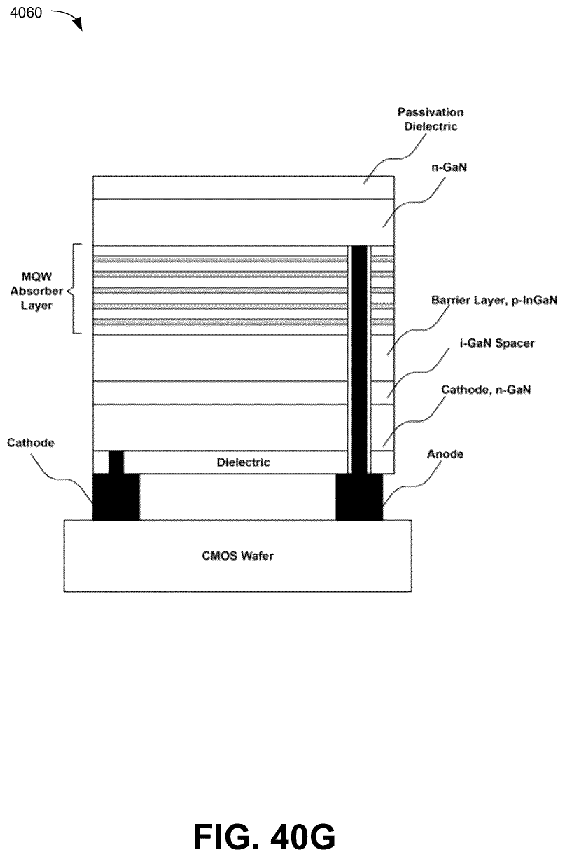

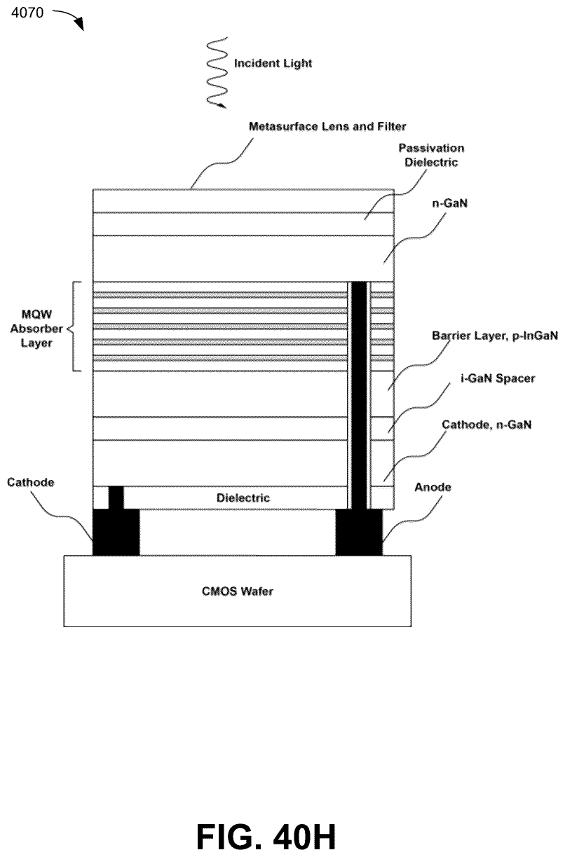

FIG. 40A depicts a cross section of a structure 4000 after a fabrication process of microscopic heterostructure NIPIN photodetector. A sapphire wafer is chosen for its stability. An Aluminum Nitride (AlN) barrier layer, up to 50 nm thick, is deposited using methods like sputtering or MOCVD to minimize strain. A 400 nm unintentionally doped (UID) GaN buffer layer follows, ensuring crystalline integrity. Then, a 300-500 nm n+GaN anode layer is grown. Thin UID GaN quantum barriers and InGaN quantum wells alternate to form a multiple quantum well (MQW) absorption layer. A p-type InGaN barrier, a i-GaN spacer, and n+GaN cathode, and patterned dielectric complete the device structure.

FIG. 40B depicts a structure 4010 after etching the structure into mesas with specific dimensions. These mesas can take various shapes, including squares with a shoreline of 10 μm, rectangles with dimensions of 10 μm×8 μm, circles with diameters of 10 μm, or ellipses with axes of 13 μm and 7 μm.

FIG. 40C depicts a structure 4020 after formation of via contacts to the cathode and anode, and formation for contact pads. Metal bumps are fabricated on both the anode and cathode terminals. These bumps facilitate flip-chip hybrid bonding, a technique used to transfer the MPD onto corresponding pads on the readout circuitry, which is often based on CMOS technology.

FIG. 40D depicts a structure 4030 after align metal pads on the MPD growth wafer with the metal pads on the CMOS readout circuitry wafer in preparation for bonding.

FIG. 40E depicts a structure 4040 after bonding of metal pads. FIG. 40F depicts a structure 4050 after sapphire wafer removal. FIG. 40G depicts a structure 4060 after deposition of passivation dielectric on the window layer. FIG. 40H depicts a structure 4070 after fabrication of microlenses. A metasurface lens also acts as a filter to select a particular wavelength to detect.

### Transfer-Friendly Infrared Heterostructure Nipin Photodetector

Infrared heterostructure MPD (IR-MPD) may be transferred to a CMOS readout wafer along with the visible MPD explained above to make cover both infrared and visible spectra.

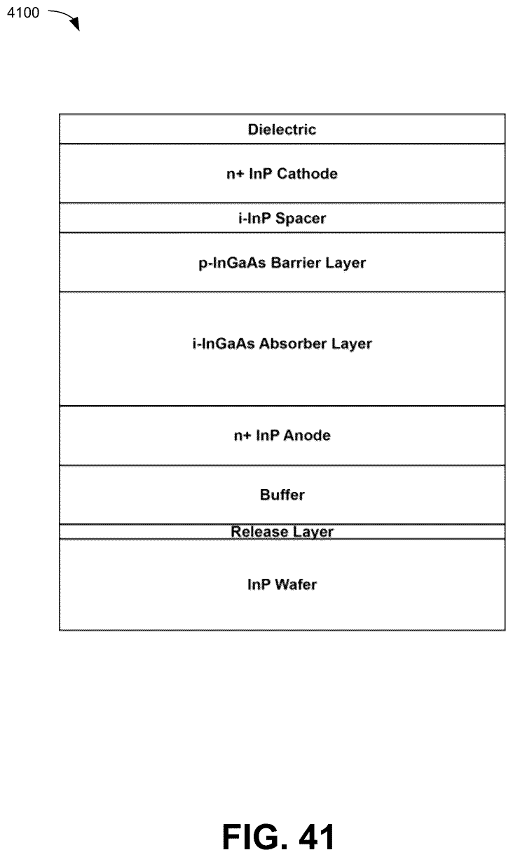

FIG. 41 depicts a cross section of infrared heterostructure MPD (IR-MPD) 4100 that is transfer-friendly for making polychromatic image sensors. InGaAs is sensitive to SWIR light and is lattice matched to InP.

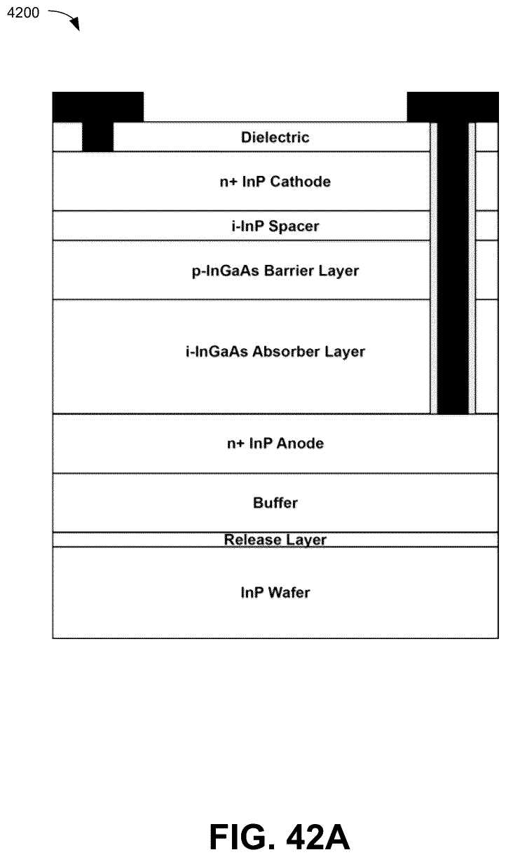

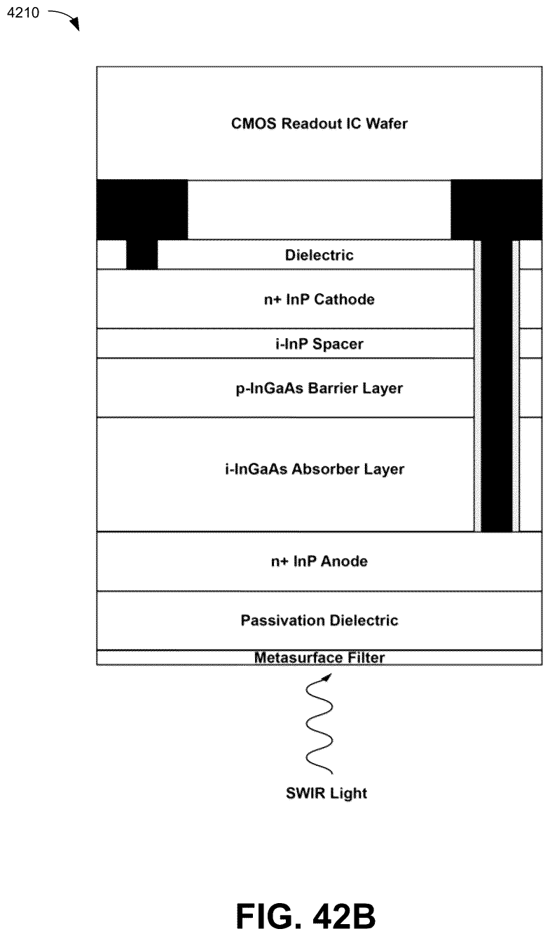

FIG. 42A depicts an example cross section of structure 4200 that includes infrared heterostructure MPD (IR-MPD) formation of contacts to cathode and anode layers.

FIG. 42B depicts an example cross section structure 4210 that includes infrared heterostructure MPD (IR-MPD) after transfer to a CMOS wafer that includes readout circuitry. This can be used for making polychromatic image sensors that cover visible, infrared, and other spectra.

Various examples include a high-speed and high-responsivity image sensor apparatus comprising: a substrate selected from sapphire; a buffer layer of unintentionally doped (UID) GaN grown on the substrate; an n+GaN anode layer grown on the buffer layer; a multiple quantum well (MQW) absorption layer comprising alternating layers of GaN quantum barriers and InGaN quantum wells, where the indium mole fraction in the InGaN quantum wells is configured to detect a specific wavelength; a p-type InGaN barrier layer grown on the MQW absorption layer; an UID GaN spacer is grown on the p-type InGaN barrier; an n+ GaN cathode layer grown on the p-type i-GaN spacer; metal bumps on the anode and cathode terminals for flip-chip hybrid bonding with a readout CMOS circuit; and microlenses or metasurface lenses integrated on each MPD for selective wavelength detection.

In some examples of the image sensor, the indium mole fraction in the InGaN quantum wells determines the cutoff wavelength for the MPD. In some examples, the mesa shape is selected from the group consisting of square, rectangular, circular, or elliptical with predefined dimensions. In some examples, the p-type barrier layer has an indium mole fraction between 3% and 10%.

In some examples, the high-speed imaging system detects light across the ultraviolet, visible, and infrared spectra using configurable quantum wells.

In some examples, the metasurface lenses act as both wavelength filters and focusing elements to enhance the responsivity in low-light conditions.

Some examples can include a method for manufacturing a high-speed and high-responsivity image sensor, comprising: depositing an Aluminum Nitride (AlN) barrier layer on a sapphire wafer; growing a UID GaN buffer layer using Metal Organic Chemical Vapor Deposition (MOCVD); forming an n+ GaN anode layer; growing a multiple quantum well (MQW) absorption layer with alternating layers of UID GaN quantum barriers and InGaN quantum wells; depositing a p-type InGaN barrier layer and an n+ GaN cahode layer; etching the structure into mesas with target dimensions; and depositing metal bumps on the anode and cathode terminals for flip-chip hybrid bonding to readout circuitry.

In some examples, the Aluminum Nitride (AlN) barrier layer is deposited to a thickness of up to 50 nm using hot sputtering or MOCVD.

In some examples, the mesas are etched to dimensions of 10 μm by 8 μm or other variations based on desired application needs.

### Layered Polychromatic Image Sensor Architecture and Method of Manufacture

Various examples of a polychromatic sensors enhances sensitivity while reducing noise, reduces power consumption, and resolves material and production limitations, enabling more efficient, high-performance sensors for advanced imaging applications across industries.

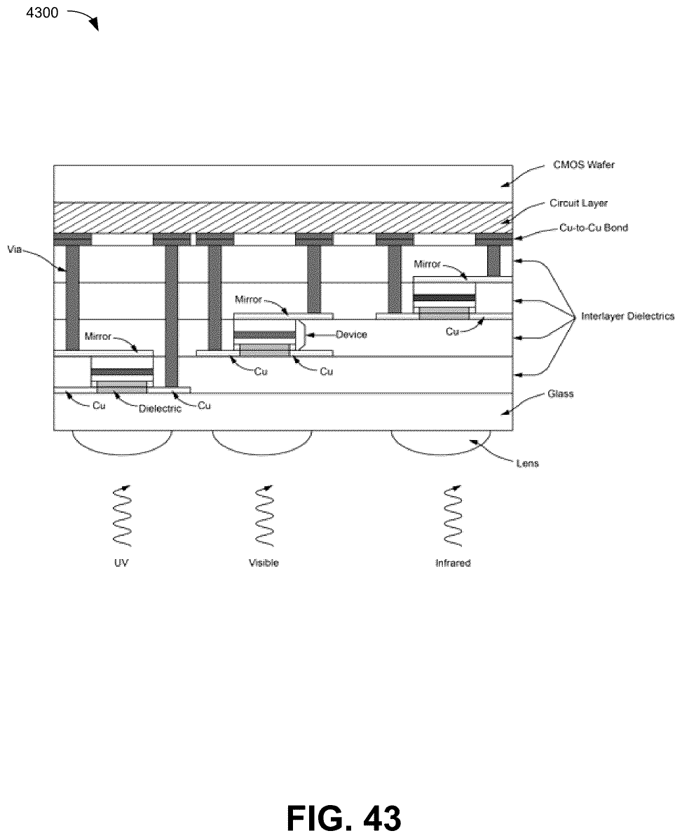

FIG. 43 depicts a cross section of a polychromatic image sensor architecture 4300. The imager is capable of detecting UV, visible, and infrared lights simultaneously. Crosstalk is eliminated by the metal vias providing contacts to the anodes (or cathodes) of adjacent photodetectors. The lenses may be conventional lenses or metasurface lenses. The polychromatic image sensor architecture includes a pixel structure that includes three detectors, each targeting a different wavelength. While this example highlights three wavelengths, the architecture is highly versatile and can accommodate any number of wavelengths, making it adaptable to a variety of applications. For example, UV, visible, and infrared light arrives at lenses. Mirrors cause light reflection to increase absorption and increase sensitivity of detector.

An example manufacturing process begins with the fabrication of a first photodetector optimized for a specific wavelength. This photodetector is grown on its ideal substrate using the best material system and device structure tailored to meet the detectivity requirements at that particular wavelength. Once the photodetector is fabricated, it is transferred from its growth substrate to a transparent glass substrate. This glass substrate is pre-equipped with the necessary interconnects, enabling seamless bonding upon transfer. The transfer process can be performed using established techniques like flip-chip bonding or pick-and-place, both of which are suitable for the microscopic scale of the photodetectors.

Once the first photodetector is bonded to the glass substrate, a first interlayer dielectric (ILD) is deposited on top, which is then planarized to create a smooth surface. Interconnect metal pads are then prepared to accommodate the next photodetector. The process is repeated for the second photodetector, which is also grown on its optimal substrate using the ideal material system and device structure that meets the detection requirements for the second wavelength. This photodetector is transferred and bonded onto the first ILD layer, aligning with the interconnect structures prepared earlier.

A similar procedure is followed for the third photodetector, targeting a third wavelength. After all three photodetectors are successfully transferred and bonded, the interconnect metal pads are prepared to receive a CMOS wafer. This CMOS wafer contains the detection circuits and interconnect pads that will link the anodes and cathodes of the photodetectors, allowing them to function together in a unified system.

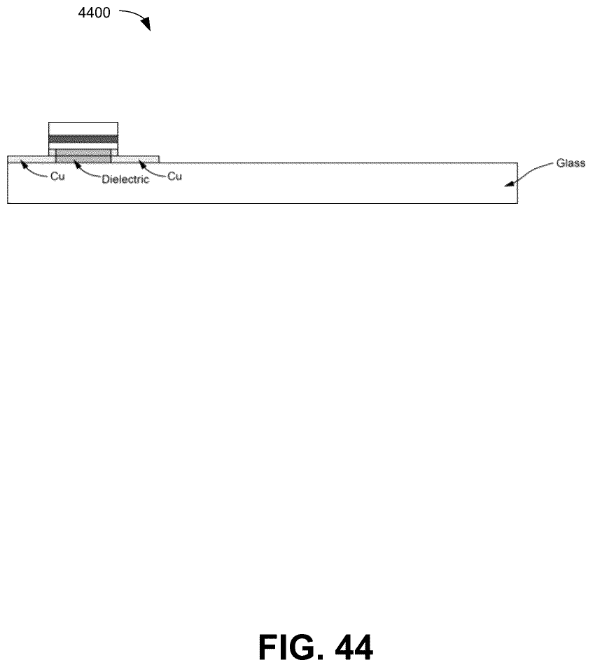

FIG. 44 depicts a cross section of the first photodetector bonded to the glass substrate through the unique interconnect structures described. A photodetector is connected to its corresponding substrate through a bonding structure. This bonding architecture involves two copper pads on the substrate, separated by a dielectric layer that is transparent to the light wavelength being detected. The dielectric layer between the copper pads, which can be on a glass substrate for the first photodetector or an interlayer dielectric (ILD) for subsequent photodetectors, has a diameter that is 60-70% of the photodetector's diameter. On the bottom side of the photodetector, a similar structure is used, featuring a dielectric disk surrounded by a copper ring. The inner diameter of the copper ring is also 60-70% of the photodetector's diameter, and the dielectric disk has a diameter equal to the inner diameter of the copper ring.

When the photodetector's interconnect structure is brought into contact with the substrate's interconnect structure, copper bonds to copper and dielectric bonds to dielectric. The strength of the copper-to-copper bond ranges from 0.2 J/m² to 2.5 J/m², while the dielectric-to-dielectric bond strength is between 0.1 J/m² and 1.5 J/m². These bonding strengths ensure that the photodetector remains securely attached to the substrate throughout further processing operations and during the operational lifetime of the image sensor. The robust nature of this bond is crucial for maintaining the integrity and functionality of the image sensor, ensuring that it can withstand the demands of multi-wavelength detection and the associated stresses of advanced imaging applications.

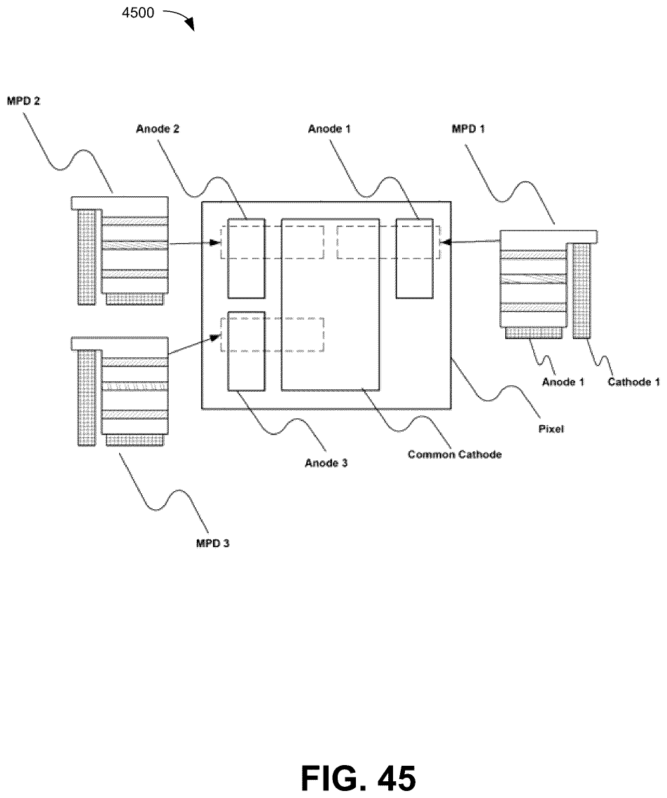

FIG. 45 depicts a top-view layout shows three photodetectors arranged for use in a polychromatic image sensor, following the architecture in FIG. 1, designed to capture multiple wavelengths efficiently. A possible layout for the three microscopic photodetectors (MPDs), with co-planar anode and cathode terminals. While a common cathode terminal may be used, this design is flexible and a multiple dedicated cathode terminals can be used. Other layouts could be used, and the photodetectors themselves may vary in size and shape. Shapes such as disks, squares, or rectangles are merely examples, and the design allows for any configuration that best suits the specific application of the polychromatic image sensor.

The layered construction, involving the strategic transfer of each photodetector and the use of interlayer dielectric and interconnect pads, creates an efficient, scalable system capable of multi-wavelength detection. This approach not only maximizes performance at each wavelength but also simplifies the manufacturing process, making it feasible to expand the architecture to accommodate additional wavelengths as needed.

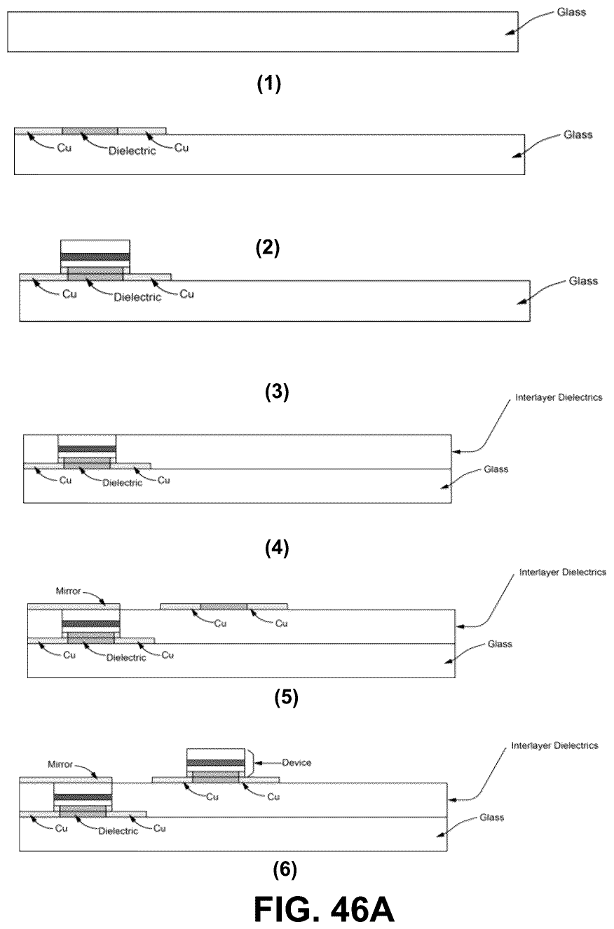

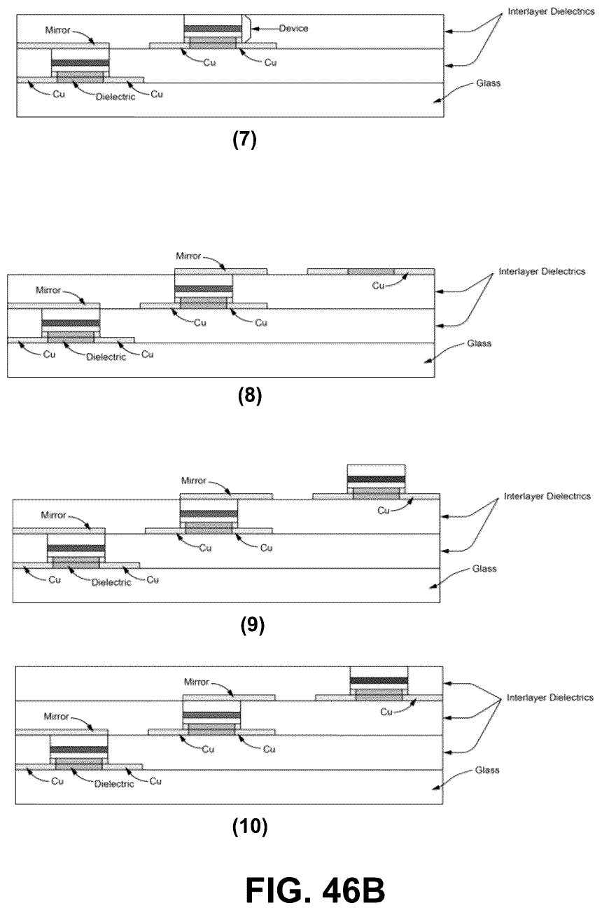

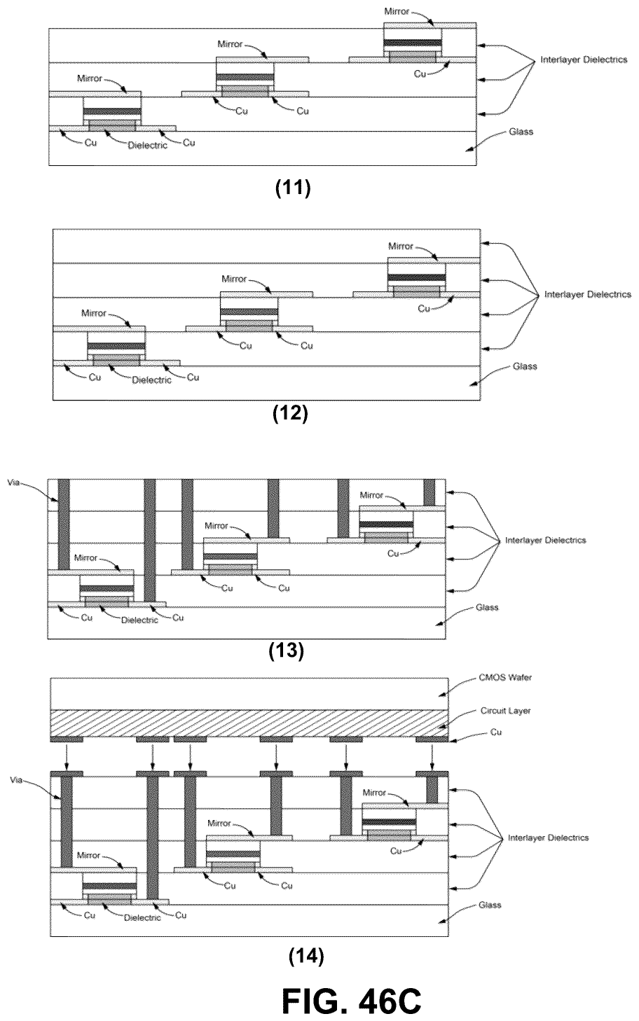

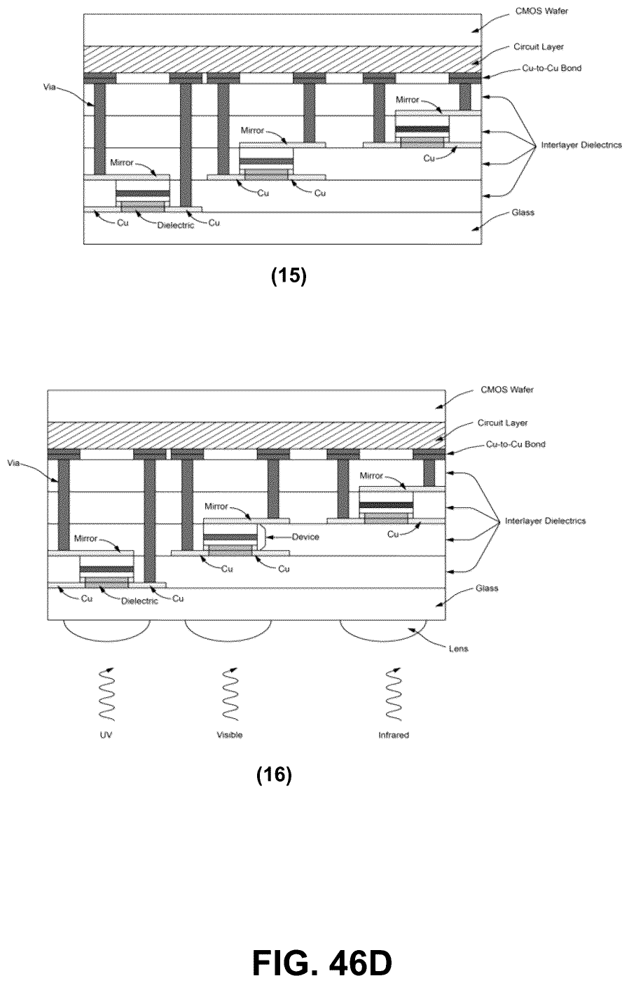

FIGS. 46A-46D show a sequence of schematic show an example process flow for manufacturing the polychromatic image sensor. At (1), transparent glass wafer is provided. At (2), form interconnect bonding structure for receiving the first microscopic photodetector (MPD). At (3), bond first MPD to substrate. At (4), deposit and planarize of first interlayer dielectric (ILD). At (5), form interconnect bonding structure for receiving the second microscopic photodetector (MPD). At (6), bond the second MPD to the first ILD. At (7), deposit and planarize second interlayer dielectric (ILD). At (8), form interconnect bonding structure for receiving the third microscopic photodetector (MPD). At (9), bond the third MPD to the second ILD. At (10), deposit and planarize third interlayer dielectric (ILD). At (11), deposition and patterning of the mirror of third MPD (the last MPD in this case). At (12), deposition and planarization of fourth interlayer dielectric (ILD). At (13), formation of via trenches and filling the trenches with metal. At (14), aligning the CMOS wafer with its metal interconnect pads to the metal pads of the anodes and cathodes of the MPDs. At (15), perform hybrid bonding. At (16), form microscopic scale lenses.

Various examples can include a polychromatic image sensor architecture that includes multiple photodetectors, each for different wavelengths, and bonded onto a common substrate with layered interconnects and dielectric materials to enable multi-wavelength detection.

Various examples include a process of fabricating the image sensor, including operations such as growing photodetectors on their optimal substrates, transferring them to a transparent substrate, and bonding them using techniques like flip-chip or pick-and-place. Spectral filters or metasurface lenses can be utilized to enhance the sensor's performance by selectively targeting specific wavelengths.

Various examples include a bonding structure with copper and dielectric layers between the photodetector and the substrate, ensuring robust connections and minimizing crosstalk.

### Single Layer Polychromatic Image Sensor Architecture

Polychromatic image sensors are technically sophisticated but face hurdles in achieving low noise, high sensitivity, and efficient data processing across a wide spectral range. The economic challenges mainly stem from high development and material costs, limited scalability, and the need for substantial data infrastructure investments. These limitations restrict their broader commercial use and maintain higher costs, especially in industries like defense and high-end scientific applications.

Designing precise, high-performance filters for multiple wavelengths is challenging. Misalignment or degradation of these filters can reduce image quality and spectral accuracy. When different wavelength channels overlap, it causes crosstalk between pixels, leading to reduced color fidelity and spectral resolution. Some systems combine multiple sensor technologies (e.g., visible, infrared), which increases complexity and the need for precise calibration and synchronization. Achieving high sensitivity across a broad spectrum while maintaining low noise levels is difficult, especially in low-light conditions. This is particularly challenging for detecting signals in the ultraviolet or infrared ranges, where sensor materials often have reduced performance. Polychromatic sensors, especially those with advanced processing capabilities, tend to consume more power than monochromatic sensors, which can limit their use in portable or battery-powered devices like drones or handheld surveillance tools. The development of sensitive materials that respond effectively to multiple wavelengths is still an area of ongoing research. For example, optimizing semiconductor materials like InGaAs or HgCdTe for infrared detection adds cost and complexity. In addition, manufacturing precise, high-performance optics and micro-fabricated components for polychromatic sensors can be complex and prone to yield losses. Polychromatic sensors generate large amounts of data, utilizing advanced image processing algorithms and high storage capacity to manage spectral data efficiently. This creates a need for real-time data fusion and interpretation, which can be computationally intensive.

Various examples provide an image sensor architecture with innovative manufacturing techniques that overcome key challenges of modern polychromatic sensors. Various examples simplify complex designs, enhances sensitivity while reducing noise, optimizes power consumption, and resolves material and production limitations, enabling more efficient, high-performance sensors for advanced imaging applications across industries.

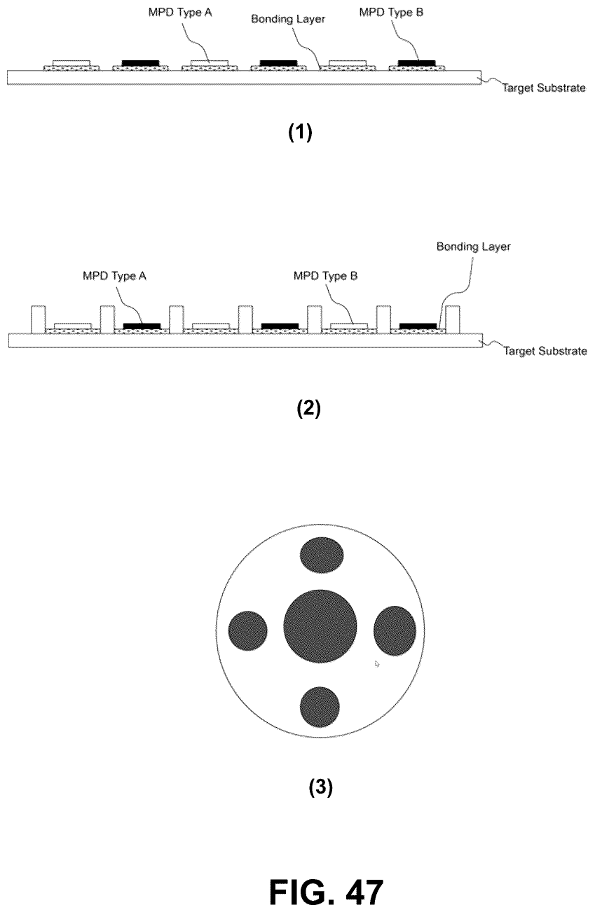

FIG. 47 depicts a pixel structure consisting of two detectors, each targeting a different wavelength. While this example highlights two wavelengths, the architecture is highly versatile and can accommodate any number of wavelengths, making it adaptable to a variety of applications. Multiple devices can be integrated on a single substrate, using a nanoparticle-infused conductive paste (called Bonding Layer) for strong, reliable bonding. This paste enhances electrical connectivity and mechanical stability, ensuring efficient performance and seamless functionality in the final advanced structure.

Item (1) shows a schematic cross section of the proposed single-layer polychromatic image sensor architecture. For illustration purpose, the imager is capable of detecting UV and infrared lights simultaneously using MPD Type A and MPD Type B, respectively.

Item (2) shows a cross section of the proposed single-layer polychromatic image sensor architecture. For illustration purpose, the imager is capable of detecting UV and infrared lights simultaneously using MPD Type A and MPD Type B, respectively. The posts surrounding the photodetectors can be designed to eliminate crosstalk. An array of pseudo random white and black photodetectors can be arranged in the same plane to provide redundancy in case of failure of white or black photodetector. Multiple devices can be formed on a single substrate, using a nanoparticle-infused conductive paste (called Bonding Layer) for strong, reliable bonding. This paste enhances electrical connectivity and mechanical stability, ensuring efficient performance and seamless functionality in the final advanced structure.

Item (3) shows a top down view of photodetector. Cross section of fiber. Light emitted from different cables in wire. Photodetectors positioned in different regions more likely to receive light.

A redundancy scheme may be adopted to substantially improve the manufacturing yield. If only known good dies (KGDs) are transferred from growth substrate to target CMOS wafer, then very high yield is obtained in manufacturing. The architecture reduces power consumption compared to traditional polychromatic sensors, making it suitable for portable, battery-powered devices such as drones and handheld surveillance tools, which are critical for extended military operations in the field. The nanoparticle-infused conductive paste used in the bonding process enhances mechanical stability and electrical connectivity, ensuring robust performance in harsh military environments, where durability and long-term reliability are essential.

A distinguishing aspect of the invented structure in the final product is the incorporation of multiple devices on the same substrate, showcasing a seamless integration of different functionalities. Another feature is the use of a conductive paste embedded with nanoparticles, which plays a crucial role in establishing a strong and reliable bond between the microscopic scale photodetectors (MPDs) and the target substrate. This nanoparticle-filled conductive paste not only ensures enhanced electrical connectivity but also provides the mechanical stability needed for the efficient performance of the assembled devices, making it a standout feature in this advanced structure.

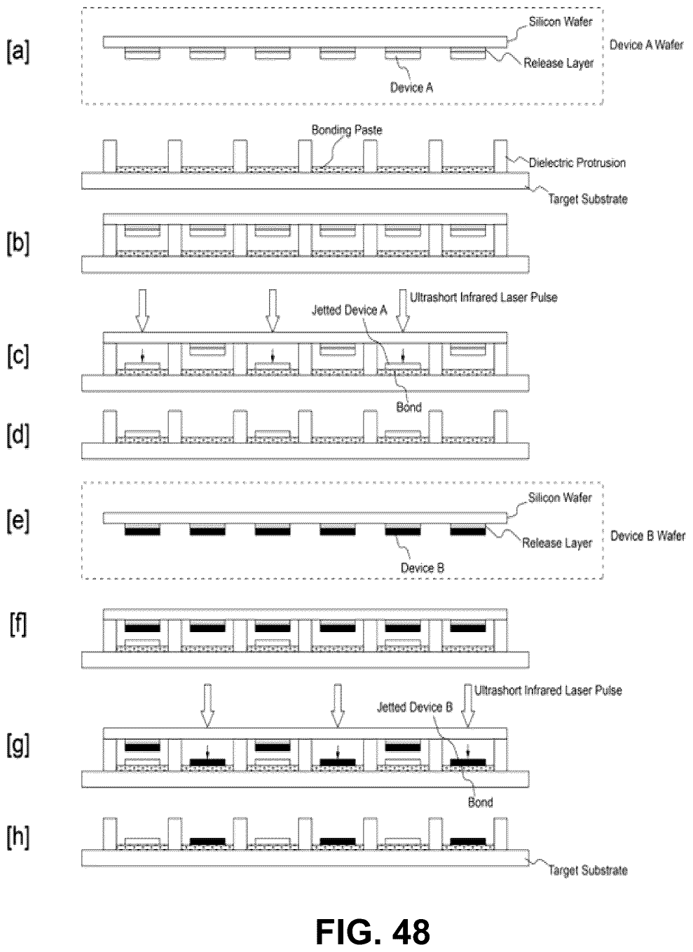

FIG. 48 depicts a process flow. The single layer construction, involving the strategic transfer of each photodetector creates an efficient, scalable system capable of multi-wavelength detection. This approach not only maximizes performance at each wavelength but also simplifies the manufacturing process, making it feasible to expand the architecture to accommodate additional wavelengths as needed.

The process begins with the growth of microscopic devices of type A on a silicon wafer, where they are supported by a dual-purpose release/growth layer that separates them from the silicon substrate. In parallel, the target substrate is prepared with an intricate array of dielectric protrusions that form wells, each filled with a conductive paste infused with conductive nanoparticles, ready to bond with the micro devices. This conductive paste is intricately connected to circuits, whether CMOS-based or thin-film-transistor-based. Once the silicon wafer is carefully aligned with the target substrate, ensuring that the micro devices face the wells, the dielectric protrusions make contact with the wafer surface, creating the ideal setup for transferring the devices. A precise laser pulse, ranging between 1500 nm to 2000 nm in wavelength, with an ultra-short pulse width of 1-10 picoseconds and energy per pulse between 1-20 micro-Joules, is directed through the silicon wafer, targeting the release/growth layer beneath the micro devices. The absorbed energy causes the layer to vaporize, creating a high-pressure burst that propels the micro device into the conductive paste, where it temporarily bonds with a strength of about 0.1-0.2 J/m². This process is then repeated with a second wafer containing microscopic devices of type B, resulting in a target substrate populated with both types of devices-potentially including microscopic photodetector of type A, and microscopic photodetectors (MPDs) for type B, with diameters ranging from 1 to 50 micrometers. To ensure the bond is robust and reliable, an annealing operation follows, enhancing the bond strength to 1-2 J/m², which not only secures the devices but also ensures low contact resistance, crucial for efficient, reliable operation. This sophisticated assembly method ultimately enables the creation of high-performance polychromatic image sensor for military and commercial applications.

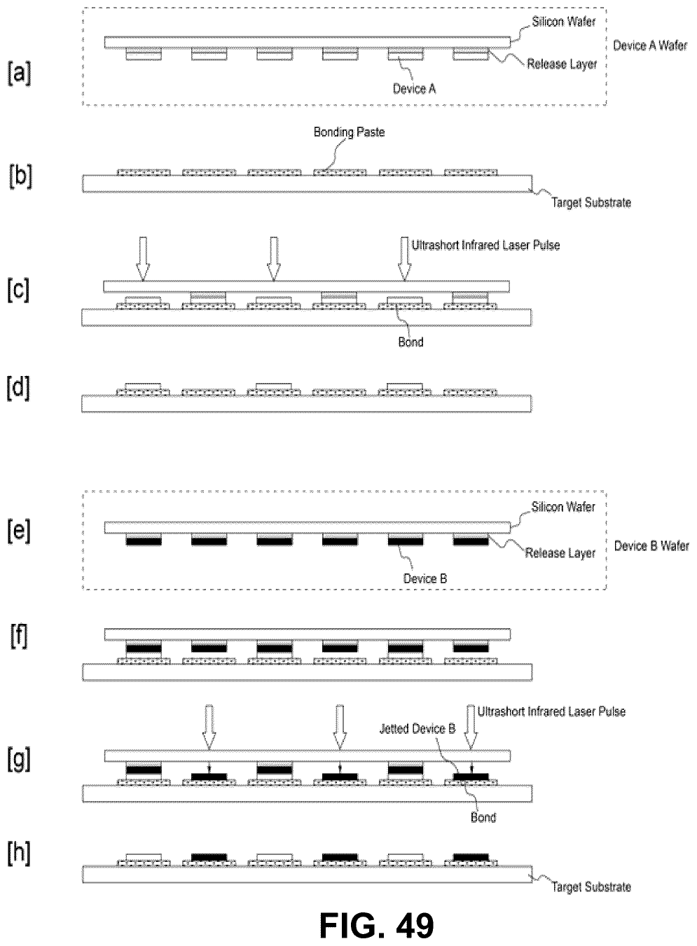

FIG. 49 depicts a process flow for transferring multiple microscopic devices from multiple growth substrates onto a single target substrate. The process flow is similar to what is shown in FIG. 48 except that the previously transferred microscopic devices is used in place of the dielectric protrusions to create a space for jetting released microscopic devices onto the conductive past for the second, third, etc. set of microscopic devices.

Various examples include a polychromatic image sensor architecture comprising: a single substrate; a plurality of photodetectors, each targeting a different wavelength band; a nanoparticle-infused conductive bonding layer for attaching the photodetectors to the substrate, wherein the bonding layer enhances electrical connectivity and mechanical stability; and circuitry to detect signals across a range of wavelengths, including ultraviolet and infrared, while minimizing pixel crosstalk. The photodetectors are configured to detect ultraviolet and infrared wavelengths simultaneously. The nanoparticle-infused bonding layer is composed of conductive metal nanoparticles providing enhanced electrical and mechanical performance.

A method for manufacturing a polychromatic image sensor includes transferring photodetectors from multiple growth substrates to a target substrate; using a nanoparticle-infused conductive paste to bond the photodetectors to the target substrate; applying an annealing operation to strengthen the bonds and reduce contact resistance; and configuring the photodetectors to detect multiple wavelength bands on a single layer. The laser pulse used for transferring photodetectors has a wavelength in the range of 1500-2000 nm and a pulse width between 1-10 picoseconds. The annealing process strengthens the bond to between 1-2 J/m², ensuring low contact resistance.

Various examples include a polychromatic image sensor architecture with a redundancy scheme, wherein only known good dies (KGDs) are transferred to the target substrate to ensure high manufacturing yield.

Various examples include a polychromatic image sensor architecture incorporating a pixel structure with surrounding posts designed to eliminate crosstalk between photodetectors targeting different wavelengths.

### Compact Direct Photon to Digital Conversion Circuits

Polychromatic image sensors have advanced considerably, yet they continue to face significant challenges in delivering low noise, high sensitivity, and efficient data processing across wide spectral ranges. These limitations restrict their widespread commercial use and contribute to higher costs, especially in defense and scientific applications. CMOS image sensors, which dominate the market, convert light into electric charges through photodiodes, with these charges then read as an analog signal before being converted to digital form. However, in low-light conditions, CMOS sensors are prone to noise, reducing image quality. A promising alternative is photon-counting image sensors, which directly count photons striking the photodiode. Many of these sensors employ avalanche photodiodes (APDs), which, under reverse bias exceeding the breakdown voltage, produce a multiplication effect, generating large currents that correspond to individual photon counts. This approach minimizes noise, making photon-counting sensors particularly advantageous in low-light settings. Despite these benefits, APDs have drawbacks, including the need for high operating voltages, making their integration into portable or low-power devices challenging. Furthermore, creating APD-based sensors for polychromatic or hyperspectral imaging—critical for capturing multiple wavelengths—remains complex, limiting their broader application. The development of a low-voltage alternative to APDs could unlock new possibilities and significantly expand the utility of photon-counting sensors in various industries.

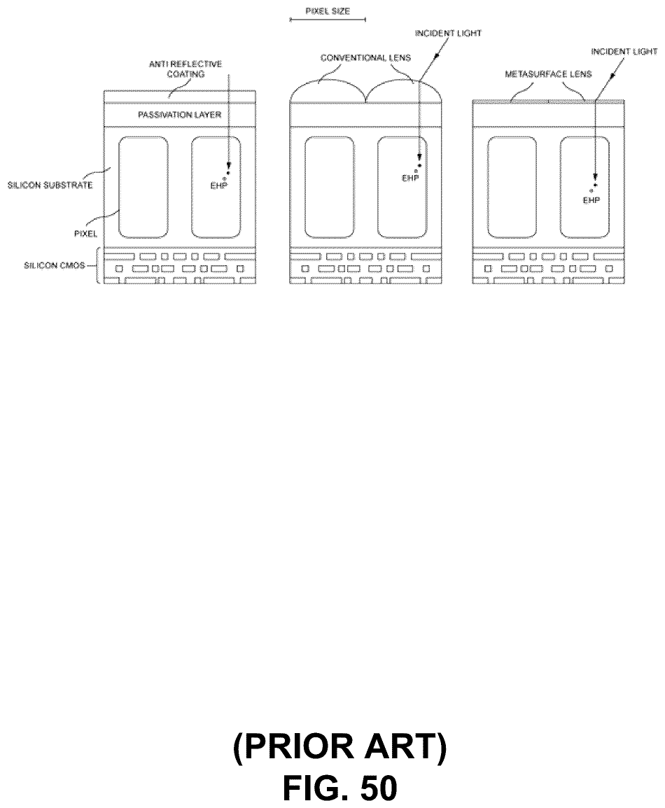

FIG. 50 depicts prior art CMOS image sensors. Prior photon counting image sensors using avalanche photodiodes (APDs) with counter circuits excel in photon detection but face challenges due to high operating voltages, making them unsuitable for portable, low-power applications. Moreover, integrating APDs for polychromatic or hyperspectral imaging is complex, limiting their versatility for accurate color detection and broader spectral analysis in diverse imaging fields.

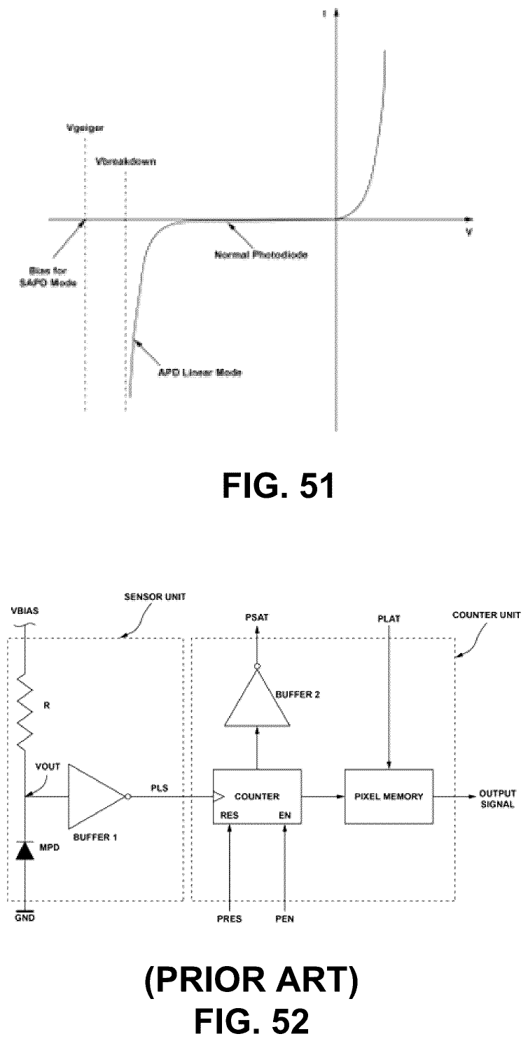

FIG. 51 shows the physics of the APD operation through its I-V characteristics of a photodiode showing avalanche photodiode (APD) operating regime at high operating voltage.

FIG. 52 shows a Prior Art photon to digital conversion using APD. The unit pixel described consists of a sensor portion and a counter portion, which work together to detect and count photons. The sensor portion includes a photodiode, specifically an avalanche photodiode, a quenching resistor, and an inverting buffer. The photodiode operates in Geiger mode by applying a bias voltage greater than or equal to its breakdown voltage. When a photon enters the photodiode, it triggers an avalanche multiplication, generating an avalanche current. This causes a voltage drop across the quenching resistor, stopping the avalanche and allowing the photodiode to reset. The quenching resistor, which could be a resistance component of a transistor, serves to halt the avalanche process. The inverting buffer captures the voltage change at the quenching resistor and outputs it as a pulse signal (PLS) whenever a photon is detected. The counter portion counts the number of pulses (photon incidences) by monitoring changes in the pulse signal from low (L) to high (H) levels. The counter is controlled by an enable signal (PEN) and a reset signal (PRES) from a vertical control circuit. The counter increases its count when the enable signal is high, and resets the count to zero when the reset signal goes high. The count value, representing the number of detected photons, is temporarily stored in the pixel memory, which is activated by a latch signal (PLAT). The stored count value becomes the pixel signal, representing the number of photons captured by the unit pixel.

Various examples include an image sensor that includes one or more processors and circuitry that enable photon detection, photon counting, and output of a count value for each pixel during a predetermined exposure period.

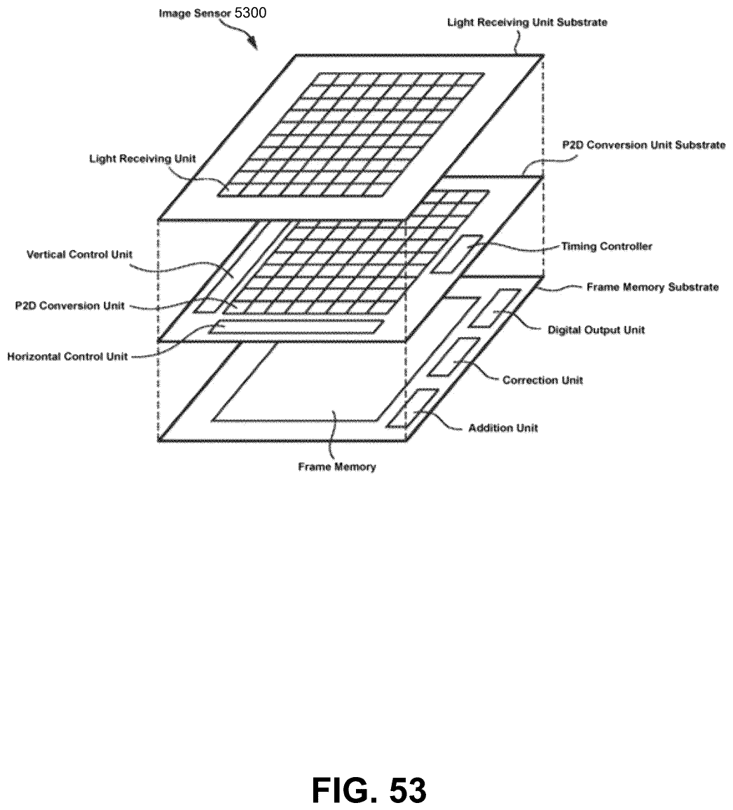

FIG. 53 depicts a layout of a vertically disaggregated image sensor 5300. A photon-to-digital (P2D) conversion unit is proposed to provide high signal-to-noise ratio. A sensor can be structured using stacked substrates for the light-receiving unit, counting unit, and frame memory unit. These substrates are electrically connected through silicon vias and hybrid bonding methods, enhancing integration and minimizing size. The frame memory substrate, often manufactured with a finer process than the light-receiving and counting unit substrates, is designed to accommodate a large number of bits, thus ensuring high data storage capability. The frame memory substrate also houses critical components such as the addition unit, correction unit, and digital output unit, all contributing to the sensor's overall efficiency.

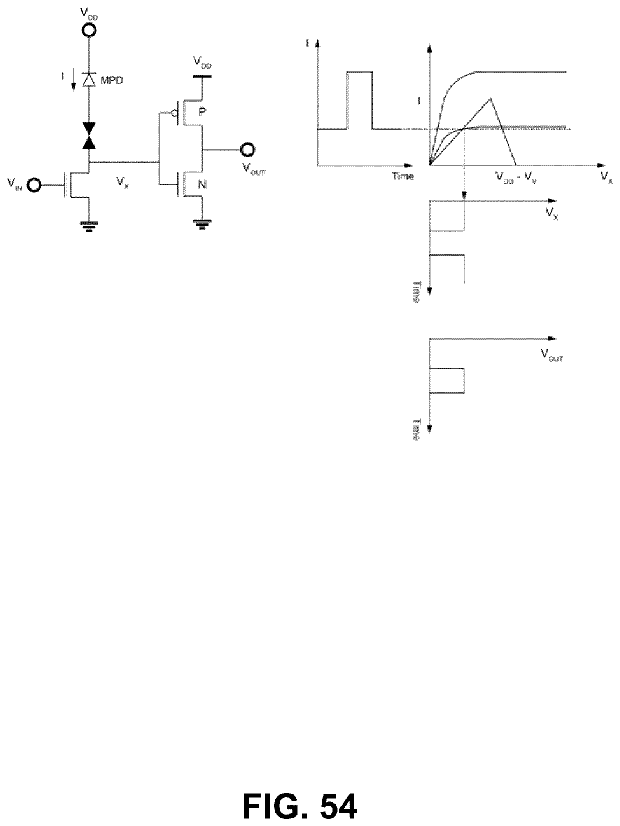

FIG. 54 depicts a photon-to-digital conversion circuit, designed to maximize signal-to-noise ratio with minimal components. This circuit can use only five transistors, making it highly efficient and space-saving, as the layout is confined to the size of the microscopic photodetector, which can be as small as 10 μm×10 μm or less. When a light pulse hits the MPD (microscopic photodetector), current flows through the NDR device and that causes VX to go to HIGH as shown on the right-hand side of the figure. An output voltage pulse is created at the output of the CMOS inverter in response to the incident photon pulse.

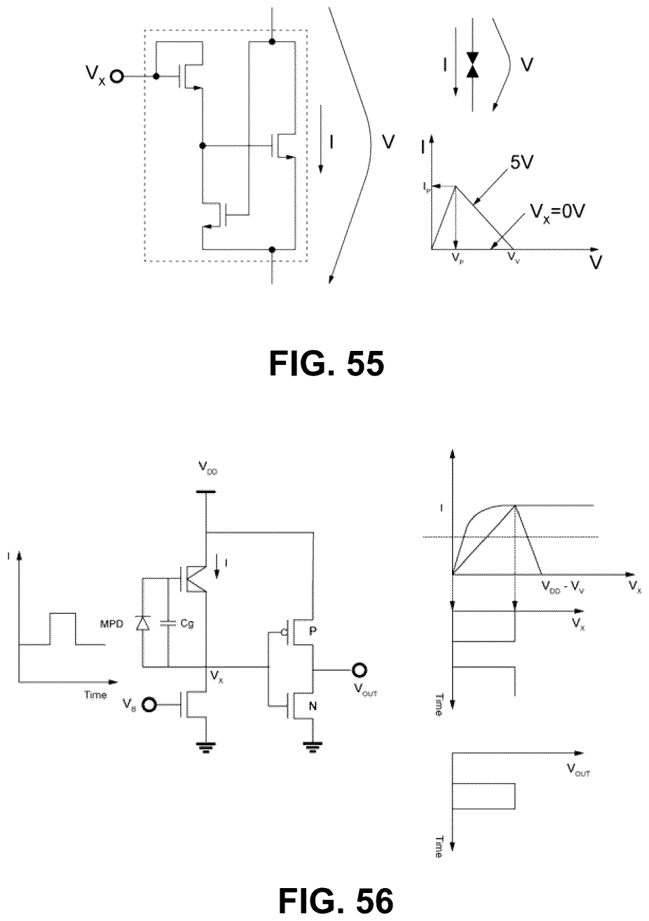

FIG. 55 depicts a negative differential resistance (NDR) device, which is implemented using only three transistors. This simplicity and efficiency make the circuit ideal for high-density sensor applications, providing robust performance without the need for complex or bulky components. This combination of photon-counting capability, compact design, and advanced signal processing represents a significant advancement in image sensor technology, providing higher-quality imaging, in low-light or noise-sensitive environments.

FIG. 56 depicts a photon to digital configuration. When the microscopic photodetector (MPD) receives a light pulse, current flows and charges gate capacitance of the NDR to turn on a negative differential resistance device (the three transistors). When the bottom transistor is biased with VB on its gate terminal, then the intercept between the two curves (NDR and FET) creates a new data point (causing VX to go to High value). VB can be a sampling pulse. VX is applied to a CMOS inverter circuit and the output voltage VOUT is a pulse that corresponds to the photon pulse hitting the MPD.

A structure includes a vertically disaggregated architecture with stacked substrates, including light-receiving, counting, and frame memory units, interconnected through silicon vias and hybrid bonding. This multi-layered structure could be revealed through Scanning Electron Microscopy (SEM) or Transmission Electron Microscopy (TEM), where the stacked nature of the components, as well as the silicon vias, would be visible, showing the advanced integration of the system.

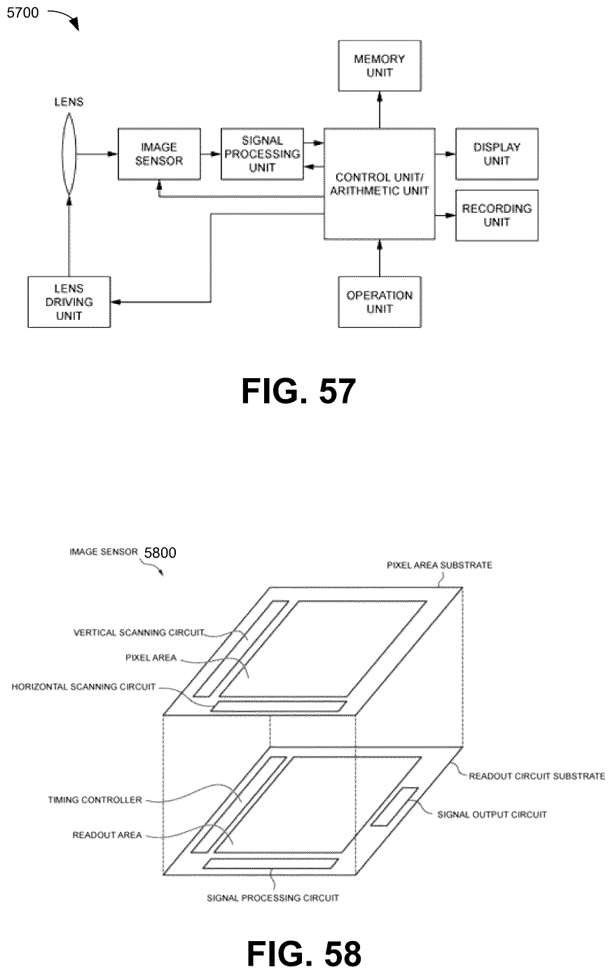

FIG. 57 depicts an image-capturing system. In system 5700, an imaging lens, driven by a lens driving unit, performs zoom, focus, and aperture control to form an optical image of a subject onto the image sensor. This sensor is capable of counting the number of photons that strike its surface and outputting that count as a signal value. The optical image formed by the lens is received as incident light on the sensor, and the output is processed into an image signal by the signal processing unit. Various types of arithmetic and control operations are handled by an overall control and arithmetic unit, which governs the functionality of the entire image-capturing apparatus. Temporary image data storage occurs in a memory unit, while a display unit shows captured images and other relevant information. Additionally, a recording unit equipped with detachable semiconductor memory allows for recording and reading image data. User input is provided via an operation unit that includes buttons, dials, or even a touch panel if the display unit supports touch functionality. Examples provide a compact, low-voltage, low-power photon-to-digital conversion (i.e., targeting the Signal Processing Unit IP block for improvement over the state-of-the-art).

FIG. 58 depicts disaggregated image sensor 5800 where the photodetection layer and photon-to-digital conversion layers are made on different substrates. Readout area include the photon-to-digital conversion circuits described herein.

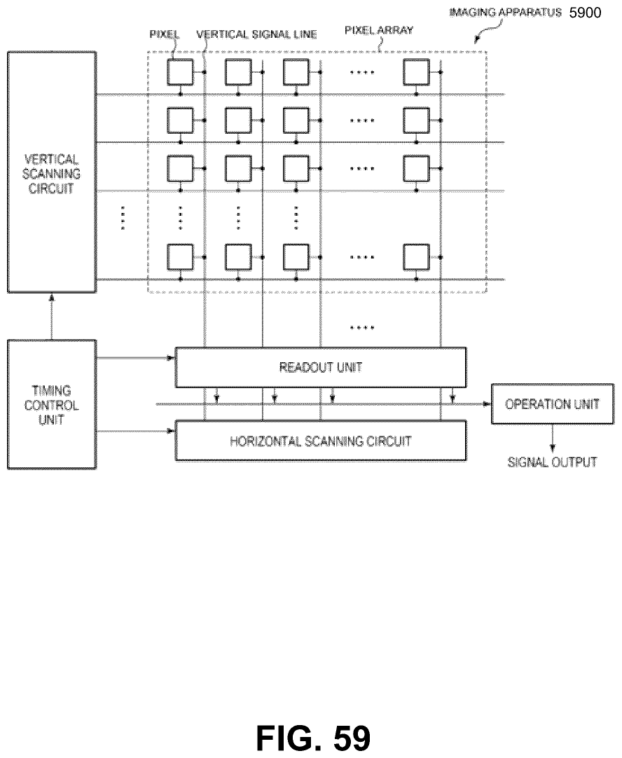

FIG. 59 depicts an imaging apparatus 5900. Imaging apparatus 5900 can include a pixel array, a vertical scanning circuit, a readout unit, a horizontal scanning circuit, a timing control unit, and an operation unit. The pixel array has a plurality of pixels arranged in a matrix. Each of vertical signal lines provided on a column basis is connected to each of the pixels as a wiring for outputting a signal.

Various examples include a polychromatic image sensor architecture comprising a vertically disaggregated structure, wherein the light-receiving unit, photon counting unit, and frame memory unit are fabricated on separate substrates, electrically connected via silicon vias and hybrid bonding, and configured to provide photon-to-digital conversion for each pixel during a predetermined exposure period. The photon-counting unit operates at low voltage, reducing power consumption and improving suitability for portable or low-power applications, eliminating the need for avalanche photodiodes (APDs). The light-receiving unit is fabricated on a silicon or compound semiconductor substrate optimized for detecting visible, ultraviolet, and infrared wavelengths. The silicon vias can be fabricated using a hybrid bonding method, including copper-to-copper and dielectric bonding techniques to minimize interconnect resistance and increase data throughput. The microscopic photodetector is as small as 5 μm×5 μm, enabling high-density pixel arrays. The frame memory substrate is manufactured using a finer process than the light-receiving and photon counting unit substrates, allowing high data storage capacity to accommodate a large number of bits. The light-receiving unit is capable of detecting light across multiple wavelength ranges, including ultraviolet, visible, and infrared, enabling hyperspectral imaging.

Various examples include a photon-to-digital conversion circuit integrated into the image sensor architecture, comprising a photodetector coupled with a negative differential resistance (NDR) device, wherein the circuit is configured to count incident photons and generate a digital pulse signal corresponding to the photon count. The NDR device can include three transistors arranged to maximize photon detection sensitivity while minimizing noise in the signal.

Various examples include a polychromatic image sensor architecture that integrates adaptive spectral filters or tunable metasurfaces with the light-receiving unit to dynamically modify wavelength sensitivity, enabling real-time multi-spectral imaging across a broader range of applications.

Various examples include a photon-counting image sensor that incorporates on-chip data compression circuitry, enabling real-time processing of photon count data to reduce storage and bandwidth requirements for high-speed imaging systems.

Various examples include a photon-counting image sensor designed for quantum communication applications, wherein the sensor is configured to detect single-photon events and operate in conjunction with quantum key distribution (QKD) protocols.

Various examples include a photon-counting image sensor adapted for flexible or wearable devices, wherein the sensor array is implemented on a flexible substrate and is designed for portable health monitoring or environmental sensing applications.

Various examples include a polychromatic image sensor comprising a real-time processing unit that performs spectral decomposition and analysis of detected light, allowing real-time classification and analysis of hyperspectral data for applications in agriculture, medical diagnostics, and environmental monitoring.

### Integrated Multicolor Microleds or MVCSELS and Photodetector Assembly for AI Data Centers

In today's rapidly advancing technology landscape, the demand for high-speed data communication in AI data centers, high-performance computing (HPC), and cutting-edge display technologies is pushing the limits of current fabrication methods. These applications require efficient and versatile integration of microscopic devices, such as microscopic light emitters (MLEs) and microscopic photodetectors (MPDs), onto a single substrate. However, traditional fabrication processes face significant challenges in accurately transferring these devices, often leading to reduced yield and increased manufacturing costs. This problem becomes even more pronounced when dealing with complex applications, such as multicolor displays that require precise integration of MLEs emitting different wavelengths, or smart displays that need seamless integration of both light-emitting and light-detecting elements. The need to combine these diverse device types without compromising performance has become a bottleneck in developing advanced optical transceivers and smart display systems. Addressing this complexity requires an innovative approach to transfer these microscopic devices efficiently, ensuring high yield, reduced costs, and enhanced functionality. Various examples can enable the assembly of MLEs and MPDs on a unified platform, paving the way for advanced optical communication systems, multicolor displays, and intelligent display technologies that meet the demands of modern AI and HPC applications.

Serial optical links based on laser light sources, while efficient for longer distances (10-100 m), demand very high-speed transmission and receiver circuits to maintain data integrity, which drives up both cost and power consumption. Therefore, for AI systems where the link length is typically less than 10 meters, parallel optical interconnects provide a more cost-effective and energy-efficient solution, enhancing overall system performance and reducing operational expenses. Laser operation is sensitive to temperature, requiring expensive, exotic cooling to guarantee consistent performance over time. Pick and place transfer method is too slow and too expensive, and faces the challenge of mechanical interference when transferring multiple devices from different growth wafers sequentially on a single target substrate.

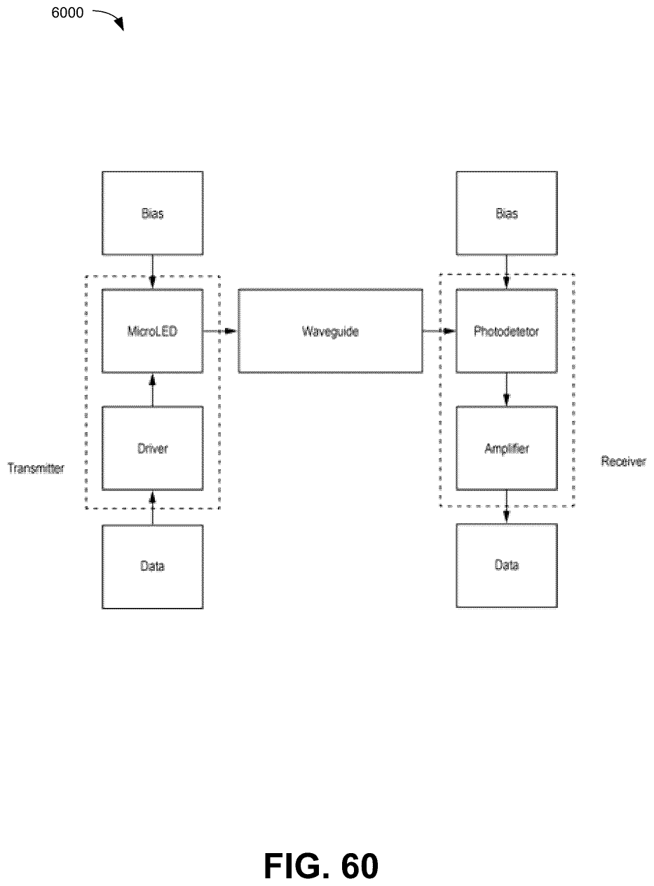

FIG. 60 depicts a block diagram of a parallel optical link 6000 based on arrays of MicroLEDs or Micro VCSELs. The waveguide may be a multicore fiber with 1024 cores, for example.

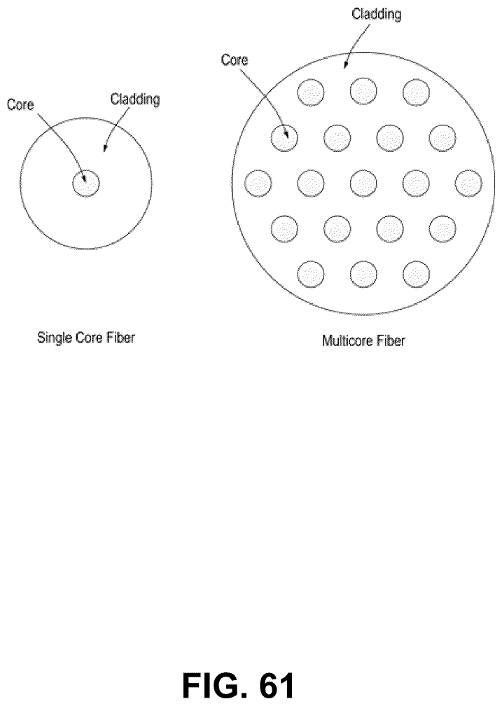

FIG. 61 depicts a schematic illustration of single core fiber and multicore fiber. For Space Division Multiplexing (SDM) datacom systems with target transmission data rates of 2 Tb/s/direction, MCFs with approximately 1024 cores are needed.

Various examples include transceivers and emissive displays built from microscopic light emitters (MLEs), such as MicroLEDs or Micro VCSELs and microscopic photodetectors (MPDs). These devices are integrated onto a single substrate, enabling multicolor displays and optical communication systems. The transceivers can achieve ultra-high data transfer rates exceeding 2 Tb/s with exceptionally low energy consumption (under 0.5 pJ/bit). The smart displays combine MLEs of various colors with MPDs tuned to specific wavelengths, enabling advanced functionality, including wavelength and spatial division multiplexing (WDM and SDM). Nanoparticle-infused conductive paste provides strong, stable device integration.

Various examples use laser pulses to transfer microscopic devices from silicon wafers onto a target substrate with conductive nanoparticle-infused paste. This method vaporizes a release layer, propelling devices into wells on the substrate for temporary bonding. An annealing operation ensures strong, reliable bonds, enabling high-performance transceivers and smart displays.

Various examples integrate multiple devices on a single substrate, using a nanoparticle-infused conductive paste for strong, reliable bonding. This paste enhances electrical connectivity and mechanical stability, ensuring efficient performance and seamless functionality in the final advanced structure.

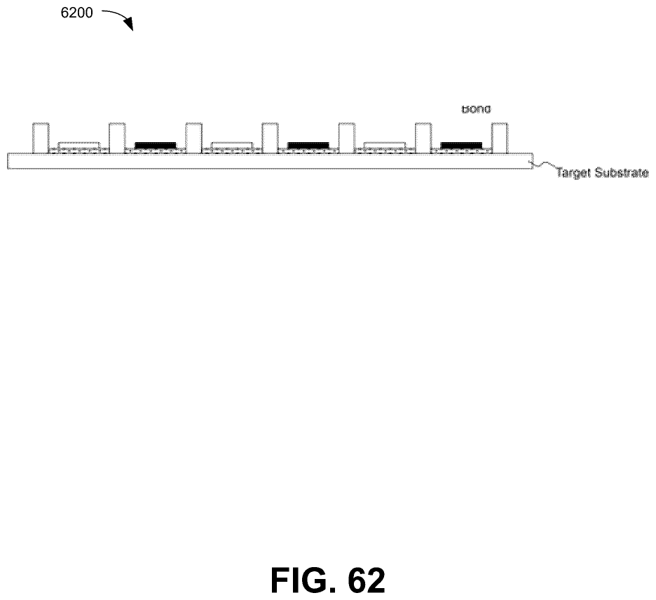

FIG. 62 depicts a schematic illustration of a device structure 6200 where a single substrate includes a plurality of devices coming from different growth substrates (wafers). Various examples enable the precise assembly of MLEs and MPDs on a unified platform, for optical communication systems, multicolor displays, and display technologies.

By enabling transceivers capable of ultra-fast speeds of 2 Tb/s per direction with remarkably low energy consumption (0.5 pJ/bit) using temperature-insensitive MicroLEDs, an efficient and cost-effective solution is provided for short-reach (<10 m) communication. Alternatively, it supports Micro VCSELs for similar high-speed transfer with slightly higher but still impressively low energy (1-2 pJ/bit). Additionally, various examples allow scaling data rates beyond 8 Tb/s per direction by combining wavelength division multiplexing (WDM) and spatial division multiplexing (SDM), significantly reducing costs compared to traditional laser-based systems. Its high-yield transfer method efficiently integrates various devices from different wafers onto a single substrate, ensuring seamless functionality and versatility in complex, multi-functional applications.

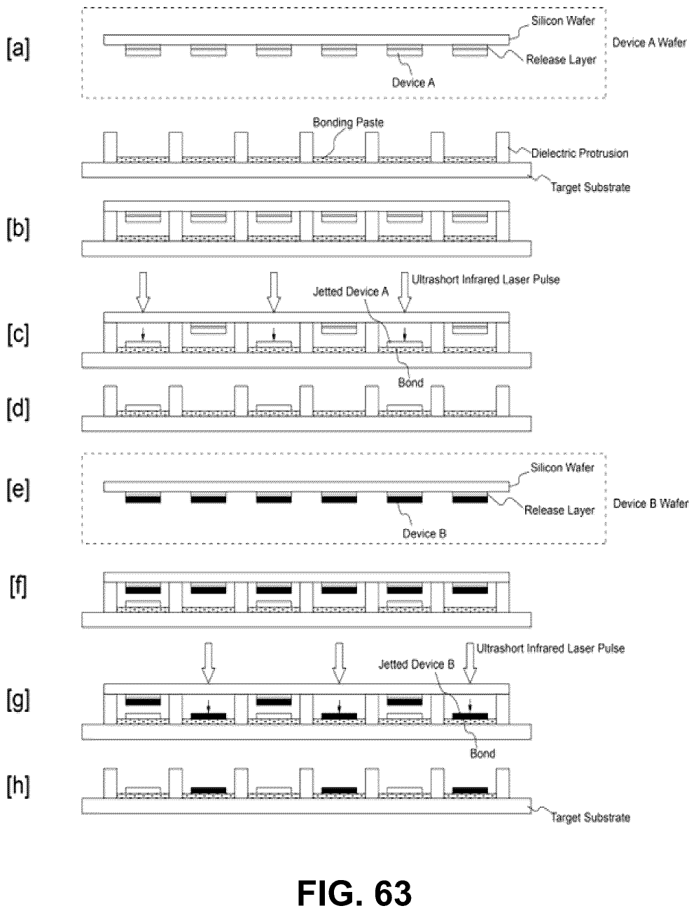

FIG. 63 depicts an example process. The process flow illustrates the transfer to two types of devices (Device A and Device B) from two different growth wafers to a single target substrate. The process begins with the growth of microscopic devices of type A on a silicon wafer, where they are supported by a dual-purpose release/growth layer that separates them from the silicon substrate. In parallel, the target substrate is prepared with an intricate array of dielectric protrusions that form wells, each filled with a conductive paste infused with conductive nanoparticles, ready to bond with the micro devices. This conductive paste is intricately connected to circuits, whether CMOS-based or thin-film-transistor-based. Once the silicon wafer is carefully aligned with the target substrate, ensuring that the micro devices face the wells, the dielectric protrusions make contact with the wafer surface, creating the ideal setup for transferring the devices. A precise laser pulse, ranging between 1500 nm to 2000 nm in wavelength, with an ultra-short pulse width of 1-10 picoseconds and energy per pulse between 1-20 micro-Joules, is directed through the silicon wafer, targeting the release/growth layer beneath the micro devices. The absorbed energy causes the layer to vaporize, creating a high-pressure burst that propels the micro device into the conductive paste, where it temporarily bonds with a strength of about 0.1-0.2 J/m². This process is then repeated with a second wafer containing microscopic devices of type B, resulting in a target substrate populated with both types of devices-potentially including microscopic light emitters (MLEs) such as Micro LEDs or Micro VCSELs for type A, and microscopic photodetectors (MPDs) for type B, with diameters ranging from 1 to 50 micrometers. To ensure the bond is robust and reliable, an annealing operation follows, enhancing the bond strength to 1-2 J/m², which not only secures the devices but also ensures low contact resistance, crucial for efficient, reliable operation. This sophisticated assembly method ultimately enables the creation of high-performance transceivers for parallel optical data communication, facilitating seamless data transfer between semiconductor chips.

The described technique offers exceptional versatility, enabling the transfer of multiple types of devices from different growth substrates onto a single target substrate. This opens up a range of innovative possibilities, such as fabricating multicolor displays by transferring microscopic light emitters (MLEs) of various wavelengths, each grown on separate wafers, onto a unified substrate, resulting in displays with a vibrant and diverse color spectrum. Moreover, the technique can be adapted to create smart emissive displays by integrating MLEs of different colors with microscopic photodetectors (MPDs) tuned to specific wavelengths like infrared, allowing these displays to not only emit light but also interact intelligently with their environment. Additionally, this method facilitates the fabrication of advanced transceivers-on-a-chip, where arrays of MLEs and MPDs are transferred onto a semiconductor chip using wafer-to-wafer transfer apparatus. These transceivers are capable of supporting ultra-high data transfer rates exceeding 2 Tb/s per direction, with remarkably low energy consumption of less than 0.5 pJ/bit, making them ideal for short-reach (up to 10 meters) optical interconnects in AI data centers. As the demand for efficient rack-to-rack connections in AI data centers grows, these transceivers offer a cutting-edge solution. Furthermore, by incorporating MLEs emitting different colors, the transceivers support both wavelength division multiplexing (WDM) and spatial division multiplexing (SDM), pushing data transmission rates to unprecedented levels.

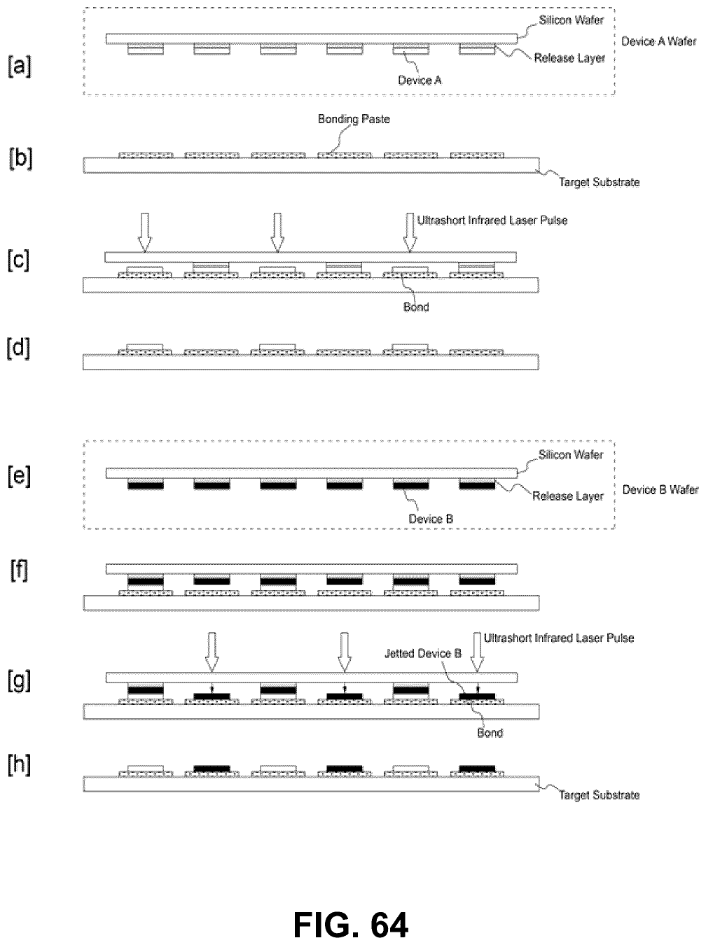

FIG. 64 depicts a process for transferring multiple microscopic devices from multiple growth substrates onto a single target substrate. The process flow is similar to what is shown in FIG. 63 except that we use the previously transferred microscopic devices in place of the dielectric protrusions to create a space for jetting released microscopic devices onto the conductive past for the second, third, etc. set of microscopic devices.

Various examples include a method for fabricating a multicolor smart emissive display, that includes growing microscopic light emitters (MLEs) on multiple silicon wafers, each MLE emitting different wavelengths (colors) and being supported by a release/growth layer; preparing a target substrate with an array of dielectric protrusions that form wells, each well filled with a conductive paste infused with conductive nanoparticles, connected to an electrical circuit; sequentially aligning each silicon wafer with the target substrate such that the MLEs face the wells; using laser pulses with wavelengths between 1500 nm to 2000 nm, pulse widths of 1-10 picoseconds, and energy levels of 1-20 micro-Joules to irradiate the release/growth layer through the silicon wafer, causing the layer to vaporize and transferring each MLE into the conductive paste; repeating the process to transfer microscopic photodetectors (MPDs) tuned to a specific wavelength, such as infrared, from a separate wafer onto the target substrate; and annealing the assembled structure to enhance the bond strength between the MLEs, MPDs, and the target substrate to 1-2 J/m². The MLEs are selected from MicroLEDs or Micro VCSELs with diameters ranging from 1 to 50 micrometers. The MPDs are microscopic photodetectors with diameters ranging from 1 to 50 micrometers. The annealing operation enhances electrical conductivity and reduces contact resistance between the transferred devices and the target substrate. The conductive paste contains conductive nanoparticles selected from silver, copper, or gold. The MLEs are configured to emit wavelengths corresponding to red, green, and blue colors for multicolor optical communication. The MPDs are tuned to specific wavelengths in the infrared spectrum to enable detection of transmitted optical signals. Circuits can be utilized that modulate the emission intensity and wavelength of the MLEs to achieve wavelength division multiplexing (WDM). The dielectric protrusions on the target substrate have heights ranging from 5 to 15 micrometers.

Various examples include a transceiver-on-a-chip apparatus comprising: a semiconductor chip serving as a target substrate with an array of dielectric protrusions forming wells filled with conductive paste containing conductive nanoparticles; a plurality of microscopic light emitters (MLEs) emitting different wavelengths and microscopic photodetectors (MPDs) transferred onto the semiconductor chip, the MLEs and MPDs bonded to the conductive paste; electrical connections that integrate the MLEs and MPDs with the circuits on the semiconductor chip, enabling high-speed optical data communication with data transfer rates exceeding 2 Tb/s per direction and energy consumption of less than 0.5 pJ/bit; and an arrangement of the MLEs to support both wavelength division multiplexing (WDM) and spatial division multiplexing (SDM).

Various examples include an apparatus for transferring microscopic devices onto a target substrate, comprising: a silicon wafer with microscopic light emitters (MLEs) or photodetectors (MPDs) grown on a release/growth layer; a target substrate prepared with an array of dielectric protrusions forming wells, each well filled with a conductive paste that includes embedded conductive nanoparticles; a laser irradiation unit configured to emit laser pulses with wavelengths between 1500 nm to 2000 nm and pulse widths of 1-10 picoseconds to selectively vaporize the release/growth layer and transfer the microscopic devices into the wells filled with conductive paste.

Various examples include constructing a multicolor display by: multiple silicon wafers with MLEs grown on them, each wafer corresponding to different emission wavelengths; a target substrate with dielectric protrusions and conductive paste, arranged to receive the MLEs from each wafer; a transfer system that sequentially aligns and transfers MLEs from each wafer to the target substrate using laser pulses.

Various examples include a method for building a transceiver-on-a-chip for high-speed optical data communication, comprising: growing MLEs and MPDs on separate silicon wafers, with each device type supported by a release/growth layer; preparing a target semiconductor chip with dielectric protrusions forming wells filled with a conductive paste containing conductive nanoparticles; aligning the silicon wafer containing MLEs to the target chip, irradiating the release/growth layer with a laser pulse to vaporize the layer, and transferring the MLEs into the conductive paste; repeating the process for MPDs, ensuring they are transferred onto the target chip; and annealing the target chip to secure the MLEs and MPDs and enhance electrical conductivity for data transfer applications.

Various examples include a method for integrating wavelength division multiplexing (WDM) and spatial division multiplexing (SDM) in a multicolor display or transceiver, comprising: transferring MLEs emitting different colors from separate wafers onto a single target substrate using a laser pulse technique; ensuring precise alignment of MLEs to enable their simultaneous activation for WDM; and arranging MLEs in multiple spatial locations on the target substrate to support SDM functionality.

### Photon-to-Photon Spectral Converter for Swir-to-Visible Imaging

Remote hyperspectral imaging remains a powerful but technically constrained field, largely due to the limitations of current sensor hardware. Many existing hyperspectral sensors, particularly those based on HgCdTe focal plane arrays, suffer from high costs, low yields, and performance issues such as “blinker” pixels such as random, time-dependent offsets that degrade image quality and make consistent calibration challenging. Hardware-induced anomalies severely limit detection reliability, especially for weak or dispersed targets like low-mass-flow chemical effluents or camouflaged threats. Furthermore, achieving high spatial resolution-essential for improved target detectability-requires smaller ground sample distances, which in turn demands more complex and expensive optics, cooling systems, and data handling architectures. The massive data volumes produced by high-bandwidth imaging across hundreds of spectral bands also strain real-time processing and data transmission systems. Current compression techniques are either computationally intensive or risk losing critical spectral detail, making them ill-suited for remote applications.

Various examples include an imaging device that includes a two-dimensional array of heterojunction phototransistors (HPTs) capable of detecting light across a broad spectral range from 400 nm to 1500 nm, for example. Each HPT pixel is integrated with a metasurface optical filter that selectively passes a specific target wavelength, enabling pixel-level spectral tuning across the array. Upon illumination, each HPT generates an electrical current proportional to the intensity of the incident light at its designated wavelength. This current is used to drive a paired MicroLED that emits visible light at a fixed wavelength of 420 nm (for example). The luminance of each MicroLED encodes the intensity of the light detected by its corresponding HPT, thereby enabling photon energy conversion and spectral-to-intensity mapping in the visible domain. An additional array of photodetectors optimized for peak performance at 420 nm (for example) can be co-integrated or paired with the HPT-MicroLED array. This configuration allows the system to function as a reconfigurable imager, converting and relaying spectral information from the 400-1400 nm range into a single visible channel. The resulting device can be read out either optically or electrically, offering capabilities for scene analysis across the visible to near-infrared spectrum in applications such as multispectral imaging, remote sensing, biomedical diagnostics. and low-light surveillance.

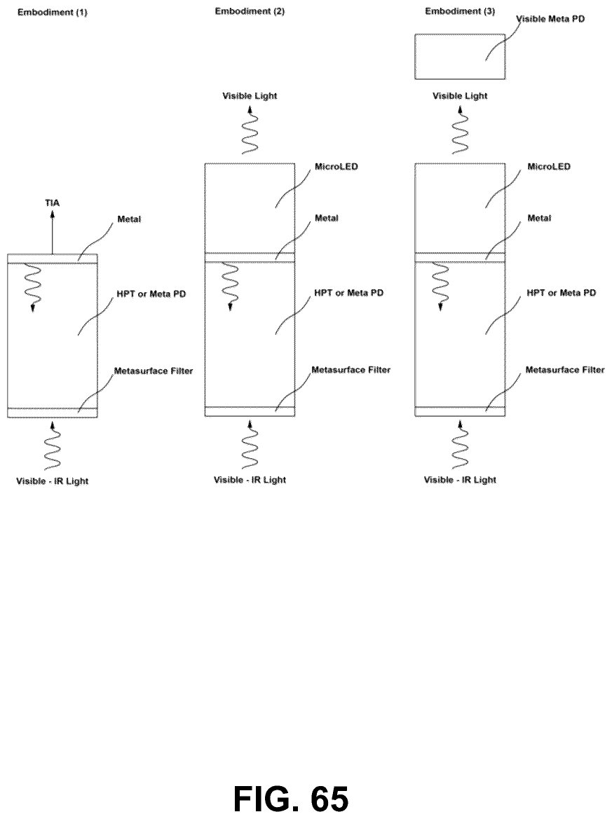

FIG. 65 shows a schematic illustrating to configurations of the proposed pixel element. More details on the HPT structure are given below. Schematic cross section illustrating three embodiments (1) detection of vis-IR light using III-V HPT or Meta photodetector, (2) conversion of IR light into a visible light (up-conversion), and (3) conversion from visible-to-IR light to electrical signal using high performance detector for visible light. One of these embodiments is used to form 2D array imager. Various examples can enable low-cost, high-performance multispectral imaging using non-exotic III-V materials instead of expensive HgCdTe. Various examples can integrate pixel-level spectral tuning via metasurface filters for enhanced spectral resolution. Various examples can convert broadband IR signals into visible light, allowing for efficient optical readout and in-sensor data compression. Various examples can reduce system complexity and power requirements by eliminating the need for cryogenic cooling. Various examples can enhance real-time processing capabilities for UAVs and satellites by shifting spectral data into a single visible channel.

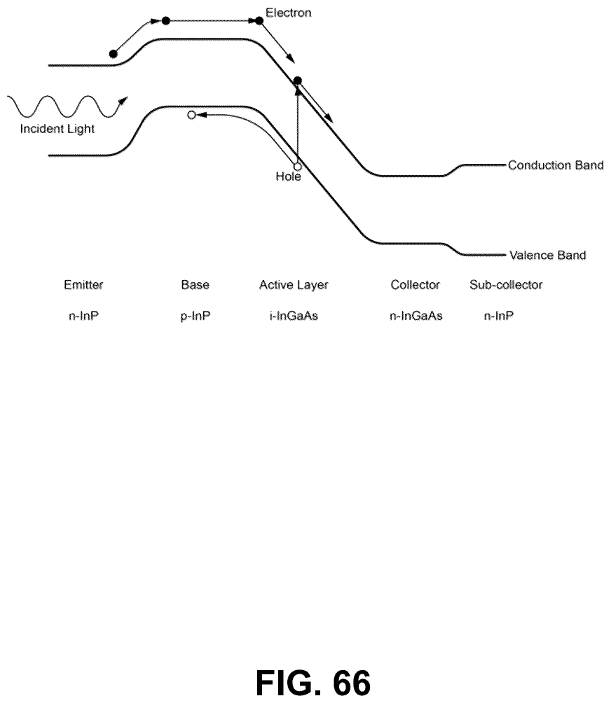

FIG. 66 shows example heterojunction phototransistor structure and the corresponding example current-voltage characteristics under dark and light conditions with different incident light intensities.

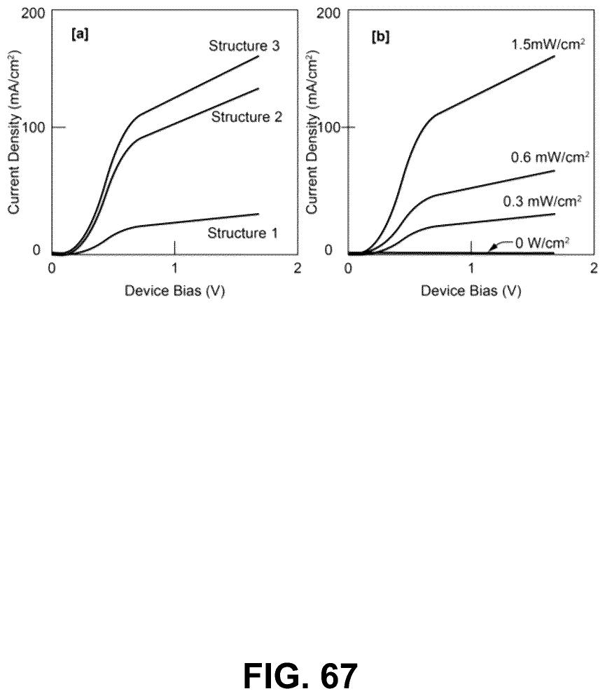

FIG. 67 depicts an illustration of the energy band diagram of an HPT that is sensitive to wavelengths 400 nm to 1400 nm. Light comes through the relatively wide bandgap material (InP) and base, gets absorbed in the i-InGaAs layer (lattice matched with InP), and electrons are collected by the collector layers. Here an NPIN HPT structure is shown. It is possible to construct a PNIP HPT structure. In [a], shown are characteristics for different structures and in [b] shown the effect of the intensity of incident light on the current flowing through the HPT.

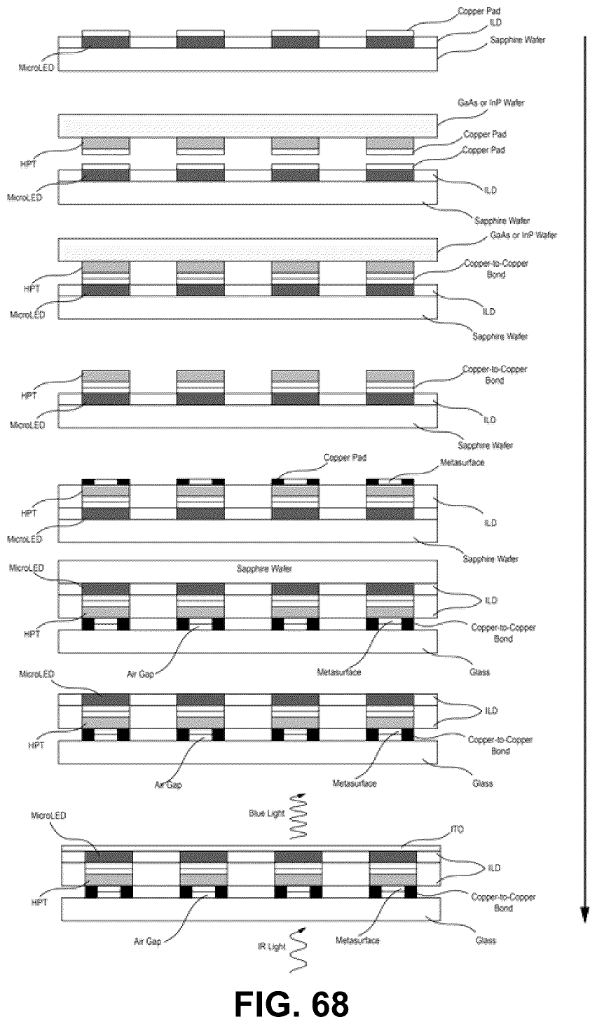

FIG. 68 depicts a process flow for making the structure MicroLED/HPT. Fabrication can commence with manufacturing blue-emitting MicroLEDs on sapphire wafers (e.g., 8″ sapphire wafers). Copper pads can be fabricated on each MicroLED's p-type anode. Separately, PNIP HPTs are fabricated on an InP or GaAs wafer using structures with the p-type collector connected to a copper pad. This copper pad can be used to connect with the copper pad on the MicroLED anode. When the anode of the MicroLED is connected with the collector of the PNIP HPT, current generated by the HPT upon incident light can flow into the MicroLED in the forward direction, resulting in blue light emission. The intensity of this light may depend on the intensity of the original IR light.

Note that the HPT is grown on an InP wafer as follows. Starting with an InP wafer, clean the surface, grow p-type window/emitter, grow the n-type base layer, grow the InGaAs absorber layer, then grow the p-type InGaAs collector and the p-type InP sub-collector. Now the surface exposed on top of the InP wafer is the p-type collector. After alignment and copper-to-copper bonding (e.g., bonding the anode of the MicroLED to the collector of the PNIP HPT), the InP substrate is removed, leaving behind the HPTs bonded to the MicroLEDs. The HPT's window layer (emitter) is now facing up. Metasurface filters are deposited on the window layers of the HPTs with each pixel having a metasurface tuned to pick up a specific wavelength in the range 400 nm to 1400 nm. Then a ring contact is formed to the emitter window layer as shown in FIG. 7. The constructed MicroLED/HPT assemblies are flip-chip transferred onto a glass wafer. The glass will protect the devices from the environment and act as a window for light to be incident on. The free surfaces are cathodes of the MicroLEDs. Blue light emitted through the cathodes can form an image reflecting the intensities from various HPT pixels in response to the incident light.

In the configuration described here the HPT are not intentionally reverse biased, but a reverse bias is developed across the HPT as a result of current continuity.

Various examples include a multispectral imaging device comprising: a two-dimensional array of heterojunction phototransistors (HPTs) configured to detect incident radiation in a spectral range of 400 nm to 1500 nm; a metasurface optical filter associated with each HPT, each filter configured to selectively pass a target wavelength to the corresponding HPT; a MicroLED electronically coupled to each HPT, wherein the MicroLED emits visible light at a fixed wavelength in response to the electrical signal generated by the corresponding HPT; and an optional photodetector array optimized for detecting the emitted visible light from the MicroLEDs.

Various examples include a method for photon-to-photon spectral conversion comprising: detecting light in the 400-1500 nm spectral range using an array of HPTs; filtering incident light at each pixel using a metasurface optical filter configured to pass a target wavelength; generating an electrical signal at each pixel corresponding to the intensity of the filtered light; driving a MicroLED with the electrical signal to emit visible light at a fixed wavelength; and optionally capturing the emitted visible light using a co-integrated or external visible-light detector array. The MicroLED emission is modulated in intensity proportionally to the detected IR or SWIR light intensity. The array is integrated monolithically on a single chip substrate. The metasurface filters are tunable or reconfigurable to allow dynamic control of the target wavelengths.

Each MicroLED emits light at approximately 420 nm. The HPT comprises a III-V semiconductor heterostructure. The metasurface optical filter comprises a patterned nanostructure with subwavelength features for wavelength selectivity. The photodetector array is based on GaN or other materials optimized for visible-light detection. The spectral response of the device enables calculation of vegetation indices including NDVI, NDWI, or NDRE from the visible output. Examples can spatially map the visible emissions to reconstruct a multispectral image of a scene.

Various examples include a spectral imaging system and an optical readout module comprising a CMOS camera tuned to detect visible light emitted by the MicroLEDs. Various examples include edge processing circuitry configured to perform on-chip data compression or feature extraction. The device operates without cryogenic cooling and supports passive ambient operation.

Various examples include a hybrid pixel structure comprising a vertically integrated HPT, metasurface filter, and MicroLED formed in a stacked configuration.

Various examples include a remote sensing platform, comprising: a drone or satellite; and the multispectral imaging mounted on the platform for aerial multispectral imaging.

### Controlled Shared Memory (Cosm)

A network operator can own and manage a physical network infrastructure. Network operators can include telecommunication companies (telcos) that permit devices (e.g., smartphones, cell phones, tablets, personal computers, televisions, radios, or other devices) to access the Internet using wireless communications technologies (e.g., 5G or 5GC) or wired communications technologies. Multiple different network tenants can share hardware resources of the physical network infrastructure, such as processors, memory, accelerators, and other circuitry. However, sharing of resources can introduce security concerns as traffic processed by a tenant may be accessible by another tenant.

As described herein, shared memory devices can be utilized to isolate network functions and data access among different network operators or tenants. Where a tenant or user request quality of service (QOS) or service level agreement (SLA) parameters, various examples described herein can allocate memory and resources (e.g., processors, accelerators, network interface devices, or others) to perform the network functions, and based on real-time telemetry, selectively modify the memory and resource allocation to meet or exceed QoS or SLA parameters. For example, based on QoS and SLA and real-time telemetry, various examples can change the allocated memory, change the allocated processor frequency or number of cores allocated to perform the network slice, change the allocated accelerator frequency or number of accelerators allocated to perform the network slice. Accordingly, various examples can perform dynamic resource reconfiguration based on real-time telemetry to adapt to changing system loads and operational priorities.

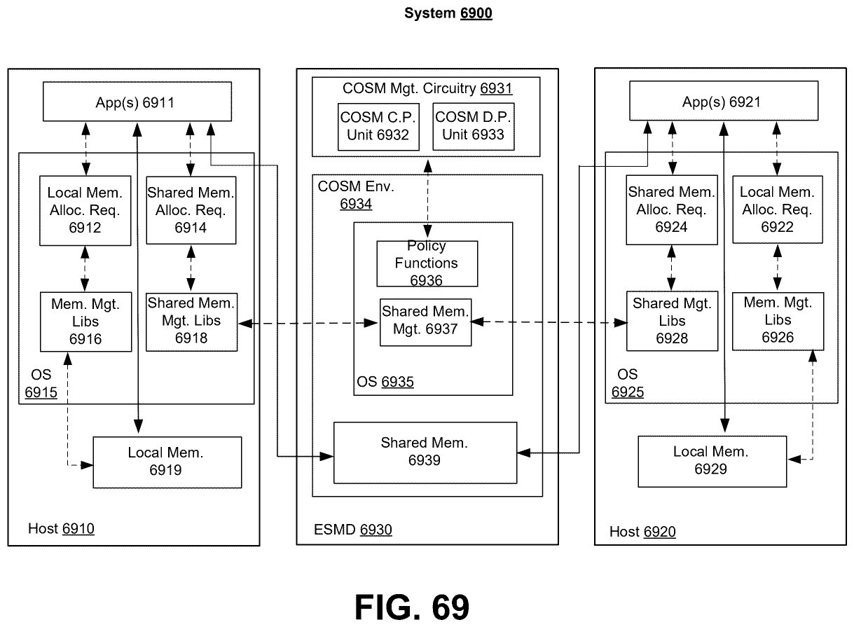

FIG. 69 illustrates an example system 6900. According to some examples, as shown in FIG. 69, system 6900 includes a host 6910, a host 6920 and an externally attached shared memory device (ESMD) 6930. Also as shown in FIG. 69, host 6910 can be configured to host one or more applications (App(s)) 6911, an operating system (OS) 6915 and maintain or include a local memory 6919.

Host 6920 can be similarly configured to host one or more applications 6921, an OS 6925 and maintain or include a local memory (mem.) 6929. In some examples, application(s) 6911 and application(s) 6921 can place a respective local memory (mem.) allocation (alloc.) request (req.) 6912, 6922 to respective OSs 6915, 6925 for use of and/or access to one or more memory regions maintained in respective local memories 6919, 6929. For these examples, OS 6915 and OS 6925 can use their respective memory (mem.) management (mgt.) library (libs.) 6916, 6926 to allocate memory regions maintained in respective local memories 6919, 6929 to allow application(s) 6911 and 6921 to access these respective local memories.

Examples of applications 6911 and 6921 can include one or more of: a microservice, virtual machine (VM), microVM, container, process, thread, or other virtualized execution environment.

According to some examples, as shown in FIG. 69, ESMD 6930 includes controlled shared memory (COSM) management (mgt.) circuitry 6931, an OS 6935 and shared memory 6939. Also as shown in FIG. 69, and described in more detail below, COSM management circuitry 6931 can include a COSM control plane (C.P.) unit 6932 and a COSM data plane (D.P.) unit 6933 that can be arranged or configured to set up and implement/enforce an isolation mechanism for access to one or more shared memory regions maintained in shared memory 6939. A COSM environment (env.) 6934 can be established at ESMD 6930 by COSM management circuitry 6931 that can include OS 6935 implementing policy functions 6936 and shared memory (mem.) management (mgt.) 6937 for access to one or more memory regions maintained in shared memory 6939 based on the isolation mechanism that can include two levels. This two-level mechanism, as will be described more below, can include host-level access control as a first level and data-level inspection and enforcement as a second level. For example, respective application(s) 6911, 6921 can place a respective shared memory allocation request 6914, 6924 to respective OSs 6915, 6925 for use of and/or access to the one or more memory regions maintained in shared memory 6939. OSs 6915, 6925 can be configured to coordinate with shared memory management 6937 via establishment of respective shared memory (mem.) management (mgt.) libraries (libs) 6918, 6928 to enable application(s) 6911 or application(s) 6921 to access one or more memory regions maintained in shared memory 6939 based, at least in part, on policy or rules enforced by policy functions 6936.

As described herein, application(s) 6911 or application(s) 6921 can execute on behalf of a tenant (e.g., network operator) to perform network functions. For example, network functions can perform operations of a Centralized Unit (CU), Distributed Unit (DU), RAN Intelligent Controller (RIC), Access and Mobility Management Function (AMF), User Plane Function (UPF), or other 5G or 5GC network functions or components defined at least in 3^{rd} Generation Partnership (3GPP) Fifth-generation wireless technology (5G) Release 695 (2018), 3GPP NextG Core (5GC) Release 696 (2020), and earlier versions, later versions, and revisions thereof.

For example, ORAN CU can perform processing of protocols, including Service Data Adaption Protocol (SDAP), Packet Data Convergence Protocol (PDCP), and Radio Resource Control (RRC). For example, 5G DU can perform processing of physical layer interface (PHY) resource mapping, beamforming, or fast fourier transform (FFT); media access control (MAC); and Radio Link Control (RLC). For example, 5G RIC can create and deploy processes, including network functions, and analyze network traffic to perform predictive maintenance, anomaly detection, and resource management.

For example, 5GC AMF can manage the connection and mobility of user equipment (UE) within a network. For example, 5GC UPF can manage user data traffic, specifically packet routing, forwarding, and Quality of Service (QOS) handling.

In some examples, application(s) 6911 or application(s) 6921 can execute on behalf of a tenant (e.g., network operator) to perform AI training or inference operations.

In some examples, application(s) 6911 executing on host 6910 can generate training data and request to store the training data into ESMD 6930. Based on a permission level for application(s) 6911, specifically, or a tenant that executes the user application, ESMD 6930 can permit or deny a request to store the training data into a memory device 6939. ESMD 6930 can allow incremental training without requiring multiple copies of the model weights, reducing security risks.

Host 6920 can execute application(s) 6921 and train the AI model based on previously trained weights stored in ESMD 6930 and user generated data also stored in ESMD 6930 and generate updated training weights. Based on a permission level for the AI model, specifically, or a tenant that executes the AI model, ESMD 6930 can permit or deny a request to store the updated training data into COSM memory system. Weights in a neural network can be numerical values associated with the connections between neurons (or nodes) across different layers of the network. A connection from one neuron to another can have an associated weight that signifies the strength and direction (positive or negative) of the influence one neuron has on another. When an input signal passes through the network, the input signal can be multiplied by these weights, which cumulatively determine the final output of the network.

According to some examples, shared memory 6939 can include in-memory compute logic or circuitry (not shown) capable of executing sensitive computations within memory buffers maintained in shared memory 6939. These memory buffers can have a self-destructive capability that automatically erases data associated with the computations executed by the in-memory compute logic or circuitry. This self-destructive capability can prevent persistence of data associated with the computations executed by the in-memory compute logic or circuitry and can prevent or reduce a risk of an unauthorized retrieval of this data.

Local memories 6919, 6929 or shared memory 6939 can include volatile and/or non-volatile types of memory. In some examples, local memories 6919, 6929 or shared memory 6939 can include one or more dual in-line memory modules (DIMMs) that are arranged to include any combination of volatile or non-volatile memory. Volatile memory include memory whose state (and therefore the data stored on it) is indeterminate if power is interrupted to the device. Volatile memory can include a cache. Nonvolatile memory can include memory whose state is determinate even if power is interrupted to the device. Dynamic volatile memory refreshes the data stored in the device to maintain state. According to some examples, as mentioned above, local memories 6919, 6929 or shared memory 6939 can include various types of non-volatile memory.

Although not shown in FIG. 69, host 6910, host 6920 or ESMD 6930 may include additional components that facilitate inter-process communications and use of shared memory 6939. For example, various network and/or internal communication interfaces and associated interconnects can communicatively couple the elements shown in FIG. 69 to each other or to elements on other hosts or ESMDs (not shown in FIG. 69).

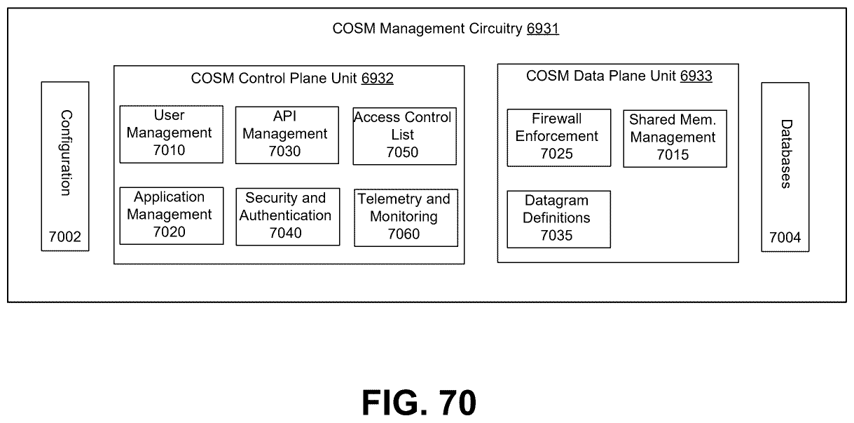

FIG. 70 illustrates example COSM management circuitry 6931. In some examples, FIG. 70 shows example logical modules, configurations or databases that can be implemented by hardware circuitry, firmware, and/or software executed on an ESMD such as ESMD 6930. For these examples, COSM management circuitry 6931 may include a COSM control plane unit 6932 and a COSM data plane unit 6933. The COSM control plane unit 6932 may be responsible for managing the configuration and establishment of memory-based communication channels in ESMD 6930. With a memory-based communication channel configured, COSM data plane unit 6933 may manage operation of the memory-based communication channel following configuration, enforcing isolation policies and providing services to be used in the respective memory-based communication channels based on the configurations.

According to some examples, ESMD 6930 can include two or more input/output (I/O) ports to couple to devices representing different hosts or host domains. A domain can be defined as a set of system resources (e.g., hosts), to which certain users (e.g., operators or tenants) can have prescribed access rights as governed by security policies or service level agreements. COSM control plane unit 6932 can interface with the attached devices to present ESMD 6930 as a memory device (e.g., sharable memory device) accessible by the attached devices via their respective interconnect. For example, interconnects arranged to operate using peripheral component interface express (PCIe) protocols, compute express link (CXL) protocols, Ethernet protocols and/or other type of interconnect protocols.

User management 7010 can be arranged to identify a particular device, operating system, hypervisor, etc. of a host or host domain and determine attributes of the corresponding host and/or host domain, including policies and configurations to be applied for the host and/or host domain. User management 7010 can further identify various applications (e.g., applications, services, processes, virtual machines (VMs), microVMs, or threads) that can run on the host or host domain's OS or hypervisor and that may utilize communication channels implemented by ESMD 6930. Application management 7020 may identify, for the applications of each host and/or host domain, attributes, permissions, policies, and preferences for the applications so as to configure the manner in which individual applications can access and use memory-based communication channels (and their corresponding buffers or memory regions) implemented in ESMD 6930. For instance, one or more buffers or memory regions or memory-based communication channel configured in ESMD 6930 (e.g., maintained in shared memory 6939) to enable communication between two or more host and/or host domain devices can be called upon, in some examples, to be used by multiple, distinct applications of a host and/or host domain, and application management 7020 can configure the memory-based communication channel to establish isolation rules and policies that can govern how or if the applications share the memory-based communication channel, among other example configurations and considerations.

Continuing with the example of FIG. 70, API management 7030 can be provided in some implementations to assist in configuring ESMD 6930 and respective memory-based communication channels configured in ESMD 6930 to interoperate in a system where ESMD 6930 couples through an external switch or another ESMD to one or more host or host domains, with the memory-based communication channel being configured to consider the routing, protocols, and other attributes of the potential one-to-many coupling of ESMD 6930 to potentially multiple distinct host or host domains through a single input/output (I/O) interface of ESMD 6930, among other examples. Security and authentication 7040 can be arranged to define and enforce security and authentication protocols (e.g., at the host, host domain or application level) for the memory-based communication channels, such that specific security features and/or policies are configured for the memory-based communication channels. Further, an access control list 7050 can govern types of allowed or non-allowed accesses to ESMD 6930. For example, enforcing access controls and permissions of the configuration port of an ESMD such as ESMD 6930. Telemetry monitoring can also be managed for memory-based communication channels of specific hosts, host domains and/or applications. For instance, in accordance with QoS guarantees for various domains or applications. Telemetry monitoring access can be controlled using telemetry monitoring manager 7060, among other example modules and logical blocks. For example, telemetry and monitoring 7060 can provide telemetry data indicative of utilization of memory (e.g., memory bandwidth, memory addresses accessed, or others) and/or utilization of compute resources (e.g., accelerator or processor utilization or busyness, or others). The busyness level can represent a number of cycles consumed by instructions and the software application executed on a particular core and exclude polling for work to perform. Other examples of levels of busyness can include quantized levels of utilization from not utilized (e.g., 0) to fully utilized (e.g., 5), average utilization over a timespan, or others.

COSM management circuitry 6931 of an example ESMD such as ESMD 6930 can additionally include COSM data plane unit 6933 to govern the operation of various memory-based communication channels (and corresponding buffers or memory regions) configured in the shared memory maintained at ESMD 6930 (e.g., shared memory 6939) in accordance with configurations 7002. Configurations 7002, for example, can be set or implemented using COSM control plane unit 6932. Individual buffers, memory regions and memory-based communication channels can have respective functionality, rules, protocols, and policies defined for the channel, and these channel or buffer definitions may be recorded within database 7004. The COSM data plane unit 6933 may include, for instance, shared memory management 7015 to identify one or more portions of shared memory (e.g., buffers or memory regions) and associated in-memory compute logic or circuitry maintained at ESMD 6930 to allocate for a specific memory-based communication channel and define pointers to provide to the host or host domain devices that are to communicate over the memory-based communication channel to enable the devices' access to the memory-based communication channel. Shared memory management 7015 can leverage these pointers to effectively “turn off” or at least limit a device's or application's access and use of the memory-based communication channel by retiring the pointer, disabling the device's ability to write data on the buffer (to send data on the memory-based communication channel) or read data from a buffer (to receive/retrieve data on the memory-based communication channel), among other example functions.

Other security and data filtering functions may be available for use in a memory-based communication channel, based on the configuration and/or policies applied to the memory-based communication channel, such as firewalling by firewall enforcement 7025 (e.g., to enforce policies that limit certain data from being written to or read from a buffer or memory region) or data filtering (e.g., at the field level) associated with datagram definitions 7035.

Datagram definition 7035 can be based on a data format of data written to or read from the memory-based communication channel (e.g., based on a protocol or other datagram format (including proprietary data formats) defined for the memory-based communication channel), to identify the presence of certain sensitive data to filter or redact such data and effectively protect such information from passing over the memory-based communication channel (e.g., from a more secure or higher trust domain to a less secure or lower trust domain), among other examples.

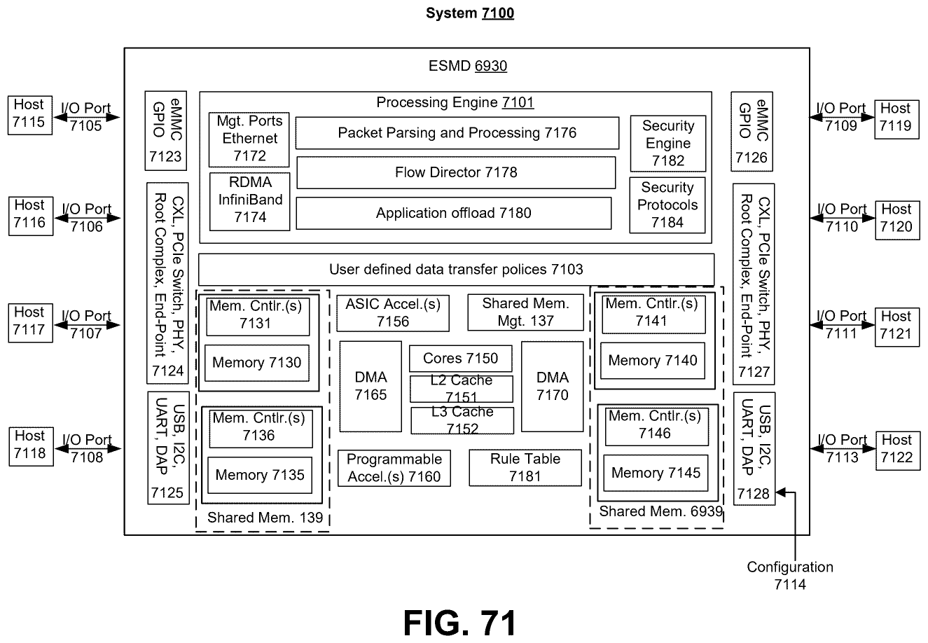

FIG. 71 illustrates an example system 7100. According to some examples, as shown in FIG. 71, system 7100 includes ESMD 6930 coupled with a different set of hosts 7113-7122 through separate I/O ports 7105-7113. Hosts 7115-7122 can be associated with two or more different domains (e.g., domains of different ownership, trust levels, security features or permissions, etc.). Different interconnect protocols may be supported by the various I/O ports 7105-7113 of ESMD 6930 (such as PCIe, CXL, Ethernet, ultra path interconnect (UPI), universal chiplet interconnect express (UCIe), NVLink, embedded multi-media controller (eMMC), general purpose I/O (GIPO), universal serial bus (USB), inter-integrated circuit (I2C), universal asynchronous receiver transmitter (UART), debug adaptor protocol (DA), etc.) and corresponding protocol logic (e.g., 7123-7124) may be provided on ESMD 6930 to enable ESMD 6930 to connect to, train, and communicate with the hosts 7115-7122 over corresponding links.

In some examples, one of the ports from among I/O ports 7105-7113 or an additional I/O port can be provided as a configuration channel 7114, to enable a user or system to interface with ESMD 6930 and configure functionality of the ESMD 6930, define configurations for connections and communication with ESMD 6930 (e.g., by hosts 7115-7122), define policies and rules that may be applied to memory-based communication channels implemented on ESMD 6930, configure cross-domain and/or shared memory services provided by or through the hardware, firmware, and/or software executed on the ESMD 6930, among other example features.

According to some examples, as mentioned briefly above for FIG. 69, ESMD 6930 can also include shared memory 6939. Shared memory 6939 can include one or more memory elements (e.g., memory 7130, 7135, 7140, 7145), at least a portion of which can be offered as shared memory and implement buffers or memory regions through which two-level isolation schemes can be applied to implement memory-based communication channels between applications or processes hosted by two or more hosts (e.g., 7115-7123) or by a same host through an exchange of data over or through one or more shared buffers or memory regions. Portions of memory 7130, 7135, 7140, 7145 arranged to maintain memory regions or buffers designated for use as shared memory may be presented by ESMD 6930 to hosts 7115-7122 as shared memory (e.g., using semantics of the corresponding interconnect protocol through which the host device connects to ESMD 6930). Shared memory management 6937 of ESMD 6930 can be arranged to coordinate access to the shared memory by hosts 7115-7122 in cooperation with corresponding memory controllers 7131, 7136, 7141, 7146. That coordinated access can include performance of read or write memory operations on respective memory elements memory 7130, 7135, 7140, 7145. Also, in-memory compute logic or circuitry (not shown) can be integrated into one or more memory elements 7130, 7135, 7140 or 7145 to execute workloads involving sensitive data and use of one or more self-destructive buffers included in these one or more memory elements to ensure data persistence is minimized for that sensitive data. ESMD 6930 can further include direct memory access (DMA) engines 7165 or 7170 to enable direct memory access (e.g., DMA reads and writes) by hosts 7115-7122) coupled to ESMD 6930 and utilizing one or more memory regions or buffers of shared memory 6939 for memory-based communication channels.

In-memory compute circuitry can perform at least one or more of: summation of packet data with other packet data from other workers, multiplication, division, minimum, maximum, or other data computation operations related to reduce, AllReduce, ReduceScatter, or AllGather. Reduce can reduce the elements of an array into a single result. AllReduce can include collecting data from different processing units and combining the data into a result. ReduceScatter can reduce input values across ranks, with each rank receiving a subpart of the result. AllGather can aggregate A values into an output of dimension A*B, where B is an integer.

A packet may be used herein to refer to various formatted collections of bits that may be sent across a network, such as Ethernet frames, Internet Protocol (IP) packets, TCP segments, UDP datagrams, etc. A flow can be a sequence of packets being transferred between two endpoints, generally representing a single session using a known protocol. Accordingly, a flow can be identified by a set of defined tuples or header field values and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

In some examples, one or more central processing unit (CPU) processor cores 7150 can be provided on ESMD 6930 to execute instructions and processes to implement the memory-based communication channel via use of one or more memory regions or buffers maintained in shared memory 6939 in order to provide various cross domain services in connection with these one or more memory regions or buffers. The various cross domain service can be based on a respective configuration, isolation rules, and/or isolation policies defined for the one or more memory regions or buffers). The isolation rules and/or isolation policies can be maintained, for example, in rule table 7181 at ESMD 6930.

A cache hierarchy that includes level-2 (L2) cache 7151 and level-3 (L3) cache 7152 can be provided, and cores 7150 can be arranged to interoperate with other processing/compute elements provided on the ESMD 6930 such as one or more application specific integrated circuit (ASIC) accelerators (accel. (s)) 7156 (e.g., cryptographic accelerators, error correction and detection accelerators, etc.) and various programmable hardware accelerators 7160 (e.g., graphics accelerators (e.g., GPU), networking accelerators, machine learning accelerators, matrix arithmetic accelerators, field programmable gate array (FPGA)-based accelerators, etc.). In addition to in-memory compute logic/circuitry being included in at least some memory elements of shared memory 6939, specialized processing functionality and acceleration capabilities (e.g., provided by ASIC accelerator(s) 7156 or programmable accelerator(s) 7160, etc.) can be leveraged to support memory-based communication channels provided through sharing one or more memory regions or buffers maintained in shared memory 6939 of ESMD 6930, based on configurations and rules defined for the memory-based communication channel (e.g., maintained in rule table 7180).

According to some examples, logic and/or features can be provided on ESMD 6930 to implement various cross domain services in connection with a memory-based communication channel established between hosts 7115-7122 via use of one or more memory regions or buffers maintained in shared memory 6939. Such logic and/or features can be implemented in hardware circuitry (e.g., of accelerator devices (e.g., 7156, 7160), functional IP blocks, etc.), firmware or software (e.g., executed by cores 7150). For these examples, functional cross domain service modules can thereby be implemented, such as modules that assist in emulating particular protocols, corresponding packet processing, and protocol features in a given memory-based communication channel (e.g., providing Ethernet-specific features (e.g., Dynamic Host Configuration Protocol (DHCP)), etc.) using an Ethernet port management module (e.g., 7172), or remote DMA (RDMA) and InfiniBand features using an RDMA and/or InfiniBand module (e.g., 7174). Various packet parsing and processing may be performed at ESMD 6930 using, for example, packet parsing and processing 7176, for instance, to parse packets written to a memory-based communication channel shared memory region or buffer and performing additional services on the packet to modify the packet or prepare the packet for reading by another host or device coupled to the memory-based communication channel shared memory region or buffer. Application management tasks may also be performed, including routing tasks (e.g., using a flow director 7178) to influence the manner in which data communicated over a memory-based communication channel shared memory region or buffer is consumed and routed by the host or host domain receiving the data (e.g., specifying a process, core, virtual machine (VM), etc. at the host that should handle further processing of the data (e.g., based on packet inspection performed at ESMD 6930), among other examples. Application offload 7180 can be used to leverage information concerning a network connection of one of the hosts coupled to ESMD 6930 to cause data read by the host to be forwarded in a particular manner on a network interface controller or other network element on the device (e.g., to further forward the data communicated over ESMD 6930 supported memory-based communication channel to other hosts over the network). In other examples, ESMD 6930 can perform various security services on data written and/or read from a memory-based communication channel shared memory region or buffer implemented on ESMD 6930, for instance, applying custom or pre-defined security policies or tasks (e.g., using a security engine 7182), applying particular security protocols to the communications carried over/through the memory-based communication channel shared memory region or buffer (e.g., IPSec using security protocols 7184), among other example cross domain services and functionality.

According to some examples, an Internet Protocol (IP) network can be at least partially replaced using one or more (or a network of) ESMDs. For these examples, ESMDs such as ESMD 6930 can be utilized to implement cross-domain collaboration that allows information sharing to become more intent-centric. For instance, one or more applications executed in a first domain at a first host and the transactions required for communications with other applications of a different domain at the first host or a second host can be first verified for authenticity, security, or other attributes (e.g., based on an application's or domain's requirements), thereby enforcing implicit security. Memory-based communication can also offer a more reliable data transfer and simpler protocol operations for retransmissions and data tracking (e.g., than a more conventional data transfer over a network or interconnect link (which may be emulated by the memory-based communication). Through such simpler operations, ESMDs solutions can offer high-performance communication techniques between interconnecting domain-specific computing environments. Further, memory interfaces in an ESMD can be enforced with access controls and policies for secure operations, such as implementing a permission matrix scheme that can include a type of data-diode which cause memory-based communication channels to operate in a unidirectional fashion with permission-based access controls, such as write-only access, read-only access, and read/write access to access one or more memory-based communication channel shared memory regions or buffers. In other instances, a memory-based communication interface maintained by the ESMD can enable bi-directional communication between different hosts or different host domains. In some examples, separate memory regions or buffers can be used to facilitate each direction of communication (e.g., one memory region/buffer for communication from host A to host B and another memory region/buffer for communication from host B to host A). In such cases, different policies, cross domain services, and even protocols can be applied to each memory region/buffer, based on the disparate characteristics and requirements of the different hosts or host domains, among other example implementations. Generally, these memory-based communication interfaces can be a standard implementation and can also be open-sourced for easier use, community adoption, and public participation in technology contributions without compromising the security and isolation properties of the data transactions. The open implementation also provides transparency of communication procedures over open interfaces to identify any security vulnerabilities.

An ESMD can enable support for application-defined communication protocols over open interface definitions (and open implementation), allowing customized communication solutions, which are wholly independent of or at least partially based on (and emulate) interconnect protocols. For instance, application-defined communication protocols may enable applications to create their own datagram format, segmentation, encryption, and flow control mechanisms that are decoupled from the protocols used in the ESMD memory-based communication channel interfaces (connecting the ESMD to hosts).

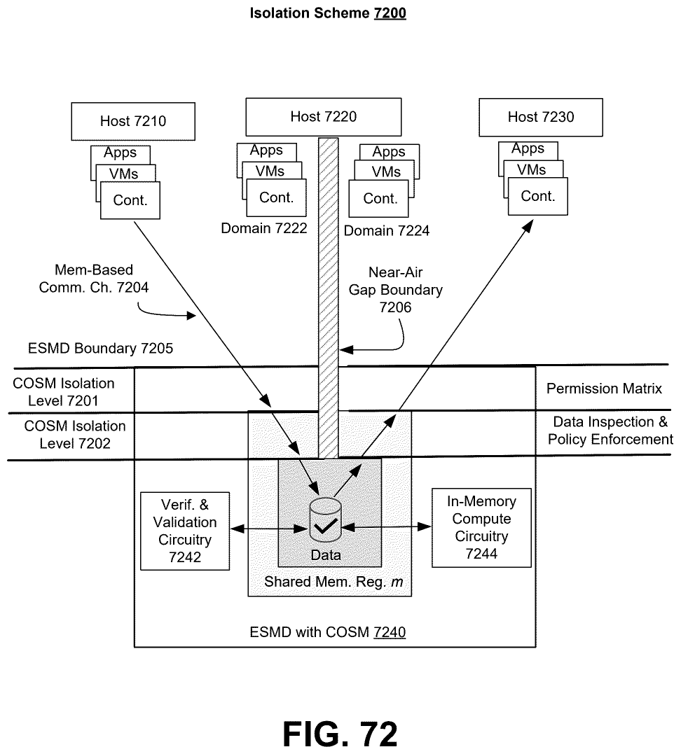

FIG. 72 illustrates an example isolation scheme 7200. In some examples, hosts 7210, 7220 or 7230 may be arranged to share access to a shared memory region m maintained at an ESMD with COSM 7240. Although not shown in FIG. 72, ESMD with COSM 7240 can be configured and/or include similar COSM management circuitry as shown in FIG. 70 for COSM management circuitry 6931 and similar functional hardware and logic/features as shown in FIG. 71 for ESMD 6930. For these examples, isolation scheme 7200 can include establishment of a memory-based communication channel 7204 to enable applications, VMs or containers (conts.) hosted by host 7210 and host 7230 to read and/or write data to shared memory region m based, at least in part, on a first COSM isolation level 7201 and a second COSM isolation level 7202.

In some examples, as shown in FIG. 72, ESMD with COSM 7240 can also include verification (Verif.) and validation circuitry 7242 and in-memory compute circuitry 7244. Verification and validation circuitry 7242 and in-memory compute circuitry 7244 can be integrated or embedded within memory elements that maintain or include shared memory region m. In some examples, for in-memory compute operations, shared memory region m can operate according to an in-memory compute technology. The in-memory compute technology can also be based on analog computations or digital computations for in-memory compute operations. In some examples, verification and validation circuitry 7242 can be included in COSM management circuitry (e.g., as part of COSM data plane unit) and in-memory compute circuitry 7244 can be integrated or embedded within memory elements that maintain or include shared memory region m. For either of these examples, sensitive workloads can be executed directly within shared memory region m and shared memory region m can be arranged to implement buffer destruction mechanisms to cause data associated with execution of the sensitive workloads to be automatically erased after verification & validation circuitry 7242 has validated post-execution computations of the sensitive workloads by in-memory compute circuitry 7244. Verification and validation can include use of error correction codes such as parity bits or cyclic redundancy check (CRC) to determine if calculated results have errors (e.g., caused by bit flips during in-memory compute operations). The sensitive workloads, for example, can be required by applications, VMs or containers hosted by host 7210, 7220 or 7230 and computations performed by in-memory compute circuitry can include, but are not limited to, encryption computations, data integrity checker computations (e.g., checksum or cyclic redundancy check (CRC)), or decryption computations. Packet traffic data (e.g., header and/or payload) and can be encrypted and stored in COSM 7240. Packet traffic data (e.g., header and/or payload) and can be decrypted after being read from COSM 7240.

According to some examples, COSM isolation level 7201 can be based on a permission matrix scheme that can be arranged to either permit or block applications, VMs or containers hosted by host 7210 or host 7230 to read/or write data to shared memory region m. For example, the permission matrix can permit applications, VMs or containers hosted by host 7210 to conduct at least write operations to shared memory region m and permit applications, VMs or containers hosted by host 7230 to conduct at least read operations to shared memory region m. COS isolation level 7201 can be implemented at ESMD boundary 7205 to allow or block write operations from host 7210 or read operations from host 7230.

In some examples, COSM isolation level 7202 can be based on data inspection and policy enforcement associated with data to be written to or read from shared memory region m. Data inspection and policy enforcement can include inspecting each data transaction (e.g., memory write or read operation) to shared memory region m before that data transaction is processed. For example, policies can be enforced that can include, but are not limited to, verifying a data format and security associated with the data transaction (e.g., ensuring encrypted payloads, structured database records, compliance with industry regulations) and allowing the data transaction if compliant to the policies or taking policy-based actions if the data transaction is not compliant to the policies. Policy-based actions can include, but are not limited to, modifying, deleting, blocking, or generating a notification to a management entity (e.g., a system management orchestrator) to indicate that a non-compliant data transaction was detected for accessing shared memory region m.

According to some examples, a second memory-based communication channel (not shown) similar to memory-based communication channel 7204 can be established between two domains 7222 and 7224 hosted by host 7220. For these examples, the second memory-based communication channel can be subject to the same two-level isolation scheme that creates a near-air gap boundary 7206 between applications, VMs and containers included in domain 7222 and applications, VMs and containers included in domain 7224. The near-air gap boundary 7206 is shown in FIG. 72 to indicate that a two-level isolation scheme such as example isolation scheme 7200 can emulate an air-gap (physical isolation) of shared memory region m when shared between two domains or shared between two hosts hosting respective domains.

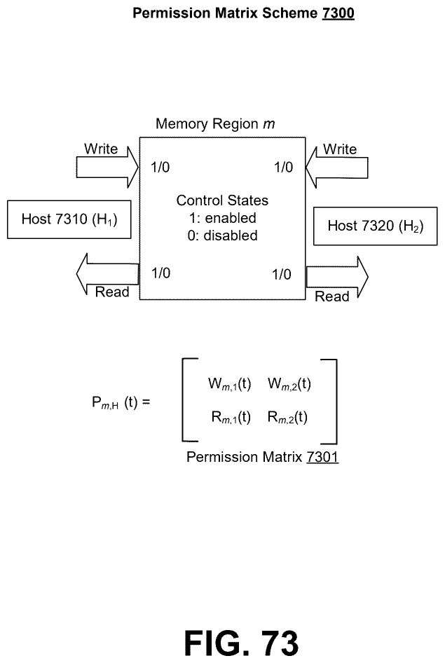

FIG. 73 illustrates an example permission matrix scheme 7300. According to some examples, example permission matrix scheme 7300 can represent a portion of a controlled shared memory (COSM) framework implemented at an ESMD. For these examples, permission matrix scheme 7300 includes use of permission matrix 7301 for fine-grained filtering and control at the granularity of individual hosts that are shown in FIG. 73 as host 7310 and host 7320 and at the granularity of an individual memory region shown in FIG. 73 as memory region 7339. Memory region 7339, for example, is maintained at the ESMD and is arranged to be shared by host 7310 and host 7320. For example permission matrix 7301, “Pₘ” indicates that this is a permission matrix for shared memory region m and “H” denotes a set of distinct hosts {H₁, H₂, . . . , Hₙ, . . . , H_{N}} that can participate in permission matrix scheme 7300 and “m” denotes a set of distinct (non-overlapping) memory regions [M₁, M₂, . . . , Mₘ, . . . , M_{M}]. A given memory region Mₘ can be characterized by a memory address of the start of memory region Mₘ and a memory address of the end of memory region Mₘ.

In some examples, memory region 7339 can represent a given memory region Mₘ, and host 7310 can represent a given host H₁ and host 7320 can represent a second given host H₂. For these examples, host 7310 and host 7320 can be configured for sharing memory region 7339 based on an underlying memory technology or standard (e.g., CXL). Both host 7310 and host 7320 can have two degrees of freedom for sharing memory region 7339: write permission and read permission, which may change with time t. The variable “t” indicates a type of time-dependent control of shared memory region 7339. For example permission matrix 7301, if W_{m,1}(t)=1, host 7310 (H₁) is permitted to write data to memory region 7339 (m) at time t and if W_{m,1}(t)=0, host 7310 (H₁) is blocked or prohibited from writing data to memory region 7339 (m) at time t. Also, if R_{m,1}(t)=1, host 7310 (H₁) is permitted to read data from memory region 7339 (m) at time t and if R_{m,1}(t)=0, host 7310 (H₁) is blocked or prohibited from writing data to memory region 7339 (m) at time t. Similarly, if W_{m,2}(t)=1, host 7320 (H₂) is permitted to write data to memory region 7339 (m) at time t and if W_{m,2}(t)=0, host 7320 (H₂) is blocked or prohibited from writing data to memory region 7339 (m) at time t. Also, if R_{m,2}(t)=1, host 7320 (H₂) is permitted to read data from memory region 7339 (m) at time t and if R_{m,2}(t)=0, host 7320 (H₁) is blocked or prohibited from writing data to memory region 7339 (m) at time t.

According to some examples, permission matrix 7301 can be used as a mechanism to ensure that hosts 7310 or 7320 can access shared memory region 7339 with tailored read/write permissions. For example, shared memory region 7339 may be a critical shared memory region and host 7310 may need to perform real-time updates to data maintained in shared memory region 7339 to perform real-time updates and thus may have write access to shared memory region 7339, while other hosts such as host 7320 are restricted to read-only permissions to prevent accidental overwrites or data corruption. This type of fine-granular control enables precise enforcement of access policies, minimizing risks of unauthorized data manipulation or accidental interference in multi-host environments.

In some examples, permission matrix 7301 can allow for a type of permission matrix filtering that facilitates dynamic and context-aware memory management. For example, an ESMD such as ESMD 6930 can be configured to update permissions on the fly based on an operational state of a system or based on application requirements. Updated permissions can include granting temporary write access to a host for a specific task and then revoking the permission once the task is complete. This type of flexibility can be important in scenarios involving hierarchical or distributed memory allocation, where different hosts or processes may have varying levels of privilege. By enabling a fine-granular level of control, the ESMD can improve both security and performance by allowing shared memory that can be utilized efficiently without compromising the integrity of data or system operations.

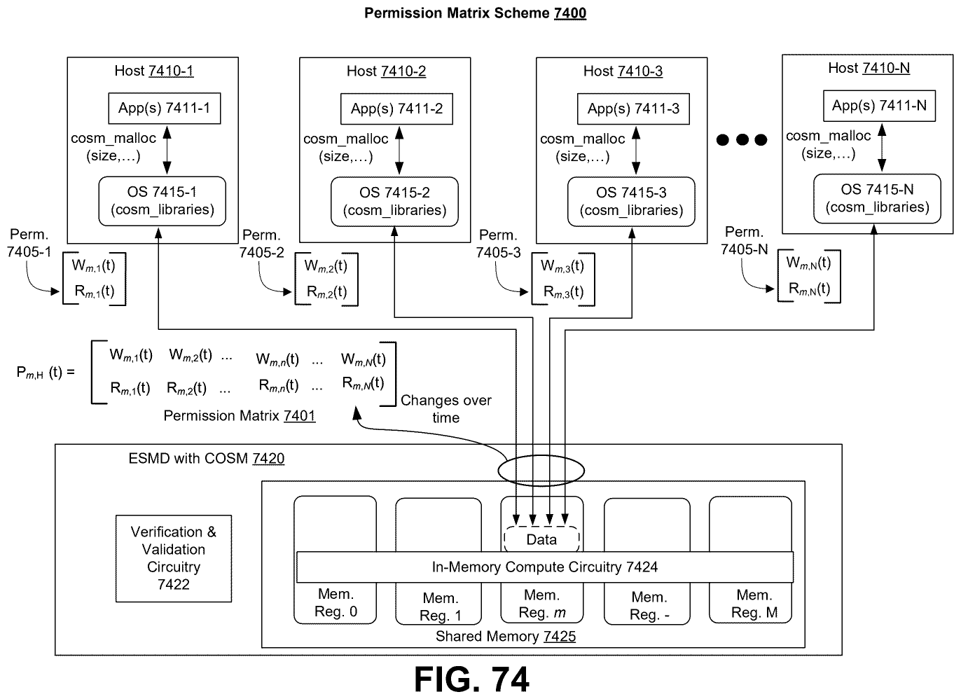

FIG. 74 illustrates an example permission matrix scheme 7400. According to some examples, permission matrix scheme 7400 shows use of a permission matrix 7401 to control access by applications 7411-1 to 7411-N hosted by Hosts 7410-1 to 7410N to data maintained in shared memory region (mem. reg.) m maintained at ESMD with COSM 7420. Although not shown in FIG. 74, ESMD with COSM 7420 can be configured to include similar COSM management circuitry as shown in FIG. 70 for COSM management circuitry 74931 and similar functional hardware and logic/features as shown in FIG. 71 for ESMD 74930. For these examples, the variables of permission matrix 7401 can be used in a similar manner as mentioned above for permission matrix 7301 to indicate write or read permissions of hosts 7410-1 to 7410-N at time t. The individual permissions included in permission matrix 7401 are shown in FIG. 74 as permissions 7405-1 to 7405-N.

In some examples, logic and/or features of COSM management circuitry for ESMD with COSM 7420 (e.g., control plane unit of COSM management circuitry) can moderate access control to memory region m maintained in memory 7425 by setting permissions for each host from among hosts 7410-1 to 7410-N through permission matrix 7401. For these examples, once permissions to access memory region m are completed, applications 7411-1 to 7411-N can use library functions (cosm_libraries) maintained by respective OSs 7415-1 to 7415-N to place memory allocation requests (cosm_malloc size, . . . ) to allocate memory addresses and to access those allocated memory addresses via read or write operations.

According to some examples, as shown in FIG. 74, shared memory 7425 includes in-memory compute circuitry 7424. In-memory compute circuitry 7424 can be capable of executing sensitive computations within memory buffers maintained in at least a portion of the memory regions maintained in shared memory 7425. Similar to the memory buffers mentioned above for FIG. 72, these memory buffers can have a self-destructive capability that automatically erases data associated with the computations executed by the in-memory compute circuitry 7424. This self-destructive capability can prevent persistence of data associated with the computations executed by in-memory compute circuitry 7424 and can prevent or reduce a risk of an unauthorized retrieval of this data. Also, prior to implementation of buffer destruction mechanisms to cause data associated with execution of the sensitive workloads to be automatically erased, verification & validation circuitry 7422 can be configured to validate post-execution computations of the sensitive workloads by in-memory compute circuitry 7424.

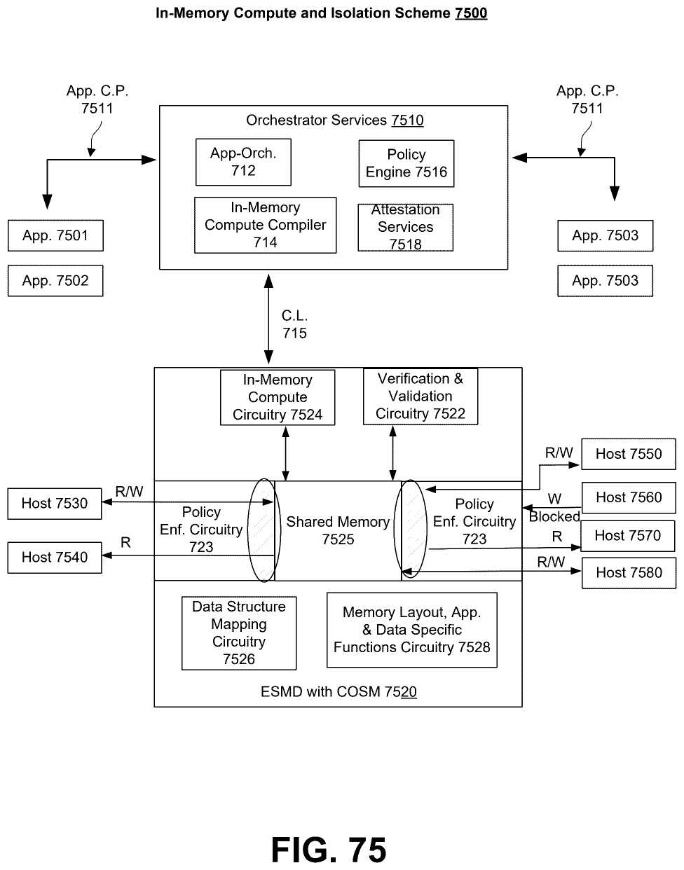

FIG. 75 illustrates an example in-memory compute and isolation scheme 7500. In some examples, as shown in FIG. 75, in-memory compute and isolation scheme 7500 can include orchestrator services 7510 communicatively coupled with applications 7501, 7502, 7503 and 7505 through an application (App.) control plane (C.P.) 7511 and communicatively coupled with ESMD with COSM 7520 through communication link (C.L.) 7515. Although not shown in FIG. 75, ESMD with COSM 7520 can be configured to include similar COSM management circuitry as shown in FIG. 70 for COSM management circuitry 6931 and similar functional hardware and logic/features as shown in FIG. 71 for ESMD 6930.

According to some examples, as shown in FIG. 75, orchestrator services 7510 can include an application-orchestrator (App-Orch.) 7512, a policy engine 7516, an in-memory compute compiler 7514, or attestation services 7518. For these examples, application-orchestrator 7512 can be configured to communicate with applications 7501, 7502, 7503 or 7505 via application control plane 7511 to receive in-memory compute requests that include in-memory computations at shared memory 7525 maintained at ESMD with COSM 7520. Policy engine 7516 and/or attestation services 7518 can be configured to determine whether a particular application is authorized to request in-memory compute for shared memory 7525. If authorized, in-memory compute compiler 7514 can be capable of causing in-memory compute circuitry 7524 to be configured for in-memory computations based on respectively authorized in-memory compute requests from applications 7501, 7502, 7503 or 7505.

Configuration of in-memory compute circuitry 7524 can also include allocating secure memory buffers included in shared memory 7525. Secure memory buffers can at least temporarily store data associated with in-memory compute computations executed by in-memory compute circuitry 7524 responsive to authorized in-memory compute requests. According to some examples, this collaboration between ESMD with COSM 7520 and orchestrator services 7510 for configuring in-memory compute circuitry 7525 and shared memory 7525 can enforce dynamic, real-time memory access and in-memory compute operations that can protect sensitive data associated with execution of security-sensitive workloads in a multi-tenant infrastructure. This type of dynamic collaboration can be used for multi-tenant environments such as open radio access networks (O-RAN), cloud computing, or industrial automation. For example, radio intelligent controller (RIC) and security management operations (SMOs) can be able to dynamically adapt memory access or in-memory compute enforcement policies based on workload demand.

In some examples, a data structure mapping circuitry 7526 maintained at ESMD with COSM 7520 can be configured to assist with the mapping of shared memory regions of shared memory 7525 to hosts 7530, 7540, 7550, 7560, 7570, or 7580 in a similar manner as described above for data transfer scheme 7500. Also, memory layout, application (App.) & data specific functions circuitry 7528 can be configured to assist with the memory layout of the shared memory regions of shared memory 7525 to facilitate use of shared memory 7525 for workloads associated with authorized in-memory compute requests to be executed by in-memory compute circuitry 7524. This facilitation can include setting up memory buffers in shared memory 7525 to have self-destructive capabilities that automatically erases data associated with the computations executed by in-memory compute circuitry 7524. Also, prior to implementation of buffer destruction mechanisms to cause data associated with execution of the sensitive workloads to be automatically erased, verification & validation circuitry 7522 can be configured to validate post-execution computations of the sensitive workloads by in-memory compute circuitry 7524. In some examples, data structure mapping circuitry 7526 and memory layout, application & data specific functions circuitry 7528 can be included in COSM management circuitry (e.g., part of a COSM data plane unit) of ESMD with COSM 7520.

According to some examples, ESMD with COSM 7520 can also include policy enforcement (Enf.) circuitry 7523. Policy enforcement circuitry 7523 can be configured to implement a similar two-level isolation scheme as described above for isolation scheme 75200 that includes use of a first level of isolation that uses a permission matrix similar to permission matrix 601 shown in FIG. 6. Also as described above, the similar two-level isolation scheme can include a second level of isolation that includes data inspection and policy enforcement as mentioned for an isolation scheme. For example, as shown in FIG. 75, the end point arrow heads between shared memory 7525 and hosts 7530, 7540, 7550, 7560, 7570 or 7580 can indicate what permissions are allowed for a particular host. For this example, hosts 7530, 7550 and 7580 have arrow heads on both end points to indicate permission for read and write memory transactions to shared memory 7525. Arrow heads on the end point on only the host side for hosts 7540 and 7570 indicates permission for only read memory transactions to shared memory 7525. Also, a blocked write request from host 7560 is shown in FIG. 75 as being at the ESMD with COSM 7520 boundary to indicate that host 7560 does not have write access permission to shared memory 7525.

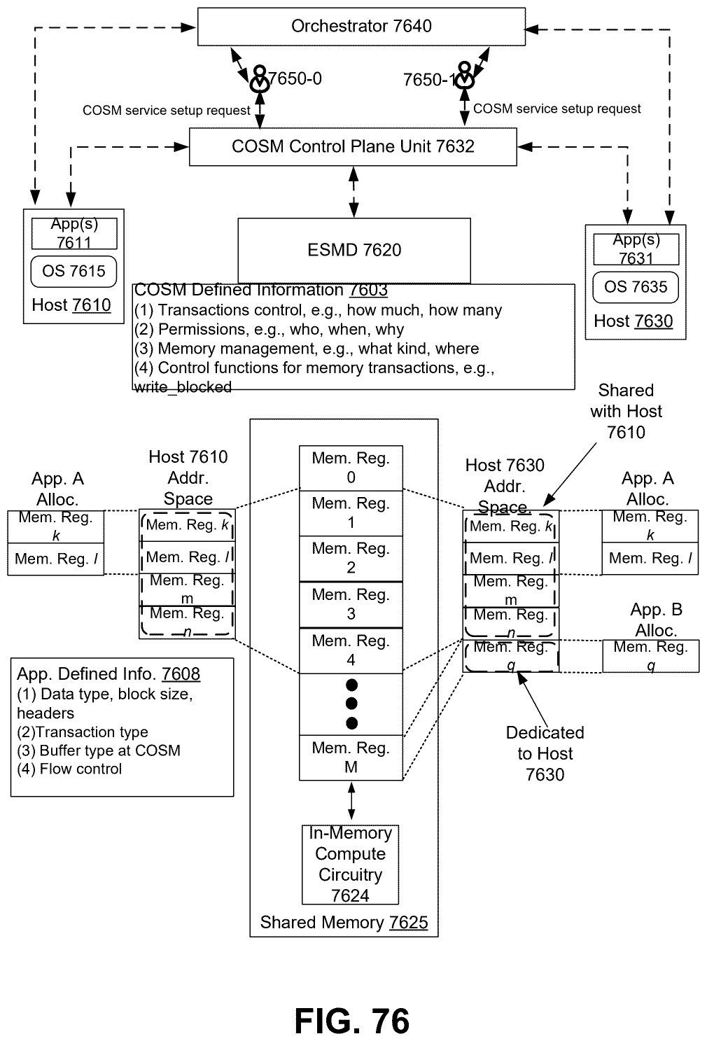

FIG. 76 depicts an example system. In some examples, as shown in FIG. 76, data transfer scheme includes a COSM control plane unit 7632 in communication with an ESMD 7620 and in communication with hosts 7610 and 7620. For these examples, although not shown in FIG. 76A, COSM control plane unit 7632 can be configured to include similar logic and/or features included in COSM control plane unit 6932 of COSM management circuitry 6931 described above for and shown in FIG. 70. Also, ESMD 7620 can include similar functional hardware and logic/features described above for and shown in FIG. 71.

According to some examples, data transfer scheme 7600 can illustrate a general approach for an end-to-end data transfer between applications hosted by hosts 7610 and 7620 via a memory-based communication channel established through shared memory regions of a shared memory maintained at ESMD 7620. For example, COSM defined information 7603 indicates: (1) transactions control; (2) permissions; (3) memory management; and (4) control functions for memory transactions for this established memory-based communication channel. Item (1) related to transaction control can be related to data inspection and policy enforcement that may be implemented in a similar manner as mentioned above for isolation scheme 7200 (COSM isolation level 7202). Item (2) related to permissions may be implemented in a similar manner as mentioned above for isolation scheme 7200 (COSM isolation level 7201) and for permission matrix scheme 7300. Item (3) related to memory management can result in host 7610 sharing memory regions 1-4 with host 7620 and also can result in host 7620 having exclusive access to memory region M. Item (4) related to control functions for memory transactions can also be related to data inspection and policy enforcement implemented in a similar manner as mentioned above for isolation scheme 7200 (COSM isolation level 7202).

In some examples, hosts 7610 and 7620 can allocate their respective address space that map to shared memory regions 1-4 to applications included in application(s) 7611 and 7613. For example, host 7610 and host 7630 address spaces that include memory regions k, l, m, n are mapped to shared memory regions 1-4. Also, host 7630's address space q is shown in FIG. 76 as mapping to memory region M that is not shared between hosts 7610 and 7630. Application A of host 7610 can request and receive an allocation of memory region k and 1 that maps to shared memory region 1 and 70. Similarly, application A of host 7630 can request and receive an allocation of memory region k and 1 that also maps to shared memory regions 1 and 2. Also, application B of host 7630 can request and receive an allocation of memory region q that maps to memory region M.

According to some examples, data transfers through shared memory regions 1-4 can be conducted with user defined protocol data units (UPDUs). For these examples, applications can determine a data structure to be used for sharing over shared memory regions 0-4. This can allow applications to create UPDUs over the shared memory, whereby applications can define data block specifications, such as data type, block size, and headers. As shown in FIG. 76 for data transfer scheme 7600, application defined information item (1) data type, block size, headers can indicate how data block specifications are defined. Also, item (2) can define transaction types (e.g., read/write), item (3) can define a buffer type to use at an ESMD with COSM, and item (4) can define a flow control.

According to some examples, as shown in FIG. 76, shared memory 7625 includes in-memory compute circuitry 7624. In-memory compute circuitry 7624 can be capable of executing sensitive computations within memory buffers maintained in at least a portion of the memory regions maintained in shared memory 7625. Similar to the memory buffers mentioned above for FIG. 72, these memory buffers can have a self-destructive capability that automatically erases data associated with the computations executed by in-memory compute circuitry 7624. This self-destructive capability can prevent persistence of data associated with the computations executed by the in-memory compute circuitry 7624 and can prevent or reduce a risk of an unauthorized retrieval of this data.

For example, administrator 7650-0 such as RAN manager (e.g., SMO, RIC, or operator) can configure COSM control plane unit 7632 with a COSM service setup request for isolation among network functions and edge/cloud applications executed for operator A. Similarly, administrator 7650-1 such as RAN manager (e.g., SMO, RIC, or operator) can configure COSM control plane unit 7632 with a COSM service setup request for isolation among network functions and edge/cloud applications executed for operator B.

Administrator 7650-0 and/or 7650-1 can configure control plane 7632 and/or orchestrator 7640 with a service level agreement (SLA) or service level objective (SLO) for memory and compute resources utilized for a communication channel between applications 7611 and 7631 using ESMD with COSM 7620. An SLA or SLO can specify at least one or more of: allocated memory bandwidth, allocated memory, allocated storage bandwidth, allocated storage, allocated network interface device bandwidth, allocated number of cores, processor utilization percentage, processor operating frequency, system uptime, number of generated frames per second (FPS), number of operations performed per second (OPS), or other criteria.

For example, for operator A, host 7610 can execute applications 7611 that can perform network functions and edge/cloud applications such as ORAN components or NextG core functions. For example, for operator B, host 7630 can execute applications 7631 that can perform network functions and edge/cloud applications such as ORAN components or NextG core functions.

In some examples, administrator 7650-0 or administrator 7650-1 can configure end-to-end isolation of communications for a network slice or between network functions by specification of a policy configuration request to interface with control plane 7632 and orchestration 7640. A policy configuration request can be expressed in JavaScript Object Notation (JSON), YAML Ain′t Markup Language (YAML), or gRPC-based schema. An example policy configuration request can be as follows.

```
PolicyConfigRequest
{
  “policy_id”: “string”,
  “flow_id”: “string”,
  “tenant_id”: “string”,
  “source_domain”: “Client | RAN | Core | Edge”,
  “destination_domain”: “Client | RAN | Core | Edge”,
  “resource_type”: [“Memory”, “Compute”, “Network”],
  “resource_size”: {
    “memory_MB”: “int”,
    “compute_cores”: “int”,
    “bandwidth_Mbps”: “int”
  },
  “priority”: “High | Medium | Low”,
  “duration_sec”: “int”,
  “isolation_level”: “Strict | Moderate | Shared”,
  “security_classificat ion”: “Sensitive | Non-sensitive”,
  “cosm_binding_policy”: {
    “write_access”: [“host_id_1”],
    “read_access”: [“host_id_2”, “host_id_3”],
    “access_control_ttl”: “int”
  },
  “telemetry_required”: true,
  “logging”: {
    “enable_audit”: true,
    “log_level”: “info | debug | warning”
  }
}
```

For example, resource_type can specify one or more of memory, compute, or networking resources to exclusively allocate to an isolated communications channel. For example, isolation_level can specify an isolation level of strict, moderate, or low. For example, an isolation level of strict can allocate memory addresses or memory devices and compute devices exclusively to an operator. For example, an isolation level of moderate can allocate memory addresses or memory devices and compute devices exclusively to an operator for a particular time or operation, such as connection setup. For example, an isolation level of shared can share memory addresses or memory devices and compute devices among operators.

For example, write_access can specify which host is permitted to write to a memory region. For example, read_access can specify which host is permitted to read from a memory region.

For example, telemetry_required can specify whether the ESMD with COSM is to report telemetry data such as memory addresses read from, memory addresses written to, number of memory reads or writes for a particular range of memory addresses, processor utilization or busyness, accelerator utilization or busyness, networking utilization or busyness, or others.

For example, log_level can specify that telemetry can be reported as information (info), a subset of information that is debug-related, or a warning of resources being overutilized, underutilized, or memory addresses being requested to be accessed by an application that is not granted permission to access the memory addresses.

### Memory Accesses Using Optical Communication Channels

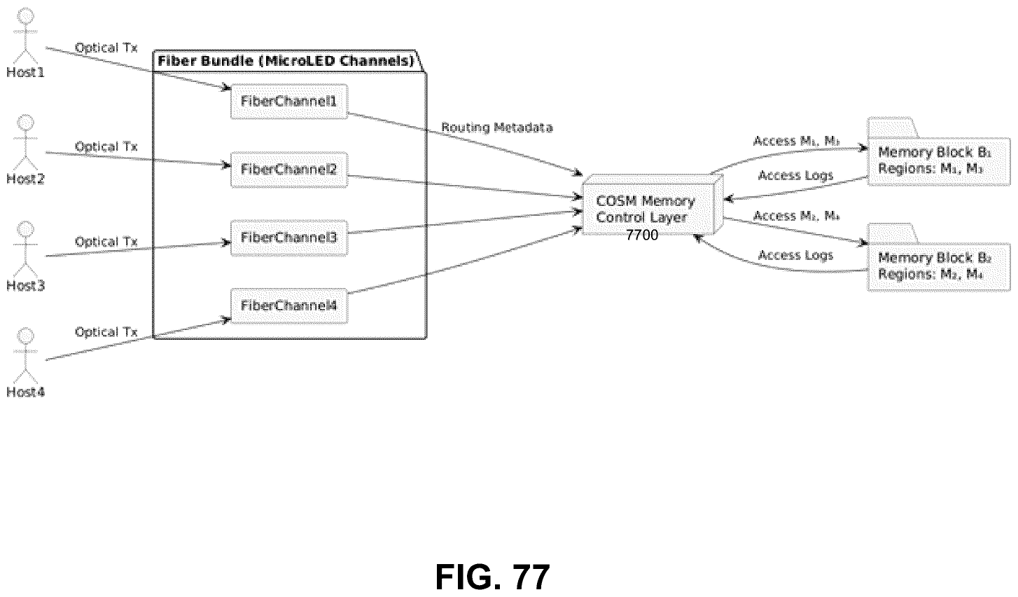

FIG. 77 depicts an example system. As described herein, hosts 1-4 can access COSM memory control 7700 by respective fiber channels 1-4. Fiber channels 1-4 can include optical interconnects such as microLED transceivers described herein. As described herein, based on a configuration, COSM memory control can permit or deny propagation of a memory access request to an associated memory block. For example, COSM memory control can permit or deny access requests received on fiber channels 1-4 to memory blocks B1 and B2, and memory regions M1 and M3 of block 1 and memory regions M2 and M4 of block 2. A memory block can include a physical memory device and can include one or more memory banks. As described herein, a memory region can be accessed by multiple different fibers connected to one or more hosts.

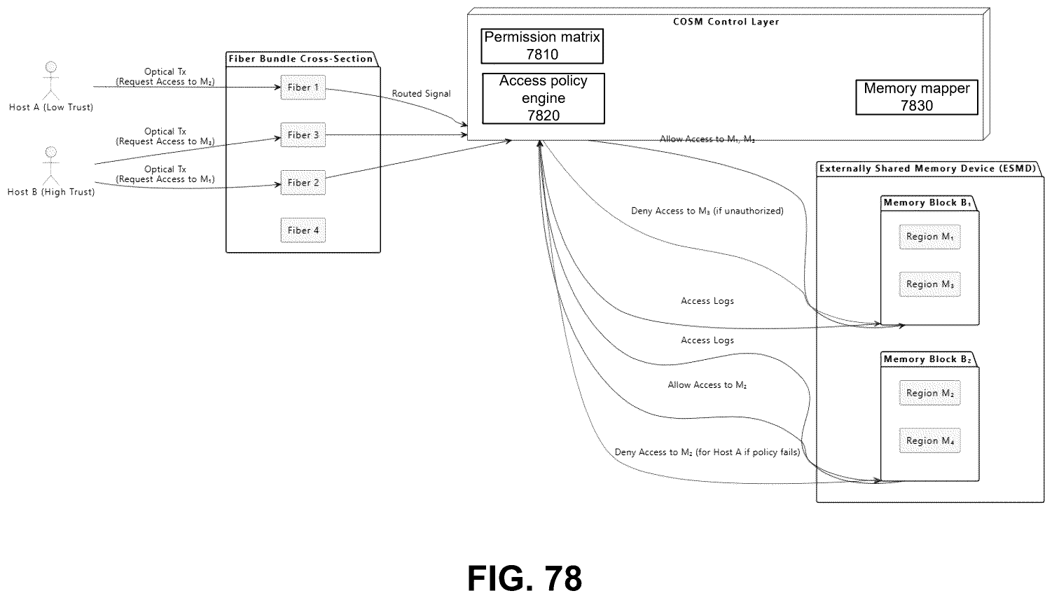

FIG. 78 depicts an example of memory access routing over an optical interconnect to enforce multi-host, multi-region isolation, and explain dynamic policy control for low vs. high-trust hosts. Hosts can communicate over dedicated fiber channels where each fiber can access a unique memory region such as a span of contiguous or non-contiguous memory addresses. A microLED switch performs control and policy enforcement by applying access control using a Permission Matrix 7810 and Access Policy Engine 7820 and routes or denies access requests based on host trust level and mapping rules. Memory mapper 7830 can indicate memory addresses that are permitted for access by particular fibers and hosts.

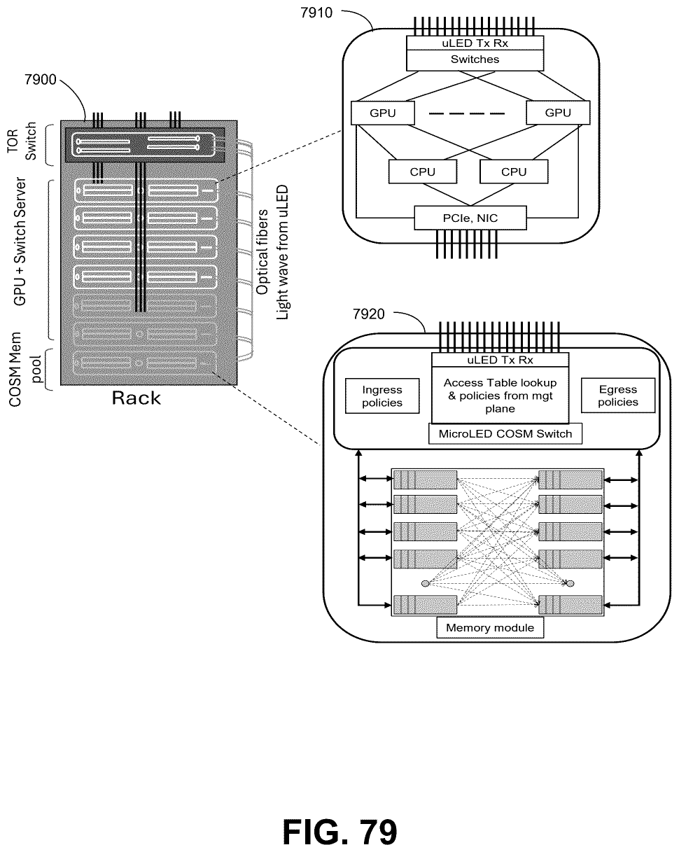

FIG. 79 depicts an example system. In some examples, a rack of servers 7900 can include a memory pool that communicate by optical fibers, electrical wires, and/or wireless communication. For example, a server or host can include one or more instances of host 7910 one or more graphics processing units (GPUs), central processing units (CPUs), accelerators, a switch, and a network interface device or device interface to communicate with other servers or hosts or ESMD 7920.

As described herein, based on a configuration, ESMD 7920 can allocate one or more regions of memory to store data for access by memory access requests received from optical interconnects. Data can include packets, artificial intelligence (AI) training data, weight data, or other data. As described herein, ESMD 7920 can perform switching of packets for communications among processes where communications are received from optical interconnects and transmitted by optical interconnects.

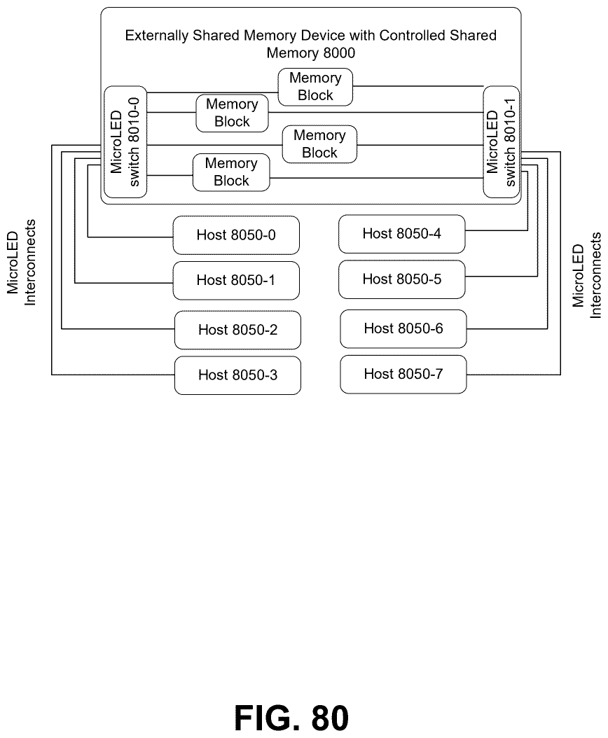

FIG. 80 illustrates a COSM-enabled Externally Shared Memory Device (ESMD) architecture with microLED-based optical interconnects and switching. Multiple hosts 8050-0 to 8050-7 can be connected to an memory blocks of ESMD 8000 by optical interconnects and/or electrical or wireless communication technologies. ESMD 8000 can include a memory device that includes multiple memory blocks. Memory blocks can be associated with particular physical addresses. As described herein, a fiber channel is mapped to a memory region (e.g., M1, M2) within a block (e.g., B1, B2). Hosts 8050-0 to 8050-7 and ESMD 8000 can utilize microLED transmitters and photodetectors (PDs) for optical communications.

MicroLED optical interconnects provide optical isolation, reducing cross-talk and vulnerabilities from electromagnetic interference (EMI) signal reading. MicroLED switches 8010-0 and 8010-1 of ESMD 8000 can enforce access type (e.g., read/write) permissions, memory quotas, and usage-based segmentation based on a configuration that specifies per-host and per-request policy enforcement. MicroLED switches 8010-0 and 8010-1 or other circuitry can support multi-tenancy by logically and physically isolating workloads.

Various operator policies can control whether a particular host can read from or or write to a particular memory block, and a level of granularity (e.g., application, user, or tenant). COSM's permission matrices and enforcement circuitry provides multi-tenant memory isolation and hardware-level access control of memory access. COSM's permission matrices and enforcement circuitry can apply an Access Control List (ACL) to manage memory partitioning by defining per-user access levels for each memory block. Based on permission matrices, MicroLED switches 8010-0 and 8010-2 can provide non-blocking, light-based communication paths between host systems and individual memory blocks.

An example of operations is as follows. At (1), a host sends a memory request over its dedicated microLED interconnect to ESMD 8000. A memory request can include identify read or write, host identity, fiber ID, and target memory region. Transactions can be logged in an access log for auditing or revocation policies. At (2), a microLED switch, which receives the memory request, validates the request against its permission matrix. Validating the request can check access type (read/write), host identity, fiber ID, target memory region, and permissions. If the request is authorized, at (3), the memory block is accessed and the data is transmitted to the requester host by the MicroLED switch via an optical interconnect to the host. If the request is denied, the request is blocked and logged for policy enforcement.

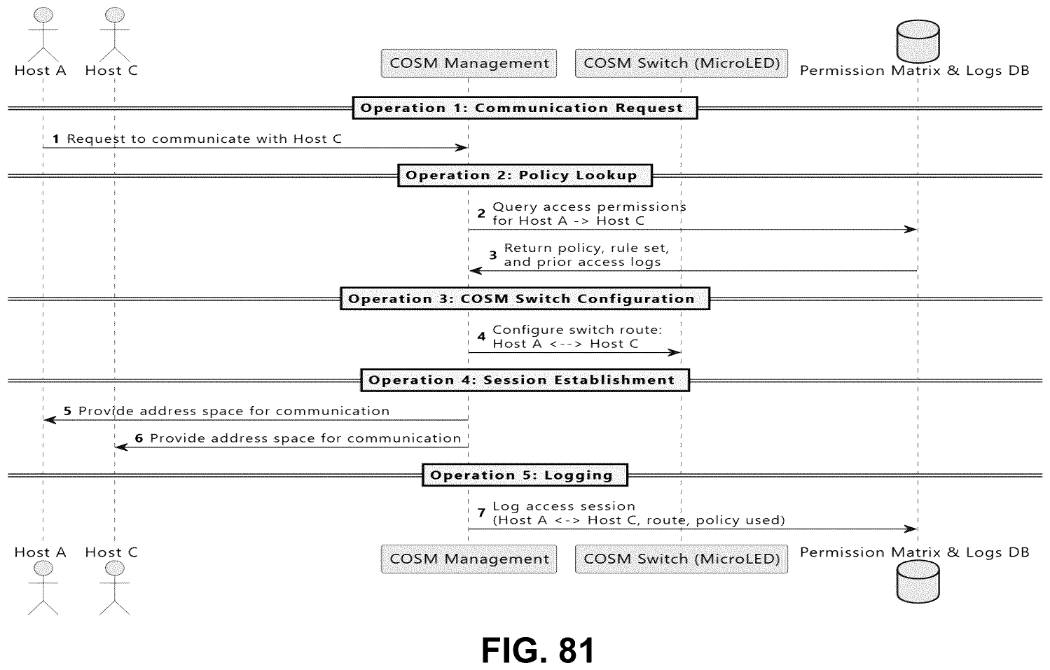

FIG. 81 depicts an example operation. The example operations can be used to provide secure optical communications between host A and C by a COSM. At (1), host A can request COSM management system to setup a secure and isolated communication with host C by sharing one or more memory regions. At (2), COSM management system can query access permissions in a permission matrix configuration to determine whether isolated communications among hosts A and C via COSM are permitted. At (3), the permission matrix can provide to COSM management can permit shared access to memory region in COSM by fibers connected to hosts A and C. At (4), COSM management can request microLED switch controller to provide access to the memory regions requested to be shared by hosts A and C.

At (5) and (6), COSM management can indicate to respective hosts A and C addresses available for communication between host A and C. At (7), COSM management can log accesses to memory regions by hosts A and C in permission matrix for auditing and potential reallocation of memory and compute resources to communications between host A and host C.

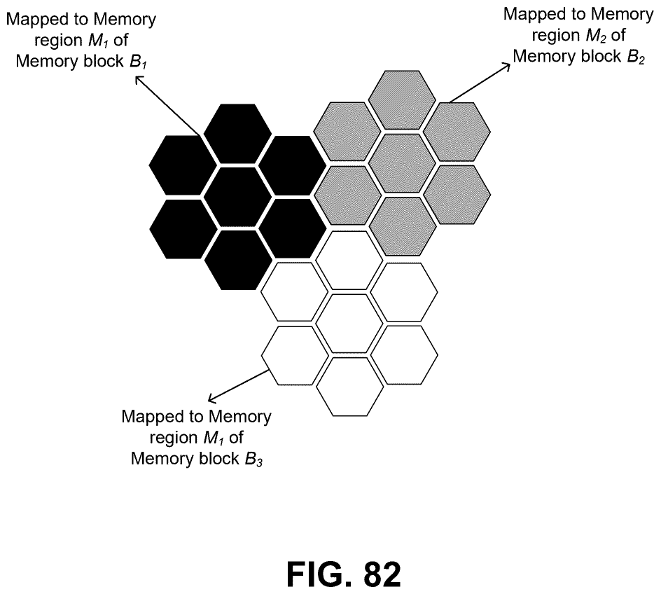

FIG. 82 depicts an example fiber bundle cross-section. Different shaded fiber bundles can be connected to particular hosts or circuitries and can be coupled to access particular memory regions via microLED-based transceivers. As described herein, a microLED-based transceiver communicate with another microLED-based transceiver over one or more optical interconnects. As described herein, a microLED-based transceiver can include lens arrays, microLED arrays, and photodetector arrays.

Each fiber in a bundle can connect to a dedicated microLED/PD pair, which is physically mapped to a single memory region (e.g., M₁ of B₁) to create optical air gaps between memory regions. COSM divides memory blocks (B₁, B₂ . . . ) into secure regions (M₁, M₂, etc.) and each region is accessible only through its assigned fiber channel. Even if multiple hosts attempt to read or write to the same memory block, fiber routes and a configured switch can enforce memory separation. For example, host A (low trust) can only access M2 via Fiber 7 whereas host B (high trust) has access to M1, M₃, and M4 via Fibers 1, 2, and 9. Multiple fibers can be grouped logically and group access policies can enforce that only certain hosts can access grouped regions.

To share data in a memory region among different hosts, microLED switches for different fibers can permit access to the same memory region. For example, host C can access memory region M2 via fiber 1 whereas host D has access to M2 via fiber 4.

As described herein, a microLED switch in COSM acts a security gatekeeper to a memory region by evaluating memory requests; verifying host authentication and policy compliance; and allowing, denying, or rerouting access based on security clearance for a particular application, tenant, or request.

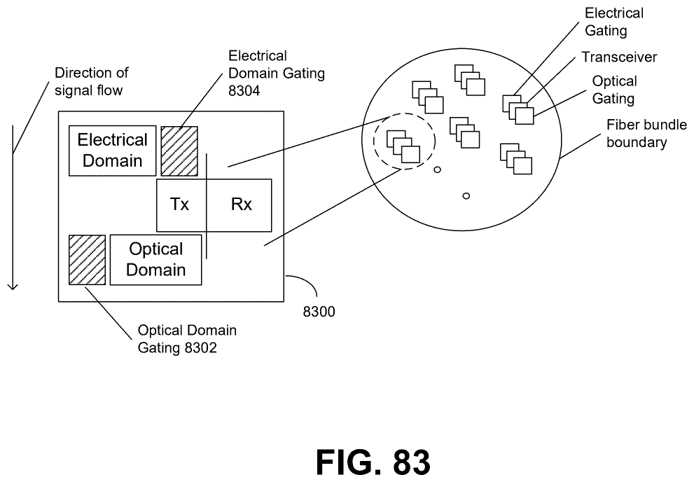

FIG. 83 depicts an example of circuitry that can gate access to data. For example, circuitry 8300 can be used by a MicroLED switch or circuitry coupled to a memory block. For example, multiple levels of signal gating for received signals from an optical fiber from a host and signals transmitted via the optical fiber to the host can be applied based on a configuration. At least electrical and/or optical signal gating can be applied to permit or deny egress or ingress of signals to and from a host. For example, a switch can perform signal gating to (1) electrical signals by activating or deactivating circuit paths to permit or deny access to a memory region and/or (2) optical signals to control light-based data lanes.

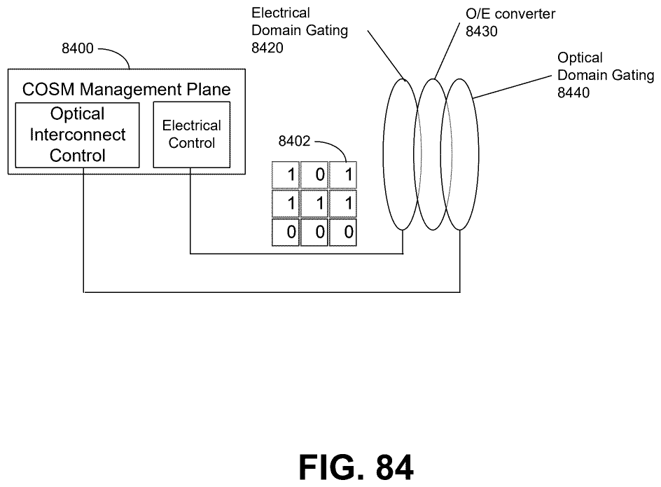

FIG. 84 depicts an example of configuring optical and electrical signal gating based on a configuration. For a group of 3 interconnects, COSM management plane 8400 can provide matrix 8402, which can specify whether to perform: optical signal gating, optical to electrical signal conversion, and electrical signal gating. However, matrix 8402 can be scaled to 100s and 1000s of microLED fiber channels. Based on matrix 8402, electrical signal gating 8320 can permit or stop electrical signal propagation. Based on matrix 8402, optical to electrical (O/E) signal conversion can perform or not perform optical to electrical signal conversion or electrical to optical signal conversion. Based on matrix 8402, optical signal gating 8440 can permit or stop optical signal propagation.

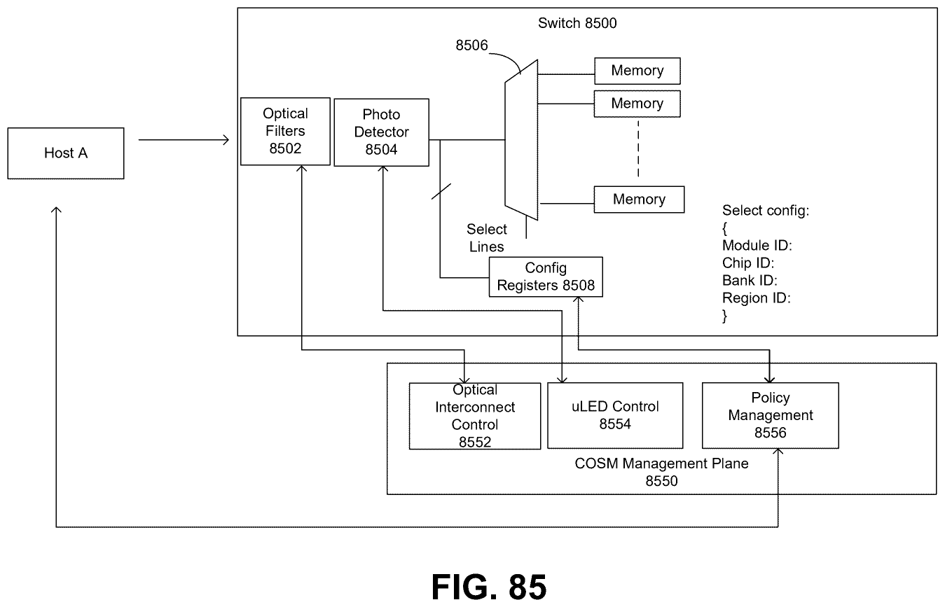

FIG. 85 depicts an example switch that can permit or deny optical or electrical communications. While the example is described for Host A can request COSM management 8550 to configure COSM microLED switch 8500 to permit or deny signals received from a particular host. Based on a request from host A, COSM management 8550 can configure microLED switch 8500 to permit propagation or deny propagation of a memory access request from host A. The request can specify {Host Identifiers{ID, process, quality of service (QOS), priority, or other fields}. Switch 8500 can be also configured to permit or deny memory accesses from another host that shares a memory region with host A, such as host C. Optical interconnect control 8552 can configure optical filters 8502 to gate or permit signals to propagate from one or more optical cables.

Photodetector 8504 can perform optical to electrical signal conversion (O/E) and provide electrical signals to demultiplexer. MicroLED control 8554 can configure photo detector (PD) 8504 to permit or deny optical signal receipt and translation to electrical signals based on a configuration in policy management that specifies per fiber permissions.

To control receipt and propagation of electrical signals, policy management 8556 can configure configuration registers 8508 of demultiplexer 8506 that is connected to multiple memory blocks. The configuration can include a bitmap or JavaScript Object Notation (JSON) file loaded into configuration register 8508 indicates whether, for a particular host, to activate a line or not. For ungated electrical signals, converted from optical signals, for a particular received request, configuration register 8508 can specify one or more electrical signal outputs from demultiplexer 8506 are permitted to egress signals to read from or write to memory blocks. A memory block can include one or more target memory devices or memory address regions.

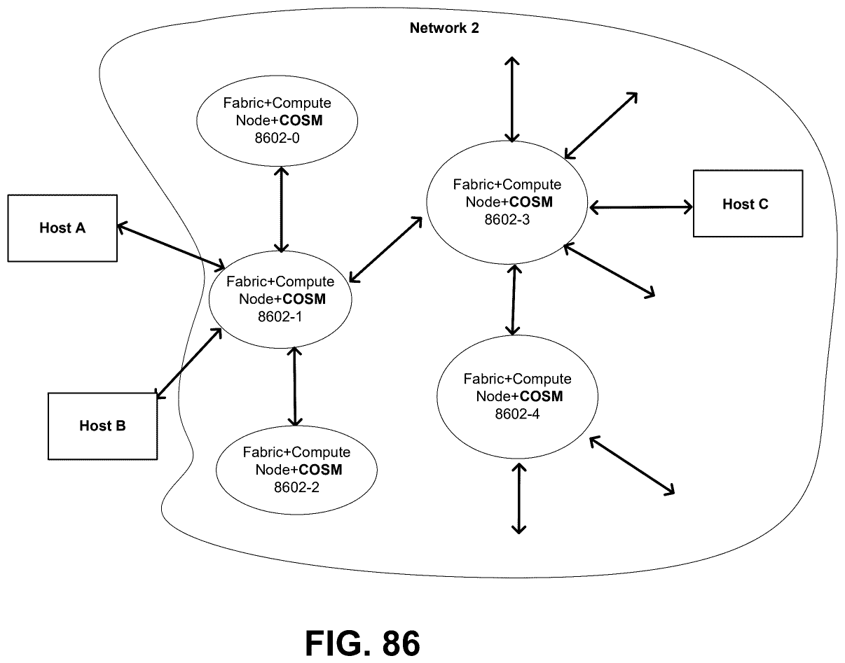

FIG. 86 depicts an example system. Multiple hosts A-C can communicate by microLED optical interconnects using one or more of COSM compute and memory nodes 8602-0 to 8602-4. COSM compute and memory nodes 8602-0 to 8602-4 can be connected in mesh, ring, or hypercube topologies. In some examples, COSM compute and memory nodes 8602-0 to 8602-4 can include compute and memory technologies and provide isolated communication of data between different hosts or processes executing on a single host by reservation of memory regions and accesses using optical interconnects, as described herein. For example, COSM compute and memory nodes 8602-0 to 8602-4 can utilize switch fabrics to route packet traffic through ESMD to store traffic from a first node (e.g., Host A) in a first memory region and copy the packet traffic from the first memory region to a second memory region for access by a second node (e.g., Host B). Nodes provide distributed ESMD access points and utilize COSM to apply memory isolation policies, authentication of authorized reads and writes, and/or secure routing of data. Utilization of COSM on different nodes can enforce access permissions per memory region, secure memory region mapping, and real-time policy enforcement and flow isolation.

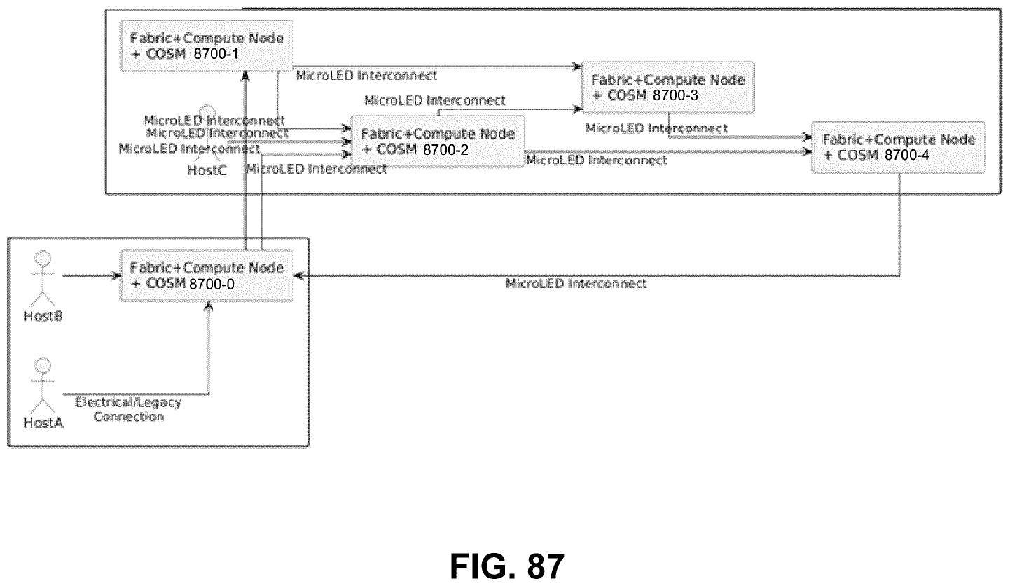

FIG. 87 depicts an example system whereby multiple COSM, switch fabric, and compute nodes (e.g., one or more of nodes 8602-0 to 8602-4) can be communicatively coupled by optical interconnects, described herein. For example, host A can communicate with a COSM, switch fabric, and compute node 8700-0 via electrical or wireless technologies. Host B can communicate with COSM, switch fabric, and compute node 8700-0 and multiple COSM, switch fabric, and compute nodes 8700-1 to 8700-4 via optical interconnects. A node can send traffic to a second node to store the traffic in a first memory region in COSM and COSM can copy the traffic from the first memory region to a second memory region for reading by a third node.

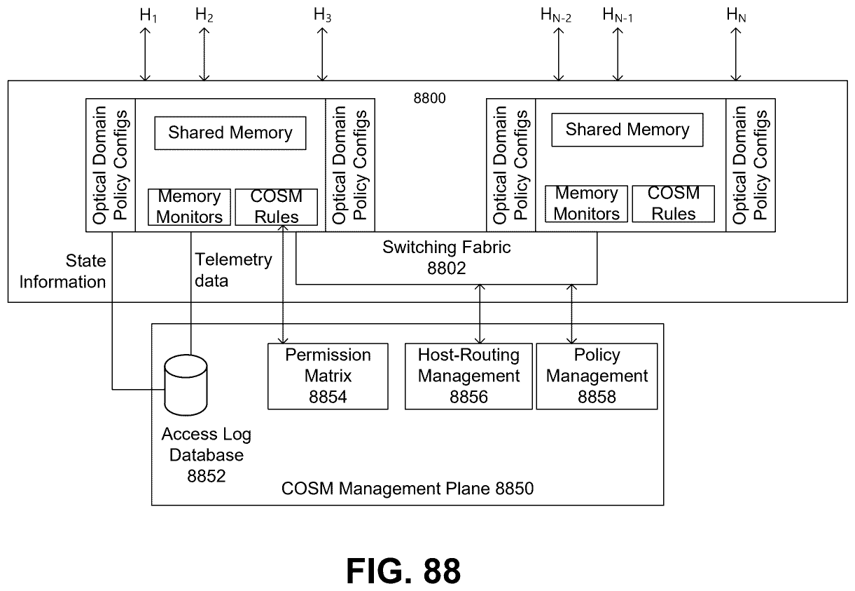

FIG. 88 depicts an example system. Node 8800 can isolate communications among nodes by providing per-connection policy enforcement between, validating memory accesses for a host before permitting access to a region of memory, or prevents unauthorized replication or movement across a fabric of nodes. Node 8800 can utilize switching fabric 8802 to provide communication between different nodes (e.g., hosts H₁ to H_{N}, where N is an integer). Permission matrix 8854 can specify whether data from the memory accessible to a first node can be copied by switching fabric 8802 to a memory accessible to a second node. For example, data from a memory accessible to a first node (e.g., H₁) can be copied by switching fabric 8802 to a memory accessible to a second node (e.g., H₂).

An operator or tenant can dynamically configure host routing management data 8856 to configure switching fabric 8802 to communicatively couple particular memory regions of the same or different memory banks, as described herein.

An operator or tenant can dynamically configure policy management data 8858 to grant or deny access, route data securely across particular optical channels, and partition memory logically per tenant or application.

Access log 8852 can store telemetry data indicative of utilization of memory (e.g., memory bandwidth, memory addresses accessed, or others) and/or utilization of compute resources (e.g., accelerator or processor utilization or busyness, or others).

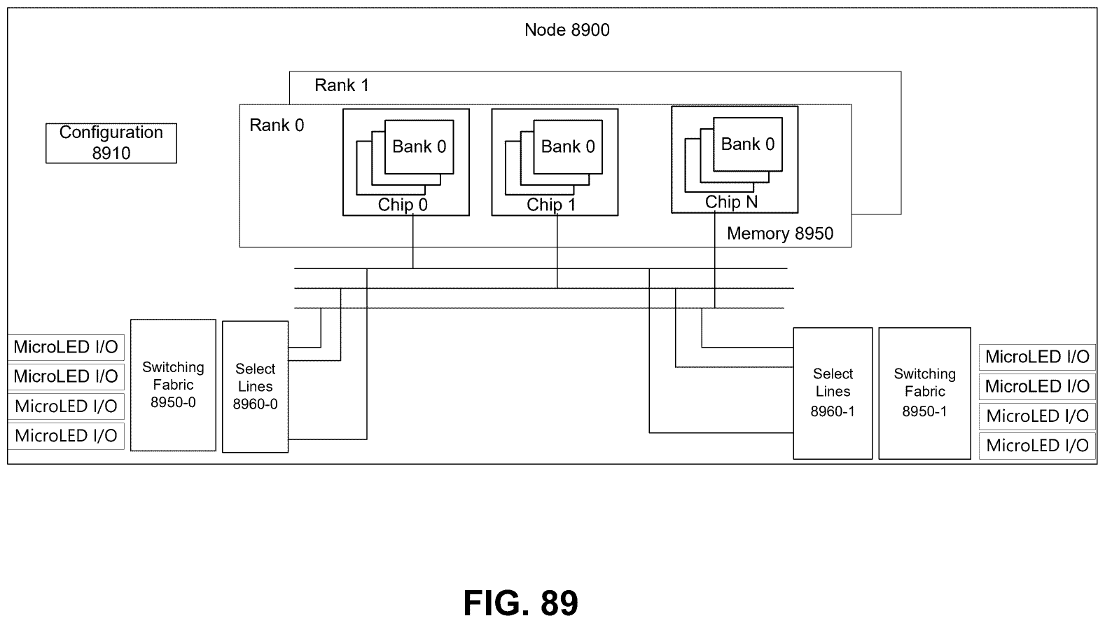

FIG. 89 depicts an example switch. Based on a policy or configuration 8910, switching fabric 8950-0 and 8950-1 can permit or deny communications from an optical interconnect to forward to output to a particular bank of memory device 8950. If switching fabric 8950-0 permits forwarding of an access request from an optical interconnect, based on a configuration 8910, select lines circuitry 8960-0 can select an interconnect to a particular bank of memory 8950 to forward the access request. If switching fabric 8950-1 permits forwarding of an access request from an optical interconnect, based on a configuration 8910, select lines circuitry 8960-1 can select an interconnect to a particular bank of memory 8950 to forward the access request. For example, as described herein, data written to a particular bank of a rank of memory 8950 can be copied from the bank to a second bank of the same or different rank for retrieval.

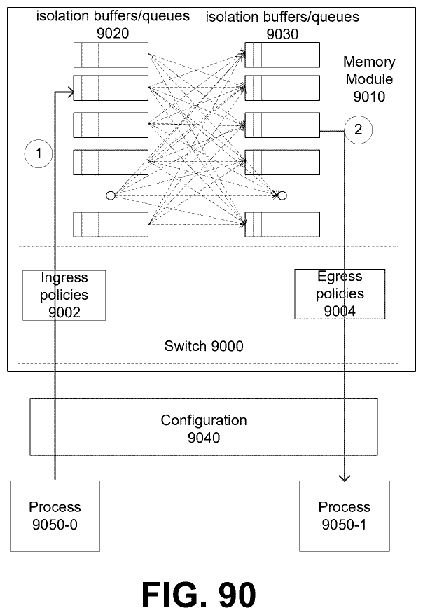

FIG. 90 depicts an example of routing data through a memory module 9010 by copying data from source buffers 9020 to destination buffers 9030 to perform in-memory switching. At (1), based on ingress policies 9002 permitting copying of data accessible by a first process (e.g., virtual machine (VM), container, application, microservice, thread) or first host and by a second process or host, data can be stored in source buffer 9020. The data can be copied from source buffer 9020 to output buffer 9030. At (2), based on an egress policy 9004 permitting the data in output buffer 9030 to be accessed by the second host or process, the data can be copied from the output buffer 9030 to the second host or process.

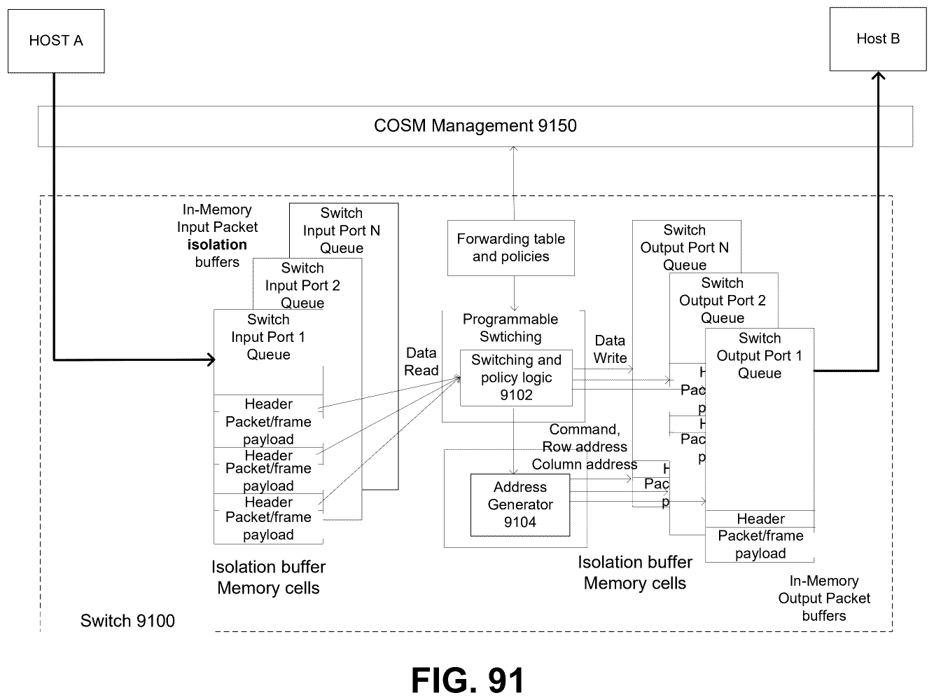

FIG. 91 depicts another example of packet transmission between hosts or processes using COSM. For example, a first process executing on host A can write packets to an input port queue 1 of switch 9100 for access by a second process executed by host B. Host A can access switch 9100 via one or more optical interconnects. COSM management 9150 can configure switching policy logic 9102 with a forwarding table and policies. Based on forwarding table and policies, programmable switch 9100 in COSM can copy packets from input port 1 queue to an address corresponding to switch output port 2 queue in memory. For example, address generator 9104 can generate a command, row address, and column address for the output port 2 queue. Host B can access COSM via one or more optical interconnects. Similarly, the second process executed by host B can transmit packets via an input queue port to an output port queue accessible by the first process executed by host A.

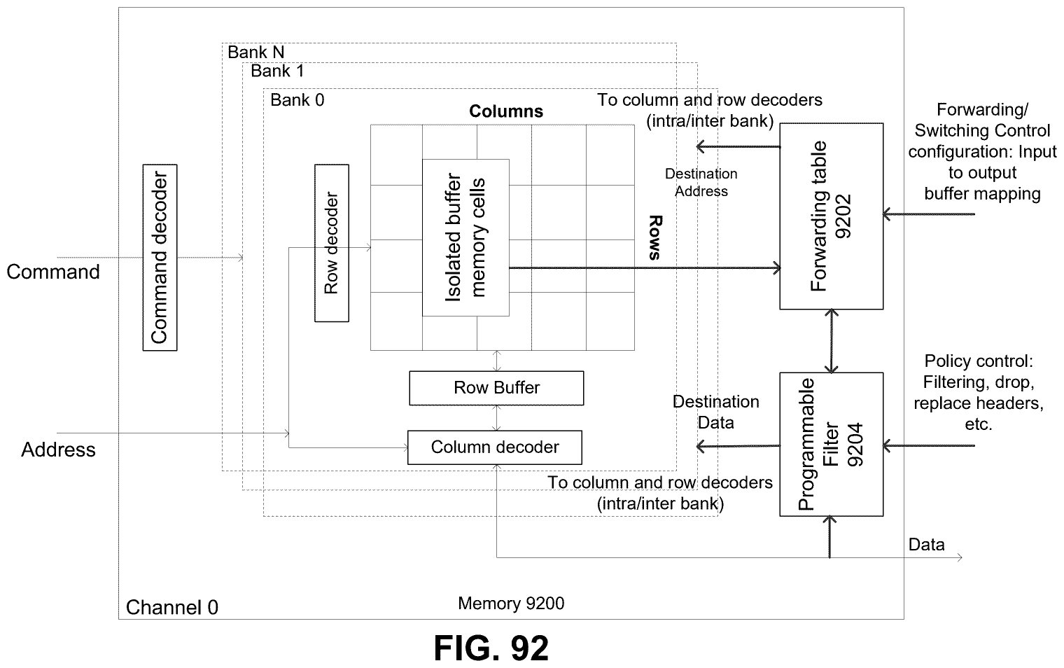

FIG. 92 depicts an example system. In some examples, data in an isolated buffer in a memory bank 0 at a memory device 9200 in COSM can be copied to an isolated buffer in memory bank 1. Forwarding table 9202 can be accessed to determine a destination address and corresponding column and row location for the isolated buffer in a memory bank 1. Forwarding table 9202 can perform input to output buffer mapping. Programmable filter 9204 can perform filtering of data based on a source or target of the data to permit or prevent receipt and storage of data. Programmable filter 9204 can filter packets, drop packets, or replace packet headers based on a configuration for host to host communications or process to process communications.

System-on-Chip (SoC) architectures can include secure and non-secure circuitries. Circuitries can include cryptographic engines, machine learning accelerators, and input/output (I/O) peripherals onto a single die or multi-chiplet substrate. This integration can experience cross-domain vulnerabilities, such as side-channel leakage between secure and non-secure circuitries, inability to dynamically reconfigure or isolate subsystems based on runtime context (e.g., sensitive transactions versus shared applications and data), and enforcing isolation of data flow. Various examples provide a configurable interconnect to logically and physically partition circuitries while providing reconfigurable data isolation and access control for interconnects such as microLEDs.

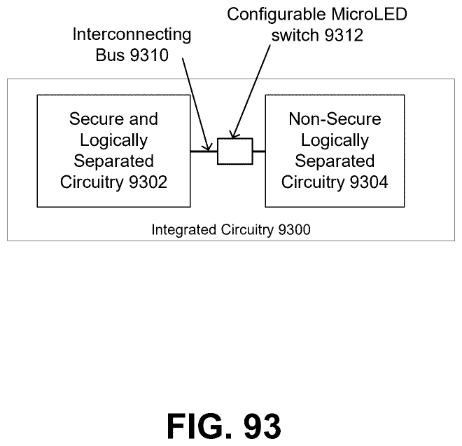

FIG. 93 depicts an example of gating of communications between first and second circuitries. First circuitry 9302 can include a memory, processor, or accelerator. Second circuitry 9304 can include a memory, processor, or accelerator. First circuitry 9302 can be configured as secure and available for access by permission whereas second circuitry 9304 can be configured as non-secure and available for access without permission. Secure and non-secure circuitries and data accessible to secure and non-secure circuitries can be isolated by microLED switch 9312. At design, a circuitry can be configured as secure, non-secure, or reconfigurable. Configurable MicroLED switch 9312 can be positioned to gate or permit communications among interconnect 9310 between isolated and non-isolated circuitry boundaries. At boot time, MicroLED switch 9312 reads security policies and initializes accordingly. At runtime, microLED switch 9312 apply configuration to deny data communications among circuitries 9302 and 9304. During runtime, configurations of microLED switch 9312 can be remapped to change whether communications over interconnect 9310 are permitted or denied. Attempts to read or write that violate a policy of microLED switch 9312 can be logged or trigger deactivation of microLED switch 9312.

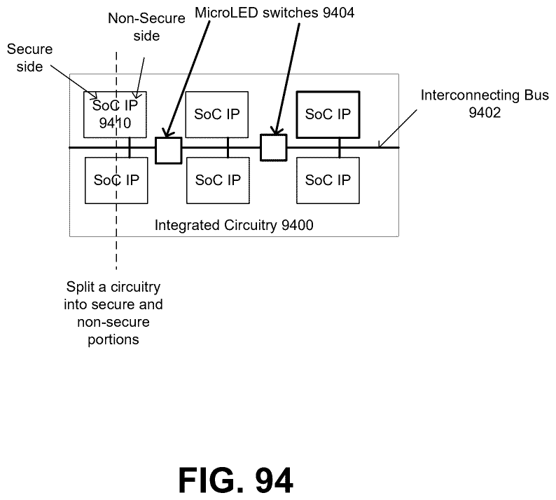

Monolithic SoCs, chiplet-based SoCs, or tiled multi-core processors can be partitioned to isolate communications and accesses to data. Various examples can isolate specific functional circuitries. Software-defined partitioning can be performed based on threat levels, workloads, or multi-tenant operation. FIG. 94 depicts an example system. In some examples, a circuitry 9410 can be partitioned into secure and non-secure sub-circuitries and data accessible to secure and non-secure circuitries can be isolated by microLED switches 9404. Configurable microLED switches 9404 act as optical bridges between circuitries in secure and non-secure domains of circuitry 9410. Configuration of microLED switches 9404 provides real-time policy enforcement, directional data flow restriction (e.g., unidirectional/bidirectional), and dynamic partitioning of compute resources.

Circuitry 9410 can be split and assigned into isolated (secure) domains and non-isolated (non-secure) domains. For example, a secure cluster can include particular memory, I/O, cores, and interconnects whereas a non-secure cluster can include particular memory, I/O, cores, and interconnects. MicroLED switch 9404, described herein, can permit bidirectional communication (e.g., write and read-only from circuitry in non-secure domain to circuitry in secure domain and vice versa), unidirectional communication (e.g., write-only or read-only from circuitry in a first domain (non-secure or secure) to circuitry in a second domain (non-secure or secure)), unidirectional communication (e.g., write and read from circuitry in a first domain (non-secure or secure) to circuitry in a second domain (non-secure or secure)), or blocked (e.g., no write and no read from circuitry in a first domain to circuitry in a second domain). For example, microLED switch 9404 can be configured at runtime to: disable access when entering secure mode, enable data streaming for specific tasks (e.g., secure inference), mirror data across zones with policy checks, or others.

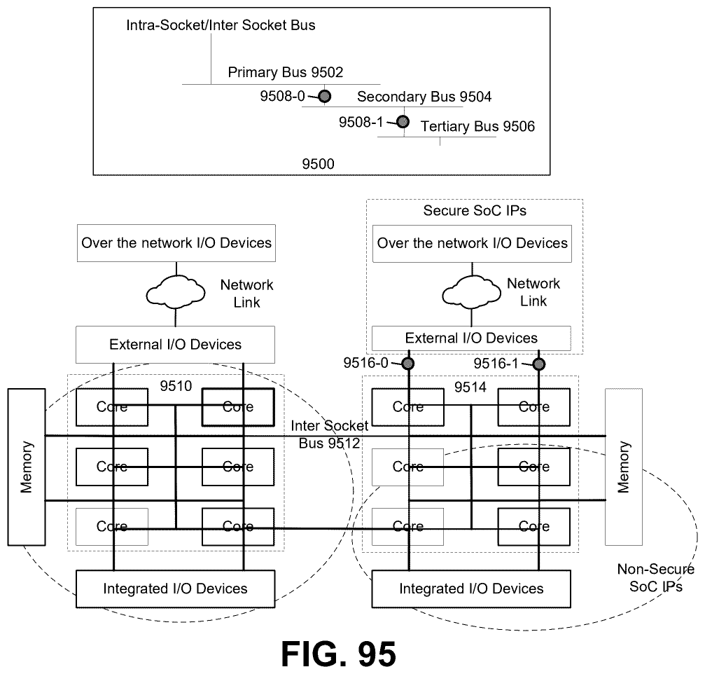

FIG. 95 depicts an example of interconnects. Various circuitries such as processors, accelerators, memory, or network interface devices can be coupled to primary bus 9502, secondary bus 9504, or tertiary bus 9506. In interconnect 9500, a primary bus 9502 can be isolated from a secondary bus 9504 by a microLED switch 9508-0. Secondary bus 9504 can be isolated from a tertiary bus 9506 by a microLED switch 9508-1. Various examples of microLED switches can be used to permit or deny access to an optical interconnect bus to partition systems into secure and unsecure domains. For example, according to a configuration, various examples of microLED switches can be configured to permit or deny transmission or receipt of signals by particular optical interconnect.

Intra-socket bus 9510 can provide communications among cores, memory, integrated I/O devices, and input/output (I/O) devices via a network link. Inter-socket bus 9512 can provide communications between intra-socket bus 9510 and intra-socket bus 9514. Intra-socket bus 9514 can provide communications among cores, memory, integrated I/O devices, and input/output (I/O) devices via a network link. However, microLED switches 9516-0 and 9516-1 can isolate communications of devices coupled to intra-socket bus 9510, inter-socket bus 9512, and intra-socket bus 9514 from devices coupled over a network link.

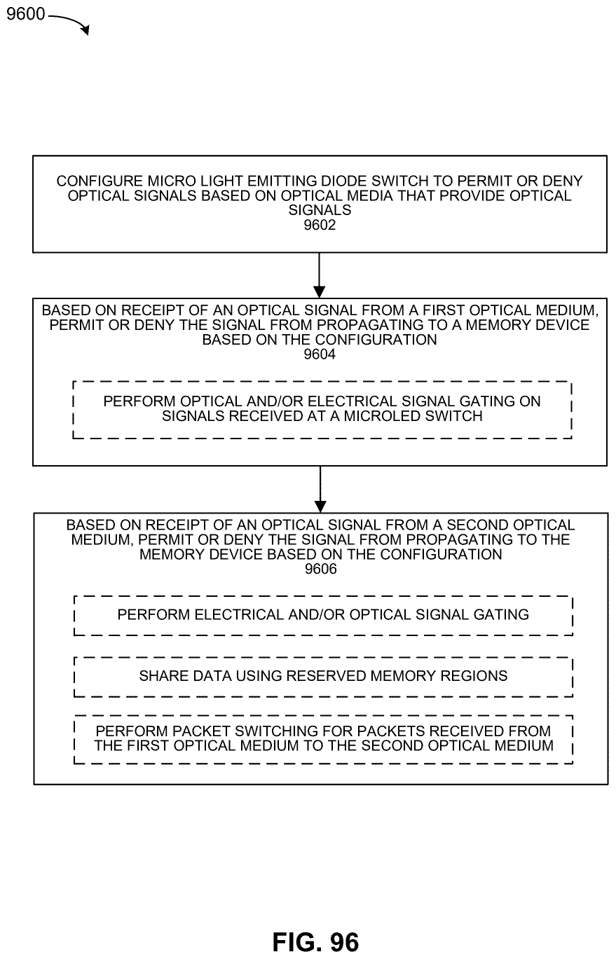

FIG. 96 depicts an example process. The process can be performed by an ESMD with microLED switches. At 9602, the ESMD can receive a configuration to apply to one or more microLED switches that receive optical signals from optical interconnects. The configuration can indicate to apply optical and/or electrical signal gating for signals received at a microLED switch of the ESMD. At 9604, based on receipt of an optical signal from an optical medium, the microLED switch can apply the configuration to permit or deny propagation of the signal. For example, based on denying propagation of the optical signal, an exception log can be updated to indicate an attempted access by a particular host, processor, and/or cable. At 9606, based on receipt of a second optical signal from a second optical medium, the microLED switch that receives the second optical signal can apply the configuration to permit or deny propagation of the second optical signal. For example, the microLED switch can apply optical and/or electrical signal gating on the second signal. Based on permitting propagation of the second optical signal, data can be shared between first and second hosts, first and second circuitries, or first and second processes. For example, packet switching can be performed by permitting or denying access to the memory.

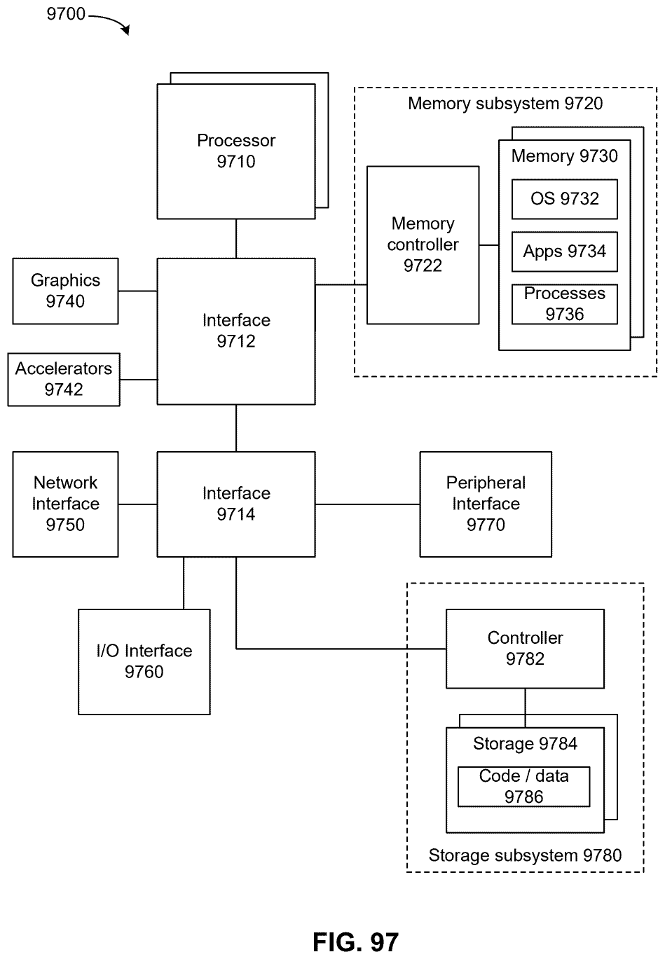

FIG. 97 depicts an example system 9700. In some examples, circuitry of system 9700 can be used to access ESMD, as described herein. System 9700 includes processor 9710, which provides processing, operation management, and execution of instructions for system 9700. Processor 9710 can include any type of microprocessor, central processing unit (CPU), graphics processing unit (GPU), XPU, processing core, or other processing hardware to provide processing for system 9700, or a combination of processors. An XPU can include one or more of: a CPU, a graphics processing unit (GPU), general purpose GPU (GPGPU), and/or other processing units (e.g., accelerators or programmable or fixed function FPGAs). Processor 9710 controls the overall operation of system 9700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 9700 includes interface 9712 coupled to processor 9710, which can represent a higher speed interface or a high throughput interface for system components that needs higher bandwidth connections, such as memory subsystem 9720 or graphics interface components 9740, or accelerators 9742. Interface 9712 represents an interface circuit, which can be a standalone component or integrated onto a processor die. Where present, graphics interface 9740 interfaces to graphics components for providing a visual display to a user of system 9700. In one example, graphics interface 9740 can drive a display that provides an output to a user. In one example, the display can include a touchscreen display. In one example, graphics interface 9740 generates a display based on data stored in memory 9730 or based on operations executed by processor 9710 or both. In one example, graphics interface 9740 generates a display based on data stored in memory 9730 or based on operations executed by processor 9710 or both.

Accelerators 9742 can be a programmable or fixed function offload engine that can be accessed or used by a processor 9710. For example, an accelerator among accelerators 9742 can provide data compression (DC) capability, cryptography services such as public key encryption (PKE), cipher, hash/authentication capabilities, decryption, or other capabilities or services. In some cases, accelerators 9742 can be integrated into a CPU socket (e.g., a connector to a motherboard or circuit board that includes a CPU and provides an electrical interface with the CPU). For example, accelerators 9742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 9742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 9720 represents the main memory of system 9700 and provides storage for code to be executed by processor 9710, or data values to be used in executing a routine. Memory subsystem 9720 can include one or more memory devices 9730 such as read-only memory (ROM), flash memory, one or more varieties of random access memory (RAM) such as DRAM, or other memory devices, or a combination of such devices. Memory 9730 stores and hosts, among other things, operating system (OS) 9732 to provide a software platform for execution of instructions in system 9700. Additionally, applications 9734 can execute on the software platform of OS 9732 from memory 9730. Applications 9734 represent programs that have their own operational logic to perform execution of one or more functions. Processes 9736 represent agents or routines that provide auxiliary functions to OS 9732 or one or more applications 9734 or a combination. OS 9732, applications 9734, and processes 9736 provide software logic to provide functions for system 9700. In one example, memory subsystem 9720 includes memory controller 9722, which is a memory controller to generate and issue commands to memory 9730. It will be understood that memory controller 9722 could be a physical part of processor 9710 or a physical part of interface 9712. For example, memory controller 9722 can be an integrated memory controller, integrated onto a circuit with processor 9710.

Applications 9734 and/or processes 9736 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 9732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 9700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 9700 includes interface 9714, which can be coupled to interface 9712. In one example, interface 9714 represents an interface circuit, which can include standalone components and integrated circuitry. In one example, multiple user interface components or peripheral components, or both, couple to interface 9714. Network interface 9750 provides system 9700 the ability to communicate with remote devices (e.g., servers or other computing devices) over one or more networks. Network interface 9750 can include an Ethernet adapter, wireless interconnection components, cellular network interconnection components, USB (universal serial bus), or other wired or wireless standards-based or proprietary interfaces. Network interface 9750 can transmit data to a device that is in the same data center or rack or a remote device, which can include sending data stored in memory. Network interface 9750 can receive data from a remote device, which can include storing received data into memory. In some examples, packet processing device or network interface device 9750 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 9700 includes one or more input/output (I/O) interface(s) 9760. I/O interface 9760 can include one or more interface components through which a user interacts with system 9700. Peripheral interface 9770 can include any hardware interface not specifically mentioned above. Peripherals refer generally to devices that connect dependently to system 9700.

In one example, system 9700 includes storage subsystem 9780 to store data in a nonvolatile manner. In one example, in certain system implementations, at least certain components of storage 9780 can overlap with components of memory subsystem 9720. Storage subsystem 9780 includes storage device(s) 9784, which can be or include any conventional medium for storing large amounts of data in a nonvolatile manner, such as one or more magnetic, solid state, or optical based disks, or a combination. Storage 9784 holds code or instructions and data 9786 in a persistent state (e.g., the value is retained despite interruption of power to system 9700). Storage 9784 can be generically considered to be a “memory,” although memory 9730 is typically the executing or operating memory to provide instructions to processor 9710. Whereas storage 9784 is nonvolatile, memory 9730 can include volatile memory (e.g., the value or state of the data is indeterminate if power is interrupted to system 9700). In one example, storage subsystem 9780 includes controller 9782 to interface with storage 9784. In one example controller 9782 is a physical part of interface 9714 or processor 9710 or can include circuits or logic in both processor 9710 and interface 9714. A volatile memory is memory whose state (and therefore the data stored in it) is indeterminate if power is interrupted to the device. A non-volatile memory (NVM) device is a memory whose state is determinate even if power is interrupted to the device. Various examples of memory 9730 or storage 9784 can include ESMD described herein.

In an example, system 9700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 800 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes an interface coupled to a memory and circuitry, coupled to the interface, wherein the circuitry is to: based on receipt of a first request to access data received from an optical interface and from a process, apply a configuration to determine whether to permit the access to data from a first memory region of the memory and based on a determination to permit the access to the data, permit access to the data by the first request, wherein the first memory region of the memory is accessible to multiple processes of a tenant via optical interconnects.

Example 2 includes one or more examples, wherein the configuration is to specify an access level of the first request from the optical interface.

Example 3 includes one or more examples, wherein the access level comprises: read only, write only, read and write, or no access.

Example 4 includes one or more examples, wherein the circuitry is to: based on receipt of a second request to access data from the process, apply the configuration to determine whether to permit the access to the data and based on a determination to deny the access to the data, deny access the data by the second request.

Example 5 includes one or more examples, wherein to deny the access to the data, the circuitry is to: perform gating of the second request in one or more of: optical format or electrical format.

Example 6 includes one or more examples, wherein the circuitry comprises: an optical signal receiver and a demultiplexer, wherein: the optical signal receiver is to permit or deny optical signal propagation based on the configuration, the demultiplexer is to selectively permit propagation of an electrical signal to the memory based on the configuration, and the electrical signal comprises an electrical signal version of the optical signal.

Example 7 includes one or more examples, wherein the circuitry is to: based on receipt of a second request, from the process, to route the data to a second process, apply the configuration to determine whether to permit the access to the data and based on a determination to permit the access to the data, copy the data to a second memory region and provide access to the data to the second process.

Example 8 includes one or more examples, wherein the data comprises one or more of: a packet, artificial intelligence (AI) weight data, or AI training data.

Example 9 includes one or more examples, and includes a method that includes isolating a first process by reserving access to memory and compute resources for the first process and by gating signals received from a first optical interface from accessing the memory and compute resources based on a configuration and sharing data between the first process and a second process by permitting access to the memory and compute resources and by permitting signals received from a second optical interface to accessing the memory and compute resources based on the configuration.

Example 10 includes one or more examples, wherein the configuration is to specify an access level of the first process.

Example 11 includes one or more examples, wherein the access level comprises: read only, write only, read and write, or no access.

Example 12 includes one or more examples, and includes based on receipt of a request to access data from the memory from a third process by a third optical interface, applying the configuration to determine whether to permit the access to the data and based on a determination to deny the access to the data, denying access to the data and indicating an unauthorized attempted data access.

Example 13 includes one or more examples, wherein the deny the access to the data comprises performing gating of a request to access the data in one or more of: optical format or electrical format.

Example 14 includes one or more examples, and includes an optical signal receiver permitting or denying optical signal propagation based on the configuration and a demultiplexer selectively permitting or denying propagation of an electrical signal to the memory based on the configuration, wherein the electrical signal comprises an electrical signal version of the optical signal.

Example 15 includes one or more examples, and includes based on receipt of a second request, from the first process, to route the data to the second process, applying the configuration to determine whether to permit the access to the data by the second process and based on a determination to permit the access to the data, copying the data to a second memory region and providing access to the data to the second process.

Example 16 includes one or more examples, and includes at least one machine readable medium comprising a plurality of instructions, that in response to being executed by at least one processor, cause the at least one processor to: issue a request to isolate a first process by reserving access to memory and compute resources for the first process and by gating signals received from a first optical interface from accessing the memory and compute resources based on a configuration and issue a request to share data between the first process and a second process by permitting access to the memory and compute resources and by permitting signals received from a second optical interface to accessing the memory and compute resources based on the configuration.

Example 17 includes one or more examples, wherein: the configuration is to specify an access level of the first request from the optical interface and the access level comprises: read only, write only, read and write, or no access.

Example 18 includes one or more examples, and includes a plurality of instructions, that in response to being executed by at least one processor, cause the at least one processor to: based on receipt of a request to access data from the memory from a third process by a third optical interface, applying the configuration to determine whether to permit the access to the data and based on a determination to deny the access to the data, denying access the data and indicating an unauthorized attempted data access.

Example 19 includes one or more examples, wherein the denying the access to the data comprises performing gating of the request in one or more of: optical format or electrical format.

Example 20 includes one or more examples, and a plurality of instructions, that in response to being executed by at least one processor, cause the at least one processor to: based on receipt of a second request, from the first process, to route the data to the second process, applying the configuration to determine whether to permit the access to the data by the second process and based on a determination to permit the access to the data, copying the data from a first memory region of the memory to a second memory region of the memory and providing access to the data, from the second memory region, to the second process.

1. An apparatus comprising:
an interface coupled to a memory and
circuitry, coupled to the interface, wherein the circuitry is to:
based on receipt of a first request to access data received from an optical interface and from a process, apply a configuration to determine whether to permit the access to data from a first memory region of the memory and
based on a determination to permit the access to the data, permit access to the data by the first request, wherein the first memory region of the memory is accessible to multiple processes of a tenant via optical interconnects.

2. The apparatus of claim 1, wherein the configuration is to specify an access level of the first request from the optical interface.

3. The apparatus of claim 2, wherein the access level comprises: read only, write only, read and write, or no access.

4. The apparatus of claim 1, wherein the circuitry is to:
based on receipt of a second request to access data from the process, apply the configuration to determine whether to permit the access to the data and
based on a determination to deny the access to the data, deny access the data by the second request.

5. The apparatus of claim 4, wherein to deny the access to the data, the circuitry is to:
perform gating of the second request in one or more of: optical format or electrical format.

6. The apparatus of claim 1, wherein the circuitry comprises:
an optical signal receiver and
a demultiplexer, wherein:
the optical signal receiver is to permit or deny optical signal propagation based on the configuration,
the demultiplexer is to selectively permit propagation of an electrical signal to the memory based on the configuration, and
the electrical signal comprises an electrical signal version of the optical signal.

7. The apparatus of claim 1, wherein the circuitry is to:
based on receipt of a second request, from the process, to route the data to a second process, apply the configuration to determine whether to permit the access to the data and
based on a determination to permit the access to the data, copy the data to a second memory region and provide access to the data to the second process.

8. The apparatus of claim 1, wherein the data comprises one or more of: a packet, artificial intelligence (AI) weight data, or AI training data.

9. A method comprising:
isolating a first process by reserving access to memory and compute resources for the first process and by gating signals received from a first optical interface from accessing the memory and compute resources based on a configuration and
sharing data between the first process and a second process by permitting access to the memory and compute resources and by permitting signals received from a second optical interface to accessing the memory and compute resources based on the configuration.

10. The method of claim 9, wherein the configuration is to specify an access level of the first process.

11. The method of claim 10, wherein the access level comprises: read only, write only, read and write, or no access.

12. The method of claim 10, comprising:
based on receipt of a request to access data from the memory from a third process by a third optical interface, applying the configuration to determine whether to permit the access to the data and
based on a determination to deny the access to the data, denying access to the data and indicating an unauthorized attempted data access.

13. The method of claim 12, wherein the deny the access to the data comprises performing gating of a request to access the data in one or more of: optical format or electrical format.

14. The method of claim 9, comprising:
an optical signal receiver permitting or denying optical signal propagation based on the configuration and
a demultiplexer selectively permitting or denying propagation of an electrical signal to the memory based on the configuration, wherein the electrical signal comprises an electrical signal version of the optical signal.

15. The method of claim 9, comprising:
based on receipt of a second request, from the first process, to route the data to the second process, applying the configuration to determine whether to permit the access to the data by the second process and
based on a determination to permit the access to the data, copying the data to a second memory region and providing access to the data to the second process.

16. At least one machine readable medium comprising a plurality of instructions, that in response to being executed by at least one processor, cause the at least one processor to:
issue a request to isolate a first process by reserving access to memory and compute resources for the first process and by gating signals received from a first optical interface from accessing the memory and compute resources based on a configuration and
issue a request to share data between the first process and a second process by permitting access to the memory and compute resources and by permitting signals received from a second optical interface to accessing the memory and compute resources based on the configuration.

17. The at least one machine readable medium of claim 16, wherein:
the configuration is to specify an access level of the first request from the optical interface and
the access level comprises: read only, write only, read and write, or no access.

18. The at least one machine readable medium of claim 16, comprising a plurality of instructions, that in response to being executed by at least one processor, cause the at least one processor to:
based on receipt of a request to access data from the memory from a third process by a third optical interface, applying the configuration to determine whether to permit the access to the data and
based on a determination to deny the access to the data, denying access the data and indicating an unauthorized attempted data access.

19. The at least one machine readable medium of claim 18, wherein the denying the access to the data comprises performing gating of the request in one or more of: optical format or electrical format.

20. The at least one machine readable medium of claim 16, comprising a plurality of instructions, that in response to being executed by at least one processor, cause the at least one processor to:
based on receipt of a second request, from the first process, to route the data to the second process, applying the configuration to determine whether to permit the access to the data by the second process and
based on a determination to permit the access to the data, copying the data from a first memory region of the memory to a second memory region of the memory and providing access to the data, from the second memory region, to the second process.
